(19) United States
(12) Patent Application Publication
(10) Pub. No.: US 2026/0100904 A1
(43) Pub. Date: Apr. 9, 2026

(54) METHOD AND APPARATUS FOR TRANSMITTING/RECEIVING WIRELESS SIGNAL IN WIRELESS COMMUNICATION SYSTEM

(71) Applicant: LG ELECTRONICS INC., Seoul (KR)

(72) Inventors: Youngdae LEE, Seoul (KR); Seoyoung BACK, Seoul (KR); Laeyoung KIM, Seoul (KR); Seungmin LEE, Seoul (KR); Seokjung KIM, Seoul (KR)

(73) Assignee: LG ELECTRONICS INC., Seoul (KR)

(21) Appl. No.: 19/104,079

(22) PCT Filed: Sep. 13, 2023
(86) PCT No.: PCT/KR2023/013712

§ 371 Date: Feb. 14, 2025

(30) Foreign Application Priority Data
Sep. 13, 2022 (KR) 10-2022-0114627

(51) Int. Cl. H04L 45/24; H04W 40/22; H04W 76/20; H04W 80/02; H04W 92/18

(52) U.S. Cl. CPC H04L 45/24; H04W 40/22; H04W 76/20; H04W 80/02; H04W 92/18

(57) ABSTRACT

In the present disclosure, a method of transmitting a signal by a user equipment (UE) in a wireless communication system, may comprise: receiving a first message including configuration information regarding a multi-path (MP) bearer configured with a plurality of radio link control (RLC) entities including at least one first RLC entity related to a direct path to a network and at least one second RLC entity related to an indirect path to the network; receiving a second message including information regarding activation/deactivation of each RLC entity; and transmitting a data unit based on the MP bearer configured through the configuration information.

### TECHNICAL FIELD

The present disclosure relates to a wireless communication system, and more particularly, to a method and apparatus for transmitting/receiving a wireless signal.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between UEs without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### DISCLOSURE

### Technical Problem

An object of the present disclosure is to provide a method of accurately and efficiently performing wireless signal transmission/reception procedures and an apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In an aspect of the present disclosure, a method of transmitting a signal by a user equipment (UE) in a wireless communication system, may comprise: receiving a first message including configuration information regarding a multi-path (MP) bearer configured with a plurality of radio link control (RLC) entities including at least one first RLC entity related to a direct path to a network and at least one second RLC entity related to an indirect path to the network; receiving a second message including information regarding activation/deactivation of each RLC entity; and transmitting a data unit based on the MP bearer configured through the configuration information. The configuration information may include information regarding data duplication for the data unit transmission. The information regarding activation/deactivation of each RLC entity may be configured based on RLC entity indexes for the plurality of RLC entities. The RLC entity indexes are determined based on an indexing order in which at least one first RLC entity index of the at least one first RLC entity related to the direct path may be followed by at least one second RLC entity index of the at least one second RLC entity related to the indirect path. The data unit transmission may be duplicated based on the data duplication on activated RLC entities among the plurality of RLC entities.

Preferably, the information regarding activation/deactivation of each RLC entity may be configured as a medium access control (MAC) control element (CE).

Preferably, the MAC CE may include an activation/deactivation indication per each RLC entity index.

Preferably, the second message including the information regarding activation/deactivation of each RLC entity may be received through the direct path.

Preferably, the second message including the information regarding activation/deactivation of each RLC entity may be received through a remote UE in the indirect path.

Preferably, the at least one first RLC entity index may be lower than the at least one second RLC entity index.

Preferably, the data unit may be a packet data convergence protocol (PDCP) data unit, and the data duplication is PDCP data unit duplication.

Preferably, the at least one second RLC entity may be at least one sidelink (SL) RLC entity related to a relay UE in the indirect path to the network.

Preferably, the first message may be received through a radio resource control (RRC) signaling.

Preferably, the plurality of RLC entity indexes may be logical channel identifiers of the plurality of RLC entities.

In another aspect of the present disclosure, there is provided a computer-readable storage medium having stored thereon instructions, when executed by a processor, that cause the processor to perform the above-described method.

In another aspect of the present disclosure, there is provided a UE configured to perform the method.

In another aspect of the present disclosure, there is provided a device configured to control the UE configured to perform the method.

### Advantageous Effects

According to an embodiment of the present disclosure, wireless signal transmission/reception procedures can be performed accurately and efficiently.

It will be appreciated by persons skilled in the art that the effects that could be achieved with the present disclosure are not limited to what has been particularly described hereinabove and other advantages of the present disclosure will be more clearly understood from the following detailed description.

### DESCRIPTION OF DRAWINGS

FIG. 1 is a diagram for explaining by comparing V2X communication based on RAT before NR and V2X communication based on NR.

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a radio protocol architecture for SL communication.

FIG. 7 illustrates UEs performing V2X or SL communication.

FIG. 8 illustrates resource units for V2X or SL communication.

FIG. 9 illustrates an Inter-UE Coordination Information MAC CE.

FIG. 10 illustrates an Inter-UE Coordination Request MAC CE.

FIG. 11 illustrates (a) User plane protocol stack and (b) Control plane protocol stack for L2 UE-to-Network Relay.

FIG. 12 illustrates a Protocol Stack of Discovery Message for UE-to-Network Relay.

FIG. 13 illustrates a procedure for L2 U2N Remote UE connection establishment.

FIG. 14 illustrates a Procedure for U2N Remote UE switching to direct Uu cell.

FIG. 15 illustrates a Procedure for U2N Remote UE switching to indirect path.

FIG. 16 illustrates an UP protocol stack for multi-path (Scenario 1).

FIG. 17 illustrates an UP protocol stack for UE aggregation (DC-like Scenario 2).

FIG. 18 illustrates an UP protocol stack for UE aggregation (DAPS-like Scenario 2).

FIG. 19 illustrates DL MP Duplication Activation/Deactivation MAC CE to be carried in a MAC PDU on DL-SCH.

FIG. 20 illustrates SL MP Duplication Activation/Deactivation MAC CE to be carried in a MAC PDU on SL-SCH.

FIG. 21 illustrates DL MP Duplication RLC Activation/Deactivation MAC CE to be carried in a MAC PDU on DL-SCH.

FIG. 22 illustrates SL Duplication RLC Activation/Deactivation MAC CE to be carried in a MAC PDU on SL-SCH.

FIG. 23 illustrates DL MP Dynamic Path Switching MAC CE to be carried in a MAC PDU on DL-SCH.

FIG. 24 illustrates SL MP Dynamic Path Switching MAC CE to be carried in a MAC PDU on SL-SCH.

FIG. 25 illustrates Simultaneous establishment of direct/indirect path in U2N based RRC connection establishment.

FIG. 26 illustrates Examples of DL DATA DELIVERY STATUS.

FIG. 27 illustrates an operating method of a UE in an embodiment of the present disclosure.

FIG. 28 illustrates split bearers.

FIG. 29 illustrates a communication system applied to the present disclosure.

FIG. 30 illustrates wireless devices applicable to the present disclosure.

FIG. 31 illustrates another example of a wireless device to which the present disclosure is applied.

FIG. 32 illustrates a vehicle or an autonomous driving vehicle applied to the present disclosure.

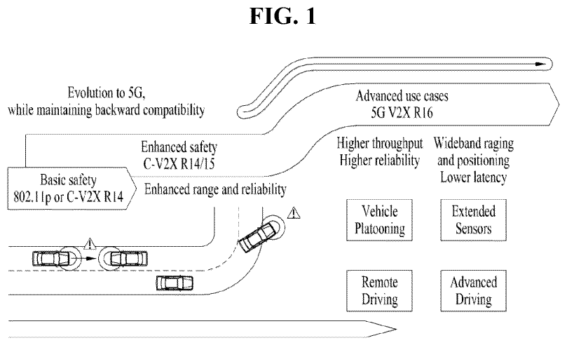

### MODE FOR INVENTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

Details of the background, terminology, abbreviations, etc. used herein may be found in following documents.

### 3GPP LTE

3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol

### 3GPP NR

3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: Overall description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

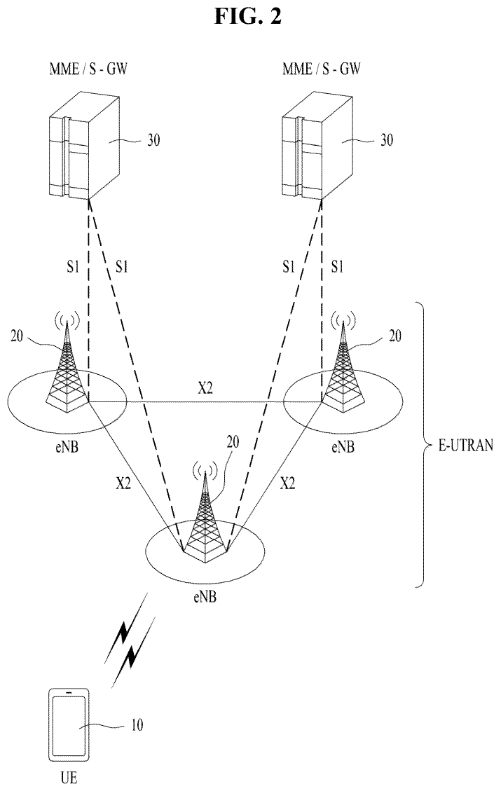

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user UE (UT), subscriber station (SS), mobile UE (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

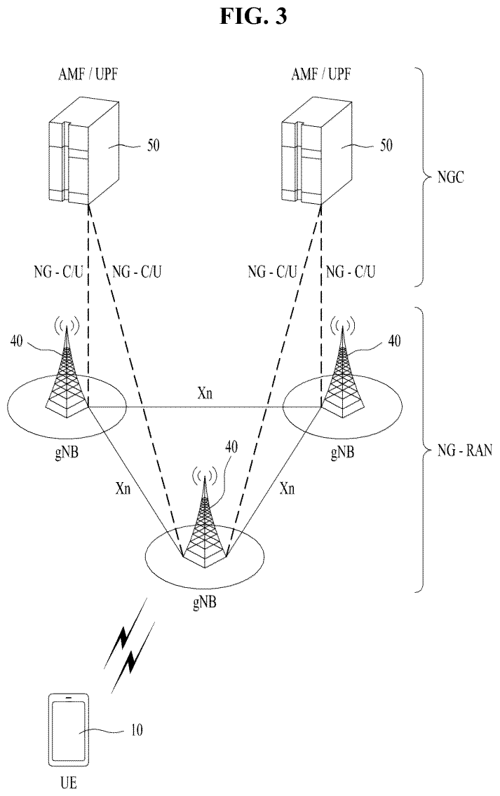

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

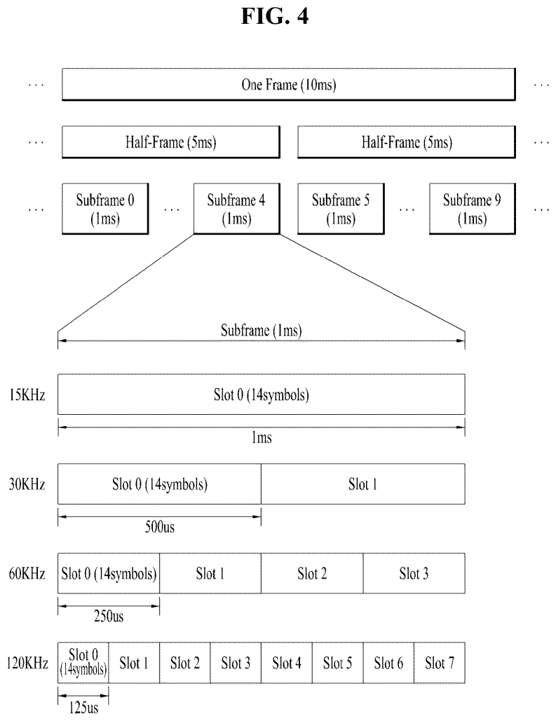

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot Nslotsymb, the number of slots per frame Nframe,uslot, and the number of slots per subframe Nsubframe,uslot according to an SCS configuration μ in the NCP case.

TABLE 1

| | | | |
|---|---|---|---|
| SCS (15*2u) | N^{slot}_{symb} | N^{frame, u}ₛₗₒₜ | N^{subframe, u}ₛₗₒₜ |

| | | | | |
|---|---|---|---|---|
| 15 kHz | (u = 0) | 14 | 10 | 1 |
| 30 kHz | (u = 1) | 14 | 20 | 2 |
| 60 kHz | (u = 2) | 14 | 40 | 4 |
| 120 kHz | (u = 3) | 14 | 80 | 8 |
| 240 kHz | (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM (A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency | Corresponding | Subcarrier |
|---|---|---|
| Range designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

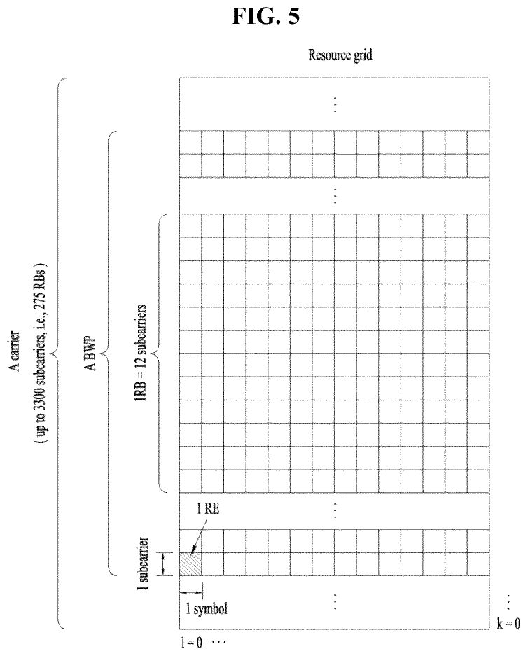

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P) RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

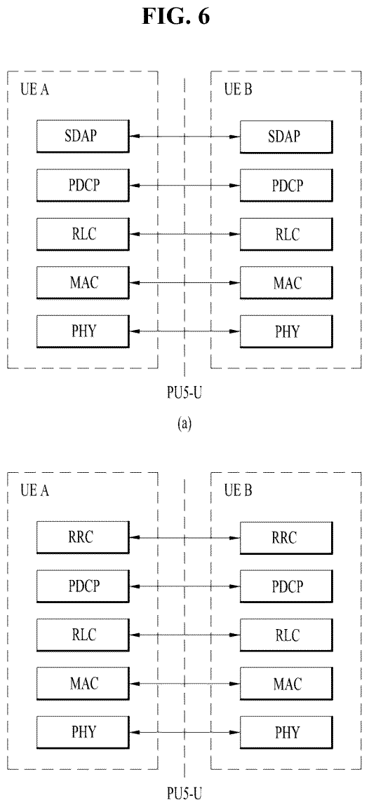

FIG. 6 illustrates a radio protocol architecture for SL communication. Specifically, FIG. 6-(a) shows a user plane protocol stack of NR, and FIG. 6-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre) set sidelink BWP (SL BWP). For example, the bandwidth of the S-SSB may be 11 resource blocks (RBs). For example, the PSBCH may span 11 RBs. The frequency position of the S-SSB may be (pre) set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

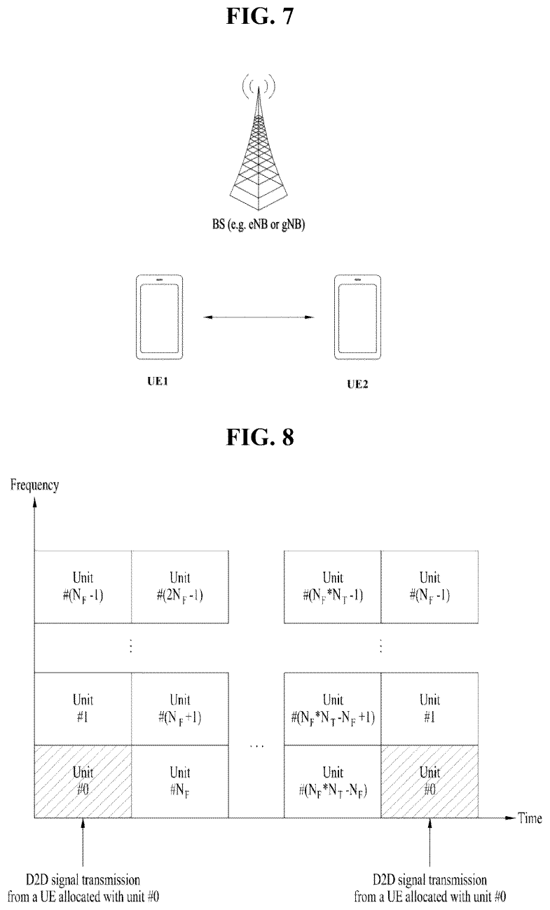

FIG. 7 illustrates UEs performing V2X or SL communication.

Referring to FIG. 7, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

FIG. 8 illustrates resource units for V2X or SL communication.

Referring to FIG. 8, the frequency resources of a resource pool may be divided into NF sets, and the time resources of the resource pool may be divided into NT sets. Accordingly, a total of NF*NT resource units may be defined in the resource pool. FIG. 8 shows an exemplary case where the resource pool is repeated with a periodicity of NT subframes.

As shown in FIG. 8, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.
(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.
(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.
(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

### SL DRX (Sidelink Discontinuous Reception)

Sidelink supports SL DRX for unicast, groupcast, and broadcast. Similar parameters for Uu (on-duration, inactivity-timer, retransmission-timer, cycle) are defined for SL to determine the SL active time for SL DRX. During the SL active time, the UE performs SCI monitoring for data reception (i.e., PSCCH and 2nd stage SCI on PSSCH). The UE may skip monitoring of SCI for data reception during SL DRX inactive time.

The actual parameters supported for each cast type (unicast, groupcast, broadcast) are specified in the following subsections.

The SL active time of the RX UE includes the time in which any of its applicable SL on-duration timer(s), SL inactivity-timer(s) or SL retransmission timer(s) (for any of unicast, groupcast, or broadcast) are running. In addition, the slots associated with announced periodic transmissions by the TX UE and the time in which a UE is expecting CSI report following a CSI request (for unicast) are considered as SL active time of the RX UE.

The TX UE maintains a set of timers corresponding to the SL DRX timers in the RX UE(s) for each pair of source/destination L2 ID for unicast or destination L2 ID for groupcast/broadcast. When data is available for transmission to one or more RX UE(s) configured with SL DRX, the TX UE selects resources taking into account the active time of the RX UE(s) determined by the timers maintained at the TX UE.

For unicast, SL DRX is configured per pair of source L2 ID and destination L2 ID.

The UE maintains a set of SL DRX timers for each direction per pair of source L2 ID and destination L2 ID. The SL DRX configuration for a pair of source/destination L2 IDs for a direction may be negotiated between the UEs in the AS layer. For SL DRX configuration of each direction, where one UE is the TX UE and the other is the RX UE:
RX UE may send assistance information, which includes its desired on duration timer, SL DRX start offset, and SL DRX cycle, to the TX UE and the mode 2 TX UE may use it to determine the SL DRX configuration for the RX UE.
Regardless of whether assistance information is provided or not, the TX UE in RRC_IDLE/RRC_INACTIVE/OOC, or in RRC_CONNECTED and using mode 2 resource allocation, determines the SL DRX Configuration for the RX UE. For a TX UE in RRC_CONNECTED and using mode 1 resource allocation, the SL DRX configuration for the RX UE is determined by the serving gNB of the TX UE.
TX UE sends the SL DRX configuration to be used by the RX UE to the RX UE.
The RX UE may accept or reject the SL DRX configuration.

A default SL DRX configuration for groupcast/broadcast can be used for DCR messages.

When the TX UE is in RRC_CONNECTED, the TX UE may report the received assistance information to its serving gNB and sends the SL DRX configuration to the RX UE upon receiving the SL DRX configuration in dedicated RRC signaling from the gNB. When the RX UE is in RRC_CONNECTED, the RX UE can report the received SL DRX configuration to its serving gNB, e.g. for alignment of the Uu and SL DRX configurations.

SL on-duration timer, SL inactivity-timer, SL HARQ RTT timer, and SL HARQ retransmission timer are supported in unicast. SL HARQ RTT timer and SL HARQ retransmission timer are maintained per SL process at the RX UE. In addition to (pre) configured values for each of these timers, SL HARQ RTT timer value can be derived from the retransmission resource timing when SCI indicates more than one transmission resource.

SL DRX MAC CE is introduced for SL DRX operation in unicast only.

For groupcast/broadcast, SL DRX is configured commonly among multiple UEs based on QoS profile and Destination L2 ID. Multiple SL DRX configurations can be supported for each of groupcast/broadcast.

SL on-duration timer, SL inactivity-timer, SL HARQ RTT and SL retransmission timers are supported for groupcast. Only SL on-duration timer is supported for broadcast. SL DRX cycle, SL on-duration, and SL inactivity timer (only for groupcast) are configured per QoS profile. The starting offset and slot offset of the SL DRX cycle is determined based on the destination L2 ID. The SL HARQ RTT timer (only for groupcast) and SL HARQ retransmission timer (only for groupcast) are not configured per QoS profile or per destination L2 ID. For groupcast, the RX UE maintains a SL inactivity timer for each destination L2 ID, and selects the largest SL inactivity timer value if multiple SL inactivity timer values associated with different QoS profiles are configured for that L2 ID. For groupcast and broadcast, the RX UE maintains a single SL DRX cycle (selected as the smallest SL DRX cycle of any QoS profile of that L2 ID) and single SL on-duration (selected as the largest SL on-duration of any QoS profile of that L2 ID) for each destination L2 ID when multiple QoS profiles are configured for that L2 ID.

For groupcast, SL HARQ RTT timer and SL retransmission timer are maintained per SL process at the RX UE. SL HARQ RTT timer can be set to different values to support both HARQ enabled and HARQ disabled transmissions.

A default SL DRX configuration, common between groupcast and broadcast, can be used for a QoS profile which is not mapped onto any non-default SL DRX configuration(s).

In-coverage TX and RX UEs in RRC_IDLE/RRC_INACTIVE obtain their SL DRX configuration from SIB. UEs (TX or RX) in RRC_CONNECTED can obtain the SL DRX configuration from SIB, or from dedicated RRC signaling during handover. For the out of coverage case, the SL DRX configuration is obtained from pre-configuration.

For groupcast, the TX UE restarts its timer corresponding to the SL inactivity timer for the destination L2 ID (used for determining the allowable transmission time) upon reception of new data with the same destination L2 ID.

TX profile is introduced to ensure compatibility for groupcast and broadcast transmissions between UEs supporting/not-supporting SL DRX functionality. A TX profile is provided by upper layers to AS layer and identifies one or more sidelink feature group(s). A TX UE only assumes SL DRX for the RX UEs when the associated TX profile corresponds to support of SL DRX. An RX UE determines that SL DRX is used if all destination L2 IDs of interest have an associated TX profile corresponding to the support of SL DRX.

Alignment of Uu DRX and SL DRX for a UE in RRC_CONNECTED is supported for unicast, groupcast, and broadcast. Alignment of Uu DRX and SL DRX at the same UE is supported. In addition, for mode 1 scheduling, the alignment of Uu DRX of the TX UE and SL DRX of the RX UE is supported.

Alignment may comprise of either full overlap or partial overlap in time between Uu DRX and SL DRX. For SL RX UEs in RRC_CONNECTED, alignment is achieved by the gNB.

The MAC entity may be configured by RRC with a SL DRX functionality that controls the UE's SCI (i.e., 1st stage SCI and 2nd stage SCI) monitoring activity for unicast, for groupcast and broadcast. When using SL DRX operation, the MAC entity shall also monitor SCI (i.e., 1st stage SCI and 2nd stage SCI) according to requirements found in other clauses of this specification.

RRC controls Sidelink DRX operation by configuring the following parameters:
sl-drx-onDuration Timer: the duration at the beginning of a SL DRX cycle;
sl-drx-SlotOffset: the delay before starting the sl-drx-onDurationTimer;
sl-drx-InactivityTimer (except for the broadcast transmission): the duration after the first slot of SCI (i.e., 1st stage SCI and 2nd stage SCI) reception in which an SCI indicates a new SL transmission for the MAC entity;
sl-drx-RetransmissionTimer (per Sidelink process except for the broadcast transmission): the maximum duration until a SL retransmission is received;
sl-drx-StartOffset: the slot where the SL DRX cycle starts;
sl-drx-Cycle: the Sidelink DRX cycle;
sl-drx-HARQ-RTT-Timer (per Sidelink process except for the broadcast transmission): the minimum duration before a SL HARQ retransmission is expected by the MAC entity.

When SL DRX is configured, the Active Time includes the time while:
sl-drx-onDurationTimer or sl-drx-InactivityTimer is running; or
sl-drx-Retransmission Timer is running; or
period of sl-LatencyBoundCSI-Report configured by RRC in case SL-CSI reporting MAC CE is not received; or
the time between the transmission of the request of SL-CSI reporting and the reception of the SL-SCI reporting MAC CE in case SL-CSI reporting MAC CE is received; or
Slot associated with the announced periodic transmissions by the UE transmitting SL-SCH Data.

When one or multiple SL DRX is configured, the MAC entity shall:
1> if multiple SL DRX Cycles that are mapped with multiple SL-QoS-Profiles of a Destination Layer-2 ID and interested cast type is associated to groupcast and broadcast:
2> select sl-drx-Cycle whose length of the sl-drx-cycle is the shortest one among multiple SL DRX Cycles that are mapped with multiple SL-QoS-Profiles associated with the Destination Layer-2 ID:
2> select sl-drx-onDurationTimer whose length of the sl-drx-onDurationTimer is the longest one among multiple SL DRX onduration timers that are mapped with multiple SL-QoS-Profiles associated with the Destination Layer-2 ID.
1> if a sl-drx-HARQ-RTT-Timer expires:
2> if the data of the corresponding Sidelink process was not successfully decoded or if the HARQ feedback (i.e., negative acknowledgement) is not transmitted for unicast due to UL/SL prioritization:
3> start the sl-drx-RetransmissionTimer for the corresponding Sidelink process in the first slot after the expiry of sl-drx-HARQ-RTT-Timer.

When the cast type is groupcast or broadcast as indicated by upper layer, the sl-drx-StartOffset and sl-drx-SlotOffset are derived from the following equations:

$$sl - drx - StartOffset ( ms ) = Destination Layer - 2 ID modulo sl - drx - Cycle ( ms ) .$$

$$sl - drx - SlotOffset ( ms ) = Destination Layer - 2 ID modulo sl - drx - onDurationTimer ( ms ) .$$

1> if the SL DRX cycle is used, and [(DFN×10)+subframe number] modulo (sl-drx-Cycle)=sl-drx-StartOffset:
2> start sl-drx-onDurationTimer after sl-drx-SlotOffset from the beginning of the subframe.
1> if a SL DRX is in Active Time:
2> monitor the SCI (i.e., 1st stage SCI and 2nd stage SCI) in this SL DRX.
2> if the SCI indicates a new SL transmission:
3> if Source Layer-1 ID of the SCI is equal to the 8 LSB of the intended Destination Layer-2 ID and Destination Layer-1 ID of the SCI is equal to the 8 LSB of the intended Source Layer-2 ID and the cast type indicator in the SCI is set to unicast:
4> start or restart sl-drx-InactivityTimer for the corresponding Source Layer-2 ID and Destination Layer-2 ID pair after the first slot of SCI reception.
3> if Destination Layer-1 ID of the SCI (i.e., 2nd stage SCI) is equal to the 8 LSB of the intended Destination Layer-1 ID and the cast type indicator in the SCI is set to groupcast:
4> select sl-drx-InactivityTimer whose length of the sl-drx-InactivityTimer is the largest one among multiple SL DRX Inactivity timers that are mapped to multiple SL-QoS-Profiles of Destination Layer-2 ID associated with the Destination Layer-1 ID of the SCI; and
4> start or restart sl-drx-InactivityTimer for the corresponding Destination Layer-2 ID after the first slot of SCI reception.
2> if the SCI indicates a SL transmission:
3> if PSFCH resource is not configured for the SL grant associated to the SCI:
4> start the sl-drx-HARQ-RTT-Timer for the corresponding Sidelink process in the slot following the end of PSSCH transmission (i.e., currently received PSSCH).
3> if PSFCH resource is configured for the SL grant associated to the SCI:
4> if HARQ feedback is enabled by the SCI and the cast type indicator in the SCI is set to unicast; or 4> if HARQ feedback is enabled by the SCI and the cast type indicator in the SCI is set to groupcast and positive-negative acknowledgement is selected;
5> start the sl-drx-HARQ-RTT-Timer for the corresponding Sidelink process in the first slot after the end of the corresponding PSFCH transmission carrying the SL HARQ feedback; or
5> start the sl-drx-HARQ-RTT-Timer for the corresponding Sidelink process in the first slot after the end of the corresponding PSFCH resource for the SL HARQ feedback when the SL HARQ feedback is not transmitted due to UL/SL prioritization;
4> if HARQ feedback is enabled by the SCI and the cast type indicator in the SCI is set to groupcast and negative-only acknowledgement is selected;
5> start the sl-drx-HARQ-RTT-Timer for the corresponding Sidelink process in the first slot after the end of the corresponding PSFCH transmission carrying the SL HARQ feedback; or
5> start the sl-drx-HARQ-RTT-Timer for the corresponding Sidelink process in the first slot after the end of the corresponding PSFCH resource for the SL HARQ feedback when the SL HARQ feedback is not transmitted due to UL/SL prioritization; or
5> start the sl-drx-HARQ-RTT-Timer for the corresponding Sidelink process in the first slot after the end of the corresponding PSFCH resource for the SL HARQ feedback when the SL HARQ feedback is a positive acknowledgement.
4> if HARQ feedback is disabled by the SCI and the resource(s) for one or more retransmission opportunities is not scheduled in the SCI:
5> start the sl-drx-HARQ-RTT-Timer for the corresponding Sidelink process in the slot following the end of PSFCH resource.
4> if HARQ feedback is disabled by the SCI and the resource(s) for one or more retransmission opportunities is scheduled in the SCI:
5> start the sl-drx-HARQ-RTT-Timer for the corresponding Sidelink process in the slot following the end of PSSCH transmission (i.e., currently received PSSCH).

NOTE: The sl-drx-HARQ-RTT-Timer is derived from the retransmission resource timing (i.e., immediately next retransmission resource indicated in an SCI) when SCI indicates a next retransmission resource. The UE uses the sl-drx-HARQ-RTT-Timer is configured when an SCI doesn't indicate a next retransmission resource.
3> stop the sl-drx-RetransmissionTimer for the corresponding Sidelink process.
1> if a SL DRX Command MAC CE is received for the Source Layer-2 ID and Destination Layer-2 ID pair of a unicast:
2> stop sl-drx-onDuration Timer for the Source Layer-2 ID and Destination Layer-2 ID pair of a unicast;
2> stop sl-drx-InactivityTimer for the Source Layer-2 ID and Destination Layer-2 ID pair of a unicast.

### Inter-UE Coordination (IUC)

The SL UE can support inter-UE coordination (IUC) in Mode 2, whereby a UE-A sends information about resources to UE-B, which UE-B then uses for resource (re)selection. The following schemes of inter-UE coordination are supported:
IUC scheme 1, where the coordination information sent from a UE-A to a UE-B is the preferred and/or non-preferred resources for UE-B's transmission, and
IUC scheme 2, where the coordination information sent from a UE-A to a UE-B is the presence of expected/potential resource conflict on the resources indicated by UE-B's SCI.

In scheme 1, IUC can be triggered by a explicit request from UE-B, or by a condition at UE-A. UE-A determines the set of resources reserved by other UEs or slots where UE-A, when it is the intended receiver of UE-B, does not expect to perform SL reception from UE-B due to half-duplex operation. UE-A uses these resources as the set of non-preferred resources, or excludes these resources to determine a set of preferred resources and sends the preferred/non-preferred resources to UE-B. UE-B's resources for resource (re)selection can be based on both UE-B's sensing results (if available) and the coordination information received from UE-A, or it can be based only on coordination information received from UE-A. For scheme 1, MAC CE and second-stage SCI or MAC CE only can be used to send IUC. The explicit request and reporting for IUC in unicast manner is supported.

In scheme 2, UE-A determines the expected/potential resource conflict within the resources indicated by UE-B's SCI as either resources reserved by other UEs and identified by UE-A as fully/partially overlapping with the resources indicated by UE-B's SCI, or as slots where UE-A is the intended receiver of UE-B and does not expect to perform SL reception on those slots due to half-duplex operation. UE-B uses the conflicting resources to determine the resources to be reselected and exclude the conflicting resources from the reselected resources. For scheme 2, PSFCH is used to send IUC.

The Sidelink Inter-UE Coordination Request (SL-IUC Req) transmission procedure is used to trigger a peer UE to transmit Sidelink Inter-UE Coordination Information.

The Sidelink Inter-UE Coordination Information (SL-IUC Info) reporting procedure is used to provide a peer UE with inter-UE coordination information.
sl-LatencyBoundIUC-Report, which is maintained for each PC5-RRC connection.

The MAC entity maintains a sl-IUC-ReportTimer for each pair of the Source Layer-2 ID and the Destination Layer-2 ID corresponding to a PC5-RRC connection. sl-IUC-ReportTimer is used for a SL-IUC Information reporting UE to follow the latency requirement signalled from an IUC-Information triggering UE. The value of sl-IUC-ReportTimer is the same as the? latency requirement of the SL-IUC Information in sl-LatencyBoundIUC-Report configured by RRC.

The MAC entity shall for each pair of the Source Layer-2 ID and the Destination Layer-2 ID corresponding to a PC5-RRC connection which has been established by upper layers:
1> if the SL-IUC Information reporting has been triggered by an SL-IUC Request MAC CE (and/or an SCI) and not cancelled:
2> if the sl-IUC-ReportTimer for the triggered SL-IUC Information reporting is not running:
3> start the sl-IUC-ReportTimer.
2> if the sl-IUC-ReportTimer for the triggered SL-IUC Information reporting expires:
3> cancel the triggered SL-IUC Information reporting.
2> else if the MAC entity has SL resources allocated for new transmission and the SL-SCH resources can accommodate the SL-IUC Information MAC CE and its subheader as a result of logical channel prioritization:
3> instruct the Multiplexing and Assembly procedure to generate a Sidelink Inter-UE Coordination Information MAC CE as defined in clause 6.1.3.35;
3> stop the sl-IUC-ReportTimer for the triggered SL-IUC Information reporting;
3> cancel the triggered SL-IUC Information reporting.

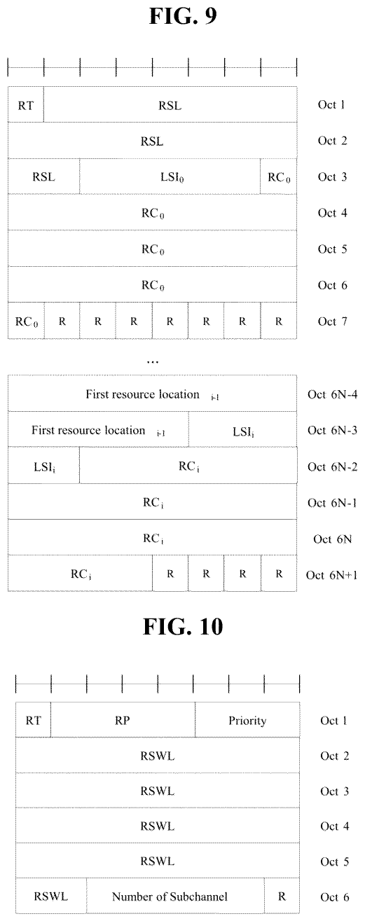

FIG. 9 illustrates an Inter-UE Coordination Information MAC CE.

The Inter-UE Coordination Information MAC CE is identified by a MAC subheader with LCID as specified in Table 5.

TABLE 5

| Index | LCID values |
|---|---|
| 0 | SCCH carrying PC5-S messages that are not protected |
| 1 | SCCH carrying PC5-S messages “Direct Security Mode |
| | Command” and “Direct Security Mode Complete” |
| 2 | SCCH carrying other PC5-S messages that are protected |
| 3 | SCCH carrying PC5-RRC messages |
| 4-19 | Identity of the logical channel |
| 20-[58] | Reserved |
| 59 | Sidelink Inter-UE Coordination Request |
| 60 | Sidelink Inter-UE Coordination Information |
| [61] | Sidelink DRX Command |
| 62 | Sidelink CSI Reporting |
| 63 | Padding |

The priority of the Inter-UE Coordination Information MAC CE is fixed to ‘1’. It has a variable size with following fields:
RT: This field indicates the resource set type, i.e., preferred resource set or non-preferred resource set, as the codepoint value of the SCI format 2-C resourceSetType field.
RSL: This field indicates the locatation of reference slot, as the codepoint value of the SCI format 2-C referenceSlotLocation field. The length of the field is 17 bits. If the length of referenceSlotLocation field in SCI format 2-C is shorter than 17 bit, this field contains referenceSlotLocation field using the LSB bits;
LSIi: This field indicates lowest subchannel indices for the first resource location of each TRIV, as the codepoint value of the SCI format 2-C lowestIndices field. LSI0 indicates lowes subchannel indices for the first resource location of TRIV within the first resource combination, LSI1 indicates lowes subchannel indices for the first resource location of TRIV within the second resource combination and so on. The length of the field is 5 bits. If the length of lowestIndices field in SCI format 2-C is shorter than 5 bit, this field contains lowestIndices field using the LSB bits;
RCi: This field indicates resource combination, as the codepoint value of the SCI format 2-C resourceCombination field. RC0 indicates the first resource combination, RC1 indicates the second resource combination and so on. [The maximum number of included resource combination is 8.] The length of the field is 26 bits. If the length of resourceCombination field in SCI format 2-C is shorter than 26 bit, this field contains resourceCombination field using the LSB bits;
First resource locationi-1: This field indicates first resource location, as the codepoint value of the SCI format 2-C firstResourceLocation field. First Resource Location0 indicates the first resource location for the second resource combination, First Resource Location1 indicates the the first resource location for the third resource combination and so on. The length of the field is 13 bits. If the length of firstResourceLocation field in SCI format 2-C is shorter than 13 bit, this field contains firstResourceLocation field using the LSB bits;
R: Reserved bit, set to 0.

FIG. 10 illustrates an Inter-UE Coordination Request MAC CE.

The Inter-UE Coordination request MAC CE is identified by a MAC subheader with LCID as specified in Table 5. The priority of the Inter-UE Coordination Request MAC CE is fixed to ‘l’. It has a variable size with following fields:
RT: This field indicates the resource set type, i.e., preferred resource set or non-preferred resource set, as the codepoint value of the SCI format 2-C resourceSetType field.
RP: This field indicates the resource reservation period, as the codepoint value of the SCI format 2-C resourceReservationPeriod field. The length of the field is 4 bits. If the length of resourceReservationPeriod field in SCI format 2-C is shorter than 4 bit, this field contains resourceReservationPeriod field using the LSB bits;
Priority: This field indicates the priority, as the codepoint value of the SCI format 2-C priority field. The length of the field is 3 bits;
RSWL: This field indicates resource selection window location, as the codepoint value of the SCI format 2-C resourceSelection WindowLocation field. The length of the field is 34 bits. If the length of resourceSelection WindowLocation field in SCI format 2-C is shorter than 34 bit, this field contains resourceSelection WindowLocation field using the LSB bits;
Number of Subchannel: This field indicates the number of subchannels, as the codepoint value of the SCI format 2-C numberOfSubchannel field. The length of the field is 5 bits. If the length of numberOfSubchannel field in SCI format 2-C is shorter than 5 bit, this field contains numberOfSubchannel field using the LSB bits;
R: Reserved bit, set to 0.

### Sidelink Relay

Sidelink relay is introduced to support 5G ProSe UE-to-Network Relay (U2N Relay) function to provide connectivity to the network for U2N Remote UE(s). Both L2 and L3 U2N Relay architectures are supported. The L3 U2N Relay architecture is transparent to the serving RAN of the U2N Relay UE, except for controlling sidelink resources.

Relay discovery: AS functionality enabling 5G ProSe UE-to-Network Relay Discovery, using NR technology but not traversing any network node.

U2N Relay UE: a UE that provides functionality to support connectivity to the network for U2N Remote UE(s).

U2N Remote UE: a UE that communicates with the network via a U2N Relay UE.

Upstream: Direction toward parent node in IAB-topology.

Uu Relay RLC channel: an RLC channel between L2 U2N Relay UE and gNB, which is used to transport packets over Uu for L2 UE-to-Network Relay.

A U2N Relay UE shall be in RRC_CONNECTED to perform relaying of unicast data.

For L2 U2N Relay operation, the following RRC state combinations are supported:
Both U2N Relay UE and U2N Remote UE shall be in RRC CONNECTED to perform transmission/reception of relayed unicast data.
The U2N Relay UE can be in RRC_IDLE, RRC_INACTIVE or RRC_CONNECTED as long as all the U2N Remote UE(s) that are connected to the U2N Relay UE are either in RRC_INACTIVE or in RRC_IDLE.

For L2 U2N Relay, the U2N Remote UE can only be configured to use resource allocation mode 2 for data to be relayed.

A single unicast link is established between one L2 U2N Relay UE and one L2 U2N Remote UE. The traffic of U2N Remote UE via a given U2N Relay UE and the traffic of the U2N Relay UE shall be separated in different Uu RLC channels over Uu.

### Protocol Stacks for SL Relay

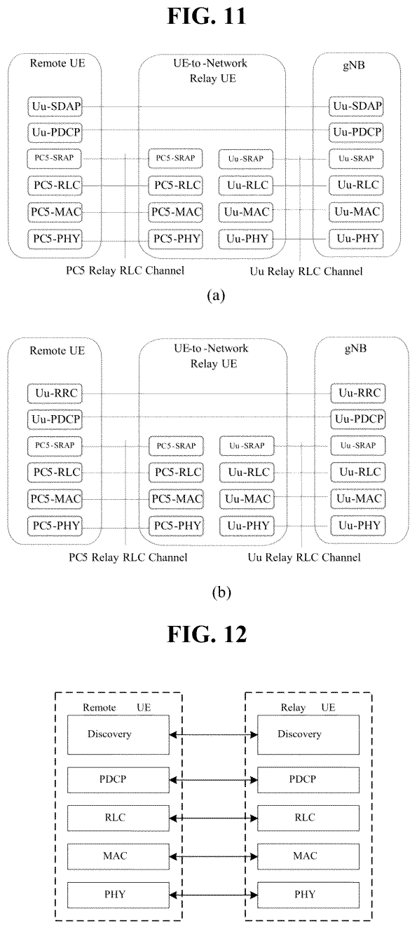

FIG. 11 illustrates (a) User plane protocol stack and (b) Control plane protocol stack for L2 UE-to-Network Relay.

The protocol stacks for the user plane and control plane of L2 U2N Relay architecture are presented in FIGS. 11 (a) and (b). The SRAP sublayer is placed above the RLC sublayer for both CP and UP at both PC5 interface and Uu interface. The Uu SDAP, PDCP and RRC are terminated between L2 U2N Remote UE and gNB, while SRAP, RLC, MAC and PHY are terminated in each hop (i.e. the link between L2 U2N Remote UE and L2 U2N Relay UE and the link between L2 U2N Relay UE and the gNB).

For L2 U2N Relay, the SRAP sublayer over PC5 hop is only for the purpose of bearer mapping. The SRAP sublayer is not present over PC5 hop for relaying the L2 U2N Remote UE's message on BCCH and PCCH. For L2 U2N Remote UE's message on SRB0, the SRAP sublayer is not present over PC5 hop, but the SRAP sublayer is present over Uu hop for both DL and UL.

For L2 U2N Relay, for uplink:
The Uu SRAP sublayer supports UL bearer mapping between ingress PC5 Relay RLC channels for relaying and egress Uu Relay RLC channels over the L2 U2N Relay UE Uu interface. For uplink relaying traffic, the different end-to-end RBs (SRBs or DRBs) of the same Remote UE and/or different Remote UEs can be multiplexed over the same Uu Relay RLC channel.
The Uu SRAP sublayer supports L2 U2N Remote UE identification for the UL traffic. The identity information of L2 U2N Remote UE Uu Radio Bearer and a local Remote UE ID are included in the Uu SRAP header at UL in order for gNB to correlate the received packets for the specific PDCP entity associated with the right Uu Radio Bearer of a Remote UE.
The PC5 SRAP sublayer at the L2 U2N Remote UE supports UL bearer mapping between Remote UE Uu Radio Bearers and egress PC5 Relay RLC channels.

For L2 U2N Relay, for downlink:
The Uu SRAP sublayer supports DL bearer mapping at gNB to map end-to-end Radio Bearer (SRB, DRB) of Remote UE into Uu Relay RLC channel over Relay UE Uu interface. The Uu SRAP sublayer supports DL bearer mapping and data multiplexing between multiple end-to-end Radio Bearers (SRBs or DRBs) of a L2 U2N Remote UE and/or different L2 U2N Remote UEs and one Uu Relay RLC channel over the Relay UE Uu interface.
The Uu SRAP sublayer supports Remote UE identification for DL traffic. The identity information of Remote UE Uu Radio Bearer and a local Remote UE ID are included into the Uu SRAP header by the gNB at DL in order for Relay UE to map the received packets from Remote UE Uu Radio Bearer to its associated PC5 Relay RLC channel.
The PC5 SRAP sublayer at the Relay UE supports DL bearer mapping between ingress Uu Relay RLC channels and egress PC5 Relay RLC channels.
The PC5 SRAP sublayer at the Remote UE correlates the received packets for the specific PDCP entity associated with the right Uu Radio Bearer of a Remote UE based on the identity information included in the Uu SRAP header.

A local Remote UE ID is included in both PC5 SRAP header and Uu SRAP header. L2 U2N Relay UE is configured by the gNB with the local Remote UE ID to be used in SRAP header. Remote UE obtains the local Remote ID from the gNB via Uu RRC messages including RRCSetup, RRCReconfiguration, RRCResume and RRCReestablishment. Uu DRB(s) and Uu SRB(s) are mapped to different PC5 Relay RLC channels and Uu Relay RLC channels in both PC5 hop and Uu hop.

It is the gNB responsibility to avoid collision on the usage of local Remote UE ID. The gNB can update the local Remote UE ID by sending the updated local Remote ID via RRCReconfiguration message to the Relay UE. The serving gNB can perform local Remote UE ID update independent of the PC5 unicast link L2 ID update procedure.

FIG. 12 illustrates a Protocol Stack of Discovery Message for UE-to-Network Relay.

Model A and Model B discovery models are supported for U2N Relay discovery. The protocol stack used for discovery is presented in FIG. 12.

The U2N Remote UE can perform Relay discovery message transmission and may monitor the sidelink for Relay discovery message while in RRC_IDLE, RRC_INACTIVE or RRC_CONNECTED. The network may broadcast a threshold, which is used by the U2N Remote UE to determine if it can transmit Relay discovery solicitation messages to U2N Relay UE(s).

The U2N Relay UE can perform Relay discovery message transmission and may monitor the sidelink for Relay discovery message while in RRC_IDLE, RRC_INACTIVE or RRC_CONNECTED. The network may broadcast a maximum Uu RSRP threshold, a minimum Uu RSRP threshold, or both, which are used by the U2N Relay UE to determine if it can transmit Relay discovery messages to U2N Remote UE(s).

The network may provide the Relay discovery configuration using broadcast or dedicated signalling for Relay discovery. In addition, the U2N Remote UE and U2N Relay UE may use pre-configuration for Relay discovery.

The resource pool(s) used for NR sidelink communication can be used for Relay discovery or the network may configure a resource pool(s) dedicated for Relay discovery. Resource pool(s) dedicated for Relay discovery can be configured simultaneously with resource pool(s) for NR sidelink communication in system information, dedicated signalling and/or pre-configuration. Whether a dedicated resource pool(s) for Relay discovery is configured is based on network implementation. If resource pool(s) dedicated for Relay discovery are configured, only those resource pool(s) dedicated for Relay discovery shall be used for Relay discovery. If only resource pool(s) for NR sidelink communication are configured, all the configured transmission resource pool(s) can be used for Relay discovery and sidelink communication.

For U2N Remote UE (including both in-coverage and out of coverage cases) that has been connected to the network via a U2N Relay UE, only resource allocation mode 2 is used for discovery message transmission.

The Relay discovery reuses NR sidelink resource allocation principles for in-coverage U2N Relay UE, and for both in-coverage and out of coverage U2N Remote UEs.

The sidelink power control for the transmission of Relay discovery messages is same as for NR sidelink communication.

No ciphering or integrity protection in PDCP layer is applied for the Relay discovery messages.

The UE can determine from SIB12 whether the gNB supports Relay discovery, Non-Relay discovery, or both.

### Relay Selection/Reselection

The U2N Remote UE performs radio measurements at PC5 interface and uses them for U2N Relay selection and reselection along with higher layer criteria. When there is no unicast PC5 connection between the U2N Relay UE and the U2N Remote UE, the U2N Remote UE uses SD-RSRP measurements to evaluate whether PC5 link quality towards a U2N Relay UE satisfies relay selection criterion.

For relay reselection, U2N Remote UE uses SL-RSRP measurements towards the serving U2N Relay UE for relay reselection trigger evaluation when there is data transmission from U2N Relay UE to U2N Remote UE, and it is left to UE implementation whether to use SL-RSRP or SD-RSRP for relay reselection trigger evaluation in case of no data transmission from U2N Relay UE to U2N Remote UE.

A U2N Relay UE is considered suitable by a U2N Remote UE in terms of radio criteria if the PC5 link quality measured by U2N Remote UE towards the U2N Relay UE exceeds configured threshold (pre-configured or provided by gNB). The U2N Remote UE searches for suitable U2N Relay UE candidates that meet all AS layer and higher layer criteria (see TS 23.304 [xx]). If there are multiple such suitable U2N Relay UEs, it is up to U2N Remote UE implementation to choose one U2N Relay UE among them. For L2 U2N Relay (re)selection, the PLMN ID and cell ID can be used as additional AS criteria.

The U2N Remote UE triggers U2N Relay selection in following cases:
Direct Uu signal strength of current serving cell of the U2N Remote UE is below a configured signal strength threshold;
Indicated by upper layer of the U2N Remote UE.

The U2N Remote UE may trigger U2N Relay reselection in following cases:
PC5 signal strength of current U2N Relay UE is below a (pre) configured signal strength threshold;
Cell (re)selection, handover or Uu RLF has been indicated by U2N Relay UE via PC5-RRC signalling;
When Remote UE receives a PC5-S link release message from U2N Relay UE;
When U2N Remote UE detects PC5 RLF;
Indicated by upper layer.

For L2 U2N Remote UEs in RRC_IDLE/INACTIVE and L3 U2N Remote UEs, the cell (re)selection procedure and relay (re)selection procedure run independently. If both suitable cells and suitable U2N Relay UEs are available, it is up to UE implementation to select either a cell or a U2N Relay UE. A L3 U2N Remote UE may select a cell and a U2N Relay UE simultaneously and this is up to implementation of L3 U2N Remote UE.

For both L2 and L3 U2N Relay UEs in RRC_IDLE/INACTIVE, the PC5-RRC message(s) are used to inform their connected Remote UE(s) when U2N Relay UEs select a new cell. The PC5-RRC message(s) are also used to inform their connected L2 or L3 U2N Remote UE(s) when L2/L3 U2N Relay UE performs handover or detects Uu RLF. Upon reception of the PC5 RRC message for notification, it is up to U2N Remote UE implementation whether to release or keep the unicast PC5 link. If U2N Remote UE decides to release the unicast PC5 link, it triggers the L2 release procedure and may perform relay reselection.

### Control Plane Procedures for L2 U2N Relay

### 1) RRC Connection Management

The U2N Remote UE needs to establish its own PDU sessions/DRBs with the network before user plane data transmission.

The NR V2X PC5 unicast link establishment procedures can be reused to setup a secure unicast link between U2N Remote UE and U2N Relay UE before U2N Remote UE establishes a Uu RRC connection with the network via U2N Relay UE.

The establishment of Uu SRB1/SRB2 and DRB of the U2N Remote UE is subject to Uu configuration procedures for L2 UE-to-Network Relay.

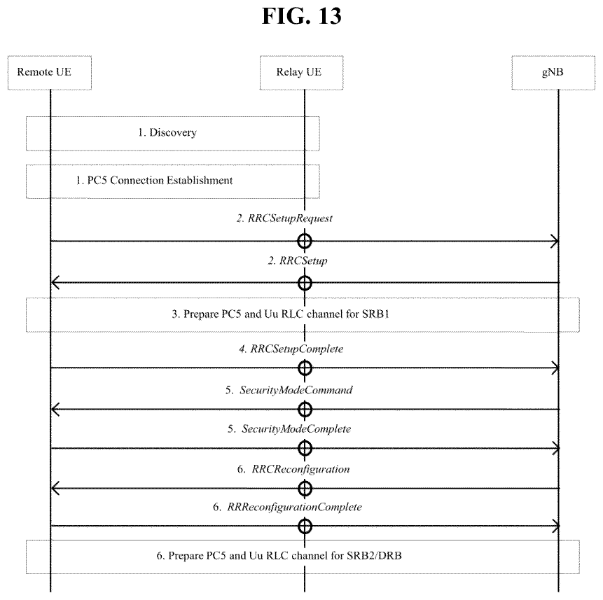

FIG. 13 illustrates a procedure for L2 U2N Remote UE connection establishment. The following high level connection establishment procedure in FIG. 13 applies to L2 U2N Relay:
1. The U2N Remote and U2N Relay UE perform discovery procedure, and establish PC5-RRC connection using NR V2X procedure.
2. The U2N Remote UE sends the first RRC message (i.e., RRCSetupRequest) for its connection establishment with gNB via the Relay UE, using a specified PC5 Relay RLC channel configuration. If the U2N Relay UE is not in RRC_CONNECTED, it needs to do its own connection establishment upon reception of a message on the specified PC5 Relay RLC channel. During Relay UE's RRC connection establishment procedure, gNB may configure SRB0 relaying Uu Relay RLC channel to the U2N Relay UE. The gNB responds with an RRCSetup message to U2N Remote UE. The RRCSetup message is sent to the U2N Remote UE using SRB0 relaying channel over Uu and a specified PC5 Relay RLC channel over PC5.
3. The gNB and U2N Relay UE perform relaying channel setup procedure over Uu. According to the configuration from gNB, the U2N Relay/Remote UE establishes an PC5 Relay RLC channel for relaying of SRB1 towards the U2N Remote/Relay UE over PC5.
4. The RRCSetupComplete message is sent by the U2N Remote UE to the gNB via the U2N Relay UE using SRB1 relaying channel over PC5 and SRB1 relaying channel configured to the U2N Relay UE over Uu. Then the U2N Remote UE is RRC connected over Uu.
5. The U2N Remote UE and gNB establish security following Uu procedure and the security messages are forwarded through the U2N Relay UE.
6. The gNB sends an RRCReconfiguration message to the U2N Remote UE via the U2N Relay UE, to setup the SRB2/DRBs for relaying purpose. The U2N Remote UE sends an RRCReconfigurationComplete message to the gNB via the U2N Relay UE as a response. In addition, the gNB configures additional Uu Relay RLC channels between the gNB and U2N Relay UE, and PC5 Relay RLC channels between U2N Relay UE and U2N Remote UE for the relay traffic.

### 2) Radio Link Failure

The U2N Remote UE in RRC_CONNECTED suspends Uu RLM when U2N Remote UE is connected to gNB via U2N Relay UE.

The U2N Relay UE declares Radio Link Failure (RLF) following the same criteria.

After RLF is declared, the U2N Relay UE takes the following action on top of the actions:
a PC5-RRC message can be used for sending an indication to its connected U2N Remote UE(s), which may trigger RRC connection re-establishment for U2N Remote UE.

Upon detecting PC5 RLF, the U2N Remote UE may trigger connection re-establishment.

### 3) RRC Connection Re-Establishment

The U2N Remote UE may perform the following actions during the RRC connection re-establishment procedure:
If only suitable cell(s) are available, the U2N Remote UE initiates RRC re-establishment procedure towards a suitable cell;
If only suitable U2N Relay UE(s) are available, the U2N Remote UE initiates RRC re-establishment procedure towards a suitable relay UE's serving cell;
If both a suitable cell and a suitable relay are available, the U2N Remote UE can select either one to initiate RRC re-establishment procedure based on implementation.

### 4) RRC Connection Resume

The RRC connection resume mechanism is applied to U2N Remote UE.

### 5) System Information

The in-coverage U2N Remote UE is allowed to acquire any necessary SIB(s) over Uu interface irrespective of its PC5 connection to Relay UE. The U2N Remote UE can also receive the system information from the Relay UE after PC5 connection establishment with U2N Relay UE.

The U2N Remote UE in RRC_CONNECTED can use the on-demand SIB framework to request the SIB(s) via U2N Relay UE. The U2N Remote UE in RRC_IDLE or RRC_INACTIVE can inform U2N Relay UE of its requested SIB type(s) via PC5-RRC message. Then, U2N Relay UE triggers on-demand SI/SIB acquisition procedure according to its own RRC state (if needed) and sends the acquired SI(s)/SIB(s) to U2N Remote UE via PC5-RRC.

Any SIB that the RRC_IDLE or RRC_INACTIVE U2N Remote UE has a requirement to use (e.g., for relay purpose) can be requested by the U2N Remote UE (from the U2N Relay UE or the network). For SIBs that have been requested by the U2N Remote UE from the U2N Relay UE, the U2N Relay UE forwards them again in case of any update for requested SIB(s). In case of RRC_CONNECTED U2N Remote UE(s), it is the responsibility of the network to send updated SIB(s) to U2N Remote UE(s) when they are updated. The U2N Remote UE de-configures SI request with U2N Relay UE when entering into RRC_CONNECTED state.

For SIB1 forwarding, for U2N Remote UE, both request-based delivery (i.e., SIB1 request by the U2N Remote UE) and unsolicited forwarding are supported by U2N Relay UE, of which the usage is left to U2N Relay UE implementation. If SIB1 changes, for U2N Remote UE in RRC_IDLE or RRC_INACTIVE, the U2N Relay UE always forwards SIB1.

For the L2 U2N Remote UE in RRC_IDLE or RRC_INACTIVE, the short message over Uu interface is not forwarded by the L2 U2N Relay UE to the L2 U2N Remote UE. The L2 U2N Relay UE can forward PWS SIBs to its connected L2 U2N Remote UE(s).

RAN sharing is supported for L2 U2N Relay UE. In particular, the L2 U2N Relay UE may forward, via discovery message, cell access related information before the establishment of a PC5-RRC connection.

### 6) Paging

When both U2N Relay UE and U2N Remote UE are in RRC IDLE or RRC INACTIVE, the U2N Relay UE monitors paging occasions of its connected U2N Remote UE(s). When a U2N Relay UE needs to monitor paging for a U2N Remote UE, the U2N Relay UE should monitor all POs of the U2N Remote UE.

When U2N Relay UE is in RRC CONNECTED and U2N Remote UE(s) is in RRC_IDLE or RRC_INACTIVE, there are two options for paging delivery:
The U2N Relay UE monitors POs of its connected U2N Remote UE(s) if the active DL BWP of U2N Relay UE is configured with CORESET and paging search space.
The delivery of the U2N Remote UE's paging can be performed through dedicated RRC message from the gNB to the U2N Relay UE. The dedicated RRC message for delivering Remote UE paging to the RRC_CONNECTED Relay UE may contain one or more Remote UE IDs (5G-S-TMSI or I-RNTI).

It is up to network implementation to decide which of the above two options to use. The U2N Relay UE in RRC CONNECTED, if configured with paging search space, can determine whether to monitor POs for a U2N Remote UE based on PC5-RRC signalling received from the U2N Remote UE.

The U2N Remote UE in RRC_IDLE provides 5G-S-TMSI and UE specific DRX cycle (configured by upper layer) to the U2N Relay UE to request it to perform PO monitoring. The U2N Remote UE in RRC_INACTIVE provides minimum value of two UE specific DRX cycles (configured by upper layer and configured by RAN), 5G-S-TMSI and I-RNTI to the U2N Relay UE for PO monitoring. The L2 U2N Relay UE can notify Remote UE information (i.e. 5G-S-TMSI/I-RNTI) to the gNB via SidelinkUEInformationNR message for paging delivery purpose. The U2N Relay UE receives paging messages to check the 5G-S-TSMI/I-RNTI and sends relevant paging record to the Remote UE accordingly.

The U2N Relay UE can use unicast signalling to send paging to the U2N Remote UE via PC5.

### 7) Access Control

The U2N Remote UE performs unified access control. The U2N Relay UE in RRC-CONNECTED does not perform UAC for U2N Remote UE's data.

### 8) Mobility Registration Update and RAN Area Update

The L2 U2N Remote UE performs Mobility Registration Update/RNAU based on the L2 U2N Relay UE's serving cell when it is connected with the L2 U2N Relay UE. A L2 U2N Remote UE in RRC_IDLE or RRC_INACTIVE initiates Mobility Registration Update/RNAU procedure if the serving cell changes (due to cell change by the U2N Relay UE) and the new serving cell is outside of the U2N Remote UE's configured RNA/TA.

### Service Continuity for L2 U2N Relay

1) Switching from Indirect to Direct Path

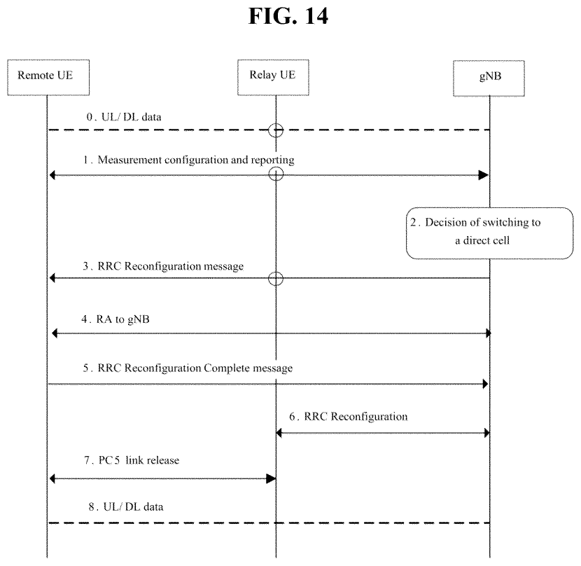

FIG. 14 illustrates a Procedure for U2N Remote UE switching to direct Uu cell.

For service continuity of L2 U2N Relay, the following procedure is used, in case of U2N Remote UE switching to direct path:
1. The Uu measurement configuration and measurement report signalling procedures are performed to evaluate both relay link measurement and Uu link measurement. The measurement results from U2N Remote UE are reported when configured measurement reporting criteria are met. The sidelink relay measurement report shall include at least U2N Relay UE's source L2 ID, serving cell ID (i.e., NCGI), and sidelink measurement quantity information. The sidelink measurement quantity can be SL-RSRP of the serving U2N Relay UE, and if SL-RSRP is not available, SD-RSRP is used.
2. The gNB decides to switch the U2N Remote UE onto direct Uu path.
3. The gNB sends RRCReconfiguration message to the U2N Remote UE. The U2N Remote UE stops UP and CP transmission via U2N Relay UE after reception of RRCReconfiguration message from the gNB.
4. The U2N Remote UE synchronizes with the gNB and performs Random Access.
5. The UE (i.e., U2N Remote UE in previous steps) sends the RRCReconfigurationComplete to the gNB via direct path, using the configuration provided in the RRCReconfiguration message. From this step, the UE (i.e., U2N Remote UE in previous steps) uses the RRC connection via the direct path to the gNB.
6. The gNB sends RRCReconfiguration message to the U2N Relay UE to reconfigure the connection between the U2N Relay UE and the gNB. The RRCReconfiguration message to the U2N Relay UE can be sent any time after step 3 based on gNB implementation (e.g., to release Uu and PC5 Relay RLC channel configuration for relaying, and bearer mapping configuration between PC5 RLC and Uu RLC).
7. Either U2N Relay UE or U2N Remote UE can initiate the PC5 unicast link release (PC5-S). The timing to execute link release is up to UE implementation. The U2N Relay UE can execute PC5 connection reconfiguration to release PC5 Relay RLC channel for relaying upon reception of RRC Reconfiguration by gNB in Step 6, or the UE (i.e., previous U2N Remote UE) can execute PC5 connection reconfiguration to release PC5 Relay RLC channel for relaying upon reception of RRCReconfiguration by gNB in Step 3.
8. The data path is switched from indirect path to direct path between the UE (i.e., previous U2N Remote UE) and the gNB. The DL/UL lossless delivery during the path switch is done according to PDCP data recovery procedure.

NOTE: Step 8 can be executed any time after step 4. Step 8 is independent of step 6 and step 7.

2) Switching from Direct to Indirect Path

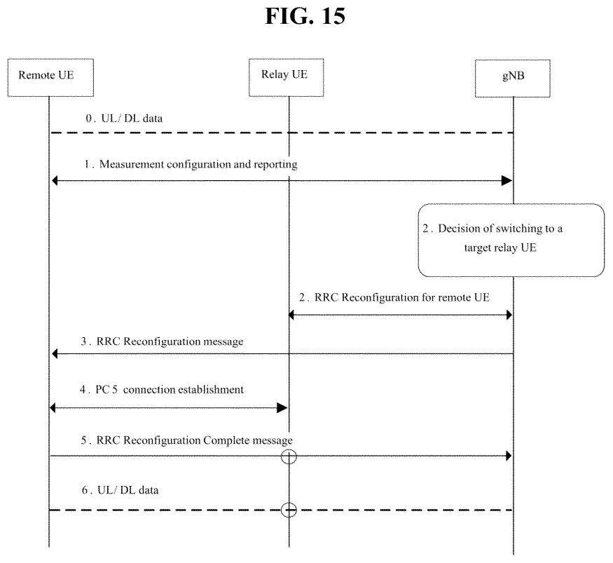

FIG. 15 illustrates a Procedure for U2N Remote UE switching to indirect path.

The gNB can select a U2N Relay UE in any RRC state i.e., RRC_IDLE, RRC_INACTIVE, or RRC_CONNECTED, as a target U2N Relay UE for direct to indirect path switch.

For service continuity of L2 U2N Remote UE, the following procedure is used, in case of the L2 U2N Remote UE switching to indirect path via a U2N Relay UE in RRC_CONNECTED:
1. The U2N Remote UE reports one or multiple candidate U2N Relay UE(s) and Uu measurements, after it measures/discovers the candidate U2N Relay UE(s).
The UE may filter the appropriate U2N Relay UE(s) according to Relay selection criteria before reporting. The UE shall report only the U2N Relay UE candidate(s) that fulfil the higher layer criteria.
The reporting can include at least U2N Relay UE ID, U2N Relay UE's serving cell ID, and sidelink measurement quantity information. The sidelink measurement quantity can be SL-RSRP of the candidate U2N Relay UE, and if SL-RSRP is not available, SD-RSRP is used.
2. The gNB decides to switch the U2N Remote UE to a target U2N Relay UE. Then the gNB sends an RRCReconfiguration message to the target U2N Relay UE, which can include at least Remote UE's local ID and L2 ID, Uu and PC5 Relay RLC channel configuration for relaying, and bearer mapping configuration.
3. The gNB sends the RRCReconfiguration message to the U2N Remote UE. The contents in the RRCReconfiguration message can include at least U2N Relay UE ID, PC5 Relay RLC channel configuration for relay traffic and the associated end-to-end radio bearer(s). The U2N Remote UE stops UP and CP transmission over Uu after reception of RRCReconfiguration message from the gNB.
4. The U2N Remote UE establishes PC5 connection with target U2N Relay UE
5. The U2N Remote UE completes the path switch procedure by sending the RRCReconfigurationComplete message to the gNB via the Relay UE.
6. The data path is switched from direct path to indirect path between the U2N Remote UE and the gNB.

In case the selected U2N Relay UE for direct to indirect path switch is in RRC_IDLE or RRC_INACTIVE, after receiving the path switch command, the U2N Remote UE establishes a PC5 link with the U2N Relay UE and sends the RRCReconfigurationComplete message via the U2N Relay UE, which will trigger the U2N Relay UE to enter RRC_CONNECTED state. The procedure for U2N Remote UE switching to indirect path in FIG. 15 can be also applied for the case that the selected U2N Relay UE for direct to indirect path switch is in RRC_IDLE or RRC_INACTIVE with the exception that step 4 is performed before step 2.

### Sidelink Discovery

The UE may perform NR sidelink discovery while in-coverage or out-of-coverage for non-relay operation.

The Relay discovery mechanism (except the U2N Relay specific threshold based discovery message transmission) is also applied to sidelink discovery.

### Dynamic Path Switching and Activation and Deactivation of PDCP Duplication for Multi-Path Operation

Benefits from multi-path are expected in following areas:
Relay and direct multi-path operation (including both scenarios 1 and 2) can provide efficient path switching between direct path and indirect path
The remote UE in multi-path operation can provide enhanced user data throughput and reliability compared to a single link
gNB can offload the direct connection of the remote UE in congestion to indirect connection via the relay UE (e.g. at different intra/inter-frequency cells)

The multi-path with relay and UE aggregation can improve the throughput and reliability/robustness, e.g., for UE at the edge of a cell, and UE with limited UL transmission power.

The terms “relay UE” and “remote UE” are used for scenarios 1 and 2. Ff we would use additional terms specific to scenario 2.

The remote UE in Scenario 1 and the remote UE in Scenario 2 as follows:
Scenario 1: the remote UE is connected to the same gNB using one direct path and one indirect path via 1) Layer-2 UE-to-Network relay,
Scenario 2: the remote UE is connected to the same gNB using one direct path and one indirect path via 2) via another UE (where the UE-UE inter-connection is assumed to be ideal).

It is assumed that the relation between remote UE and relay UE in scenario 2 is pre-configured or static and how the relation is pre-configured or static is out of the 3GPP scope.

There may be discussion on authorization and association mechanism between remote UE and relay UE in scenario 2.

Support the following cell deployment scenarios for multi-path relaying in Rel-18:
Scenario C1: The relay UE and remote UE are served by a same cell.
Scenario C2: The relay UE and remote UE are served by different intra-frequency cells of a same gNB
Scenario C3: The relay UE and remote UE are served by different inter-frequency cells of a same gNB

Support the following sidelink scenarios for multi-path:
Scenario S1: SL TX/RX and Uu share the same carrier at the remote UE.
Scenario S2: SL TX/RX and Uu use different carriers at the remote UE.
Scenario S3: SL TX/RX and Uu share the same carrier at the relay UE.
Scenario S4: SL TX/RX and Uu use different carriers at the relay UE.

Support direct bearer (bearer mapped to direct path on Uu), indirect bearer (bearer mapped to indirect path via relay UE), and MP split bearer (bearer mapped to both paths, based on the existing split bearer framework).

For a MP split bearer in scenario 1, one PDCP entity at the remote UE is configured with one direct Uu RLC channel and one indirect PC5 RLC channel.
For upstream, a PDCP entity delivers to a Uu RLC entity and a PC5 RLC entity with SRAP entity in the remote UE side.
For downstream, a PDCP entity receives from a Uu RLC entity and a PC5 RLC entity with SRAP entity in the remote UE side.

There may be decisions on the mapping of protocol entities in scenario 2.

From a perspective, multi-path scenario should be supported in Rel-18.

Both intra-DU and inter-DU cases will be supported under the same gNB.

It is needed to define control plane and user plane scenarios for multi-path support.

It is needed to define the Primary path in multi-path support.

Addition of direct/indirect path are supported as follows:
Add direct path, after the establishment of the indirect path.
Add indirect path, after the establishment of the direct path.
This does not imply the exclusion of any other path addition possibility.

The signaling impact on the direct or indirect path change under the same gNB for a UE connected via multi-path is studied. The other mobility scenarios can be further considered based on RAN2 decision.

The following use cases may not be supported in Rel-18.
Configure two indirect paths
More than two paths
Inter-gNB multi-path support

In NR standard discussion it is agreed that for a MP split bearer in scenario 1, one PDCP entity at the remote UE is configured with one direct Uu RLC channel and one indirect PC5 RLC channel. For upstream, a PDCP entity delivers to a Uu RLC entity and a PC5 RLC entity with SRAP entity in the remote UE side. For downstream, a PDCP entity receives from a Uu RLC entity and a PC5 RLC entity with SRAP entity in the remote UE side. Note that it is understood that the SRAP entity is also configured for the indirect path in scenario 1 considering that the indirect path corresponds to the Rel-17 U2N RLC channel.

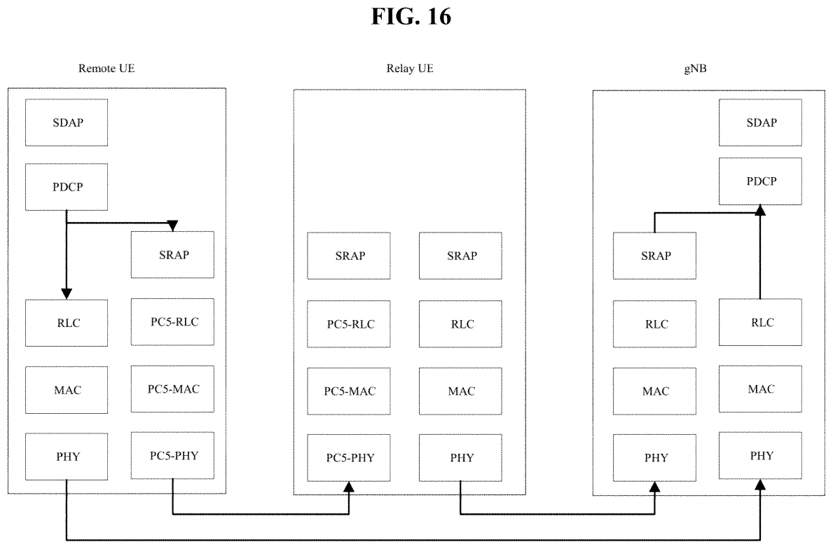

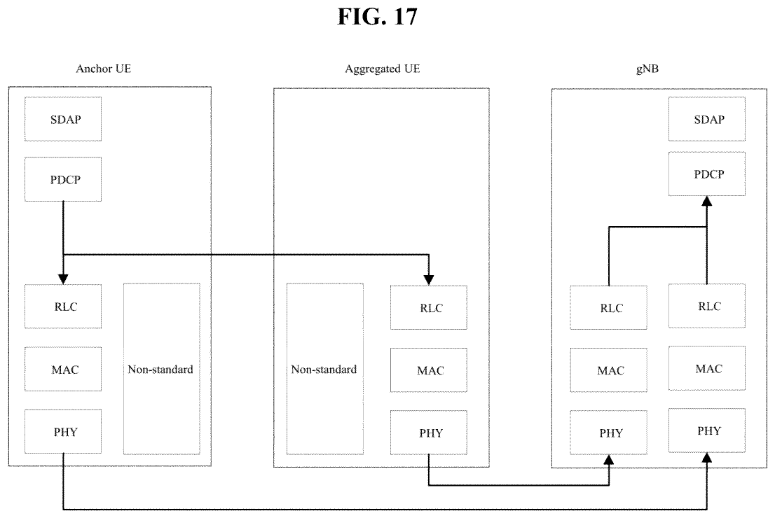

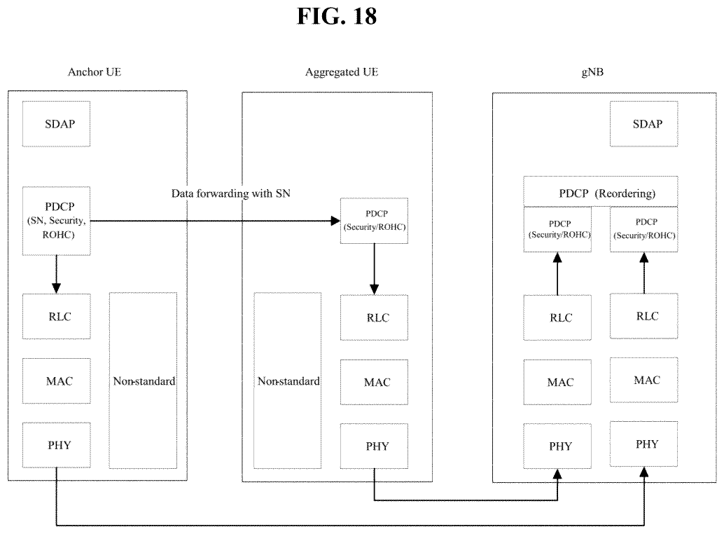

The adaptation layer is also needed to support the scenario 2 as in FIG. 16 (e.g. for data routing with bearer mapping/identification) while others think that the adaptation layer is not needed (e.g. as in FIG. 17 or FIG. 18).

According to the prior art, when a relay UE and a remote UE are configured with UE-to-Network Relay (U2N Relay) function, the relay UE provides connectivity to the network for U2N Remote UE(s). In this case, the remote UE does not have direct connection with the network while maintaining the indirect connection based on U2N relay function.

Meanwhile, it is beneficial for the remote UE to support multi-path (MP) operation by maintaining the direct connection on Uu only as well as the indirect connection based on both PC5 and Uu. The remote UE configured with MP operation can select one or both of the connections for data transmission towards the network for more reliable transmission and/or higher throughput.

For MP operation, the remote UE configure the indirect connection and the direct connection. It is not clear how the remote UE UE select one or both of the the indirect connection and the direct connection for data transmission and how the remote UE performs path switching and PDCP duplication.

The method for performing data transmission by a UE includes the following steps:

When both a direct path and an indirect path through a relay UE are configured between the base station and the remote UE, a method of path switching and activation/deactivation of PDCP duplication based on activation/deactivation of one or more RLC entities of split bearer configured in the the remote UE is proposed.

For the MP split bearer, one PDCP entity is associated with one primary RLC entity and one or more split secondary RLC entity. When a bearer is configured, the gNB can inform the remote UE which RLC entity is used for the primary RLC entity or the split secondary RLC entity e.g. by indicating the path type associated to the RLC entity and/or LCID (logical channel identity) associated to the RLC entity in the bearer configuration. that can be sent to the remote UE indirectly via relay UE or directly from the gNB.

In the configuration from the gNB,
each RLC entity of the MP split bearer can be associated with either the direct path or the indirect path.
each RLC entity of the MP split bearer can be configured as either the primary RLC entity or the split secondary path.

If no explicit configuration/command has been received from the gNB, the remote UE considers one or more of the followings:
the RLC entity associated with the direct path is always configured as the primary RLC entity and the RLC entity associated with the indirect path is always configured as the split secondary RLC entity
the RLC entity associated with the indirect path is always configured as the primary RLC entity and the RLC entity associated with the direct path is always configured as the split secondary RLC entity

Upon detection of one or more of the following conditions, if a primary RLC entity of the MP split bearer has been configured on the direct path, the RLC entity associated with the indirect path (i.e. SL RLC entity) is (re-)configured as the primary RLC entity and activated if in the deactivated state, while the RLC entity associated with the direct path (i.e. UL RLC entity) is (re-)configured as the split secondary RLC entity for the MP split bearer and deactivated if in the activated state.
Detection of Uu failure of the direct path

Upon detection of one or more of the following conditions, if a primary RLC entity of the MP split bearer has been configured on the indirect path, the RLC entity associated with the direct path (i.e. UL RLC entity) is (re-)configured as the primary RLC entity and activated if in the deactivated state, and the RLC entity associated with the indirect path (i.e. SL RLC entity or U2N RLC entity) is (re-)configured as the split secondary RLC entity for the MP split bearer and deactivated if in the activated state.
Detection of sidelink failure of the indirect path i.e. between the remote UE and the relay UE
Receiving failure information from the relay UE (e.g. Uu failure between the relay UE and a gNB)

In this application, failure can correspond to one or more of Integrity protection failure, RLC retransmission failure, RLF, bearer reconfiguration failure, beam failure, a measured result below a threshold, (high) congestion level above a threshold and LBT failure over sidelilnk or Uu.

If one or more MP split RBs are configured with MP PDCP duplication, the gNB may activate and deactivate the PDCP duplication for all or a subset of associated RLC entities for the configured DRB(s).

The PDCP duplication for the configured RB(s) of the MP split bearer type is activated and deactivated in the remote UE by:
receiving the DL MP Duplication Activation/Deactivation MAC CE in DL directly from the gNB; or
receiving the DL MP Duplication RLC Activation/Deactivation MAC CE in DL directly from the gNB; or
receiving the SL MP Duplication Activation/Deactivation MAC CE in SL indirectly via the relay UE from the gNB; or
   For this reception in the remote UE, when the relay UE receives the MP Duplication Activation/Deactivation MAC CE in DL from the gNB, the relay UE copied and relays the MP Duplication Activation/Deactivation MAC CE to be transmitted in SL.
receiving the SL MP Duplication RLC Activation/Deactivation MAC CE in SL indirectly via the relay UE from the gNB; or
   For this reception in the remote UE, when the relay UE receives the MP Duplication RLC Activation/Deactivation MAC CE in DL from the gNB, the relay UE copied and relays the MP Duplication Activation/Deactivation MAC CE to be transmitted in SL.
Indication to activation or deactivation of the PDCP entity and/or each RLC entity of the MP split bearer by a RRC message indirectly via the relay UE or directly from the gNB.

The PDCP duplication for all or a subset of associated RLC entities for the configured RB(s) is activated and deactivated in the remote UE by:
receiving the DL MP Duplication RLC Activation/Deactivation MAC CE directly from the gNB; or
receiving the SL MP Duplication RLC Activation/Deactivation MAC CE indirectly via the relay UE from the gNB;
Indication to activation or deactivation of each RLC entity of the MP split bearer by a RRC message indirectly via the relay UE or directly from the gNB.

### DL MP Duplication Activation/Deactivation MAC CE

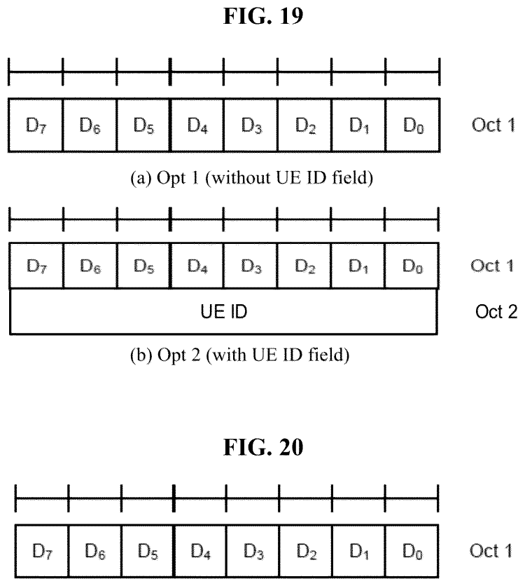

FIG. 19 illustrates DL MP Duplication Activation/Deactivation MAC CE to be carried in a MAC PDU on DL-SCH.

The DL MP Duplication Activation/Deactivation MAC CE of one octet is identified by a MAC subheader with a specific LCID value of a MAC PDU on DL-SCH. It has a fixed size and consists of a single octet containing eight D-fields. The Duplication Activation/Deactivation MAC CE is defined, for a MAC entity, as follows in FIG. 19.
Di: This field indicates the activation/deactivation status of the PDCP duplication of RB i where i is the ascending order of the RB ID among the MP split RBs configured with PDCP duplication and with RLC entity(ies) associated with this MAC entity. The Di field is set to 1 to indicate that the PDCP duplication of RB i shall be activated. The Di field is set to 0 to indicate that the PDCP duplication of RB i shall be deactivated.
UE ID: This field indicates the local identity of U2N Remote UE which can be the same UE ID as configured for the SRAP entity of the MP split bearer.

### SL MP Duplication Activation/Deactivation MAC CE

FIG. 20 illustrates SL MP Duplication Activation/Deactivation MAC CE to be carried in a MAC PDU on SL-SCH.

The SL MP Duplication Activation/Deactivation MAC CE of one octet is identified by a MAC subheader with a specific LCID value of a MAC PDU on SL-SCH. It has a fixed size and consists of a single octet containing eight D-fields. The Duplication Activation/Deactivation MAC CE is defined, for a MAC entity, as follows in FIG. 20.

Di: This field indicates the activation/deactivation status of the PDCP duplication of RB i where i is the ascending order of the RB ID among the MP split RBs configured with PDCP duplication and with RLC entity(ies) associated with this MAC entity of the remote UE. The Di field is set to 1 to indicate that the PDCP duplication of RB i shall be activated. The Di field is set to 0 to indicate that the PDCP duplication of RB i shall be deactivated.

If the remote UE receives SL MP Duplication Activation/Deactivation MAC CE on SL-SCH via the PC5 unicast link with the relay UE, the remote UE activates or deactivates the PDCP duplication of the corresponding PDCP entity associated with RB i of the MP split bearer type.

### DL MP Duplication RLC Activation/Deactivation MAC CE

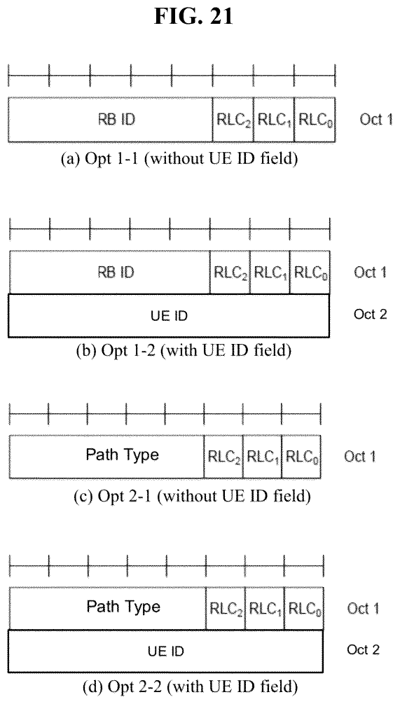

FIG. 21: DL MP Duplication RLC Activation/Deactivation MAC CE to be carried in a MAC PDU on DL-SCH.

The Duplication RLC Activation/Deactivation MAC CE is identified by a MAC subheader with a specific LCID value of a MAC PDU on DL SCH. It has a fixed size and consists of a single octet defined as follows in FIG. 21.
RB ID: This field indicates the identity of RB among the MP split bearers for which the MAC CE applies. The length of the field is 5 bits;
Path Type (or Path ID): This field indicates the 5-bit identity of a path among direct path and indirect path or the 1-bit indication to one of the direct path and indirect path for which the MAC CE applies. The length of the field is 1 or 5 bits;
   If more than one bit identify (e.g. 5 bits) is configured, this field indicates one of multiple paths configured for the remote UE. For example, the remote UE can be configured with more than one direct path and/or more than one indirect path. Different direct paths are associated with different gNBs or cells while different indirect paths are associated with different relay UEs and/or different gNBs/cells serving a relay UE for the remote UE. In this case, each of direct paths and indirect paths are identified by path ID which can replace path type field in FIG. 21.
   If one bit identify is configured, this field indicates either the direct path or indirect path of the remote UE.
   Alternatively, the Path Type field can be replaced by cell ID for UL/DL or UL/SL BWP ID or cell group ID for a specific path or a specific path type.
RLCi: This field indicates the activation/deactivation status of PDCP duplication for the secondary RLC entity i where i is ascending order of logical channel ID of secondary RLC entities (in the order of direct path and indirect path, for the RB or vice versa).
   Alternatively, this field indicates the activation/deactivation status of PDCP duplication for the primary and secondary RLC entity i where i is ascending order of logical channel ID of the primary RLC entity and secondary RLC entities in the order of the primary RLC entity and secondary RLC entities, for the RB (or vice versa).
   Alternatively, this field indicates the activation/deactivation status of PDCP duplication for the UL RLC entity and SL RLC entity i where i is ascending order of UL logical channel ID of the UL RLC entities and SL logical channel ID of SL RLC entities in the order of the UL RLC entities and SL RLC entities, for the RB (or vice versa).
   Note that different secondary RLC entities can be configured on both direct path and indirect path or on both primary path and secondary path of the MP operation.
   The RLCi field is set to 1 to indicate that the PDCP duplication for the RLC entity i shall be activated. The RLCi field is set to 0 to indicate that the PDCP duplication for the RLC entity i shall be deactivated.
UE ID: This field indicates the local identity of U2N Remote UE which can be the same UE ID as configured for the SRAP entity of the MP split bearer.

### SL MP Duplication RLC Activation/Deactivation MAC CE

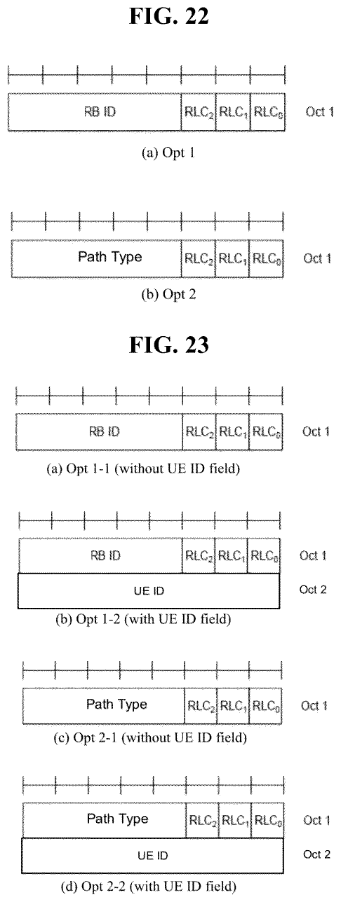

FIG. 22 illustrates SL Duplication RLC Activation/Deactivation MAC CE to be carried in a MAC PDU on SL-SCH.

The SL MP Duplication RLC Activation/Deactivation MAC CE is identified by a MAC subheader with a specific LCID value of a MAC PDU on SL SCH. It has a fixed size and consists of a single octet defined as follows in FIG. 22.
RB ID: This field indicates the identity of RB among the MP split bearers for which the MAC CE applies. The length of the field is 5 bits;
Path Type (or Path ID): This field indicates the 5-bit identity of a path among direct path and indirect path or the 1-bit indication to one of the direct path and indirect path for which the MAC CE applies. The length of the field is 1 or 5 bits;
   If more than one bit identify (e.g. 5 bits) is configured, this field indicates one of multiple paths configured for the remote UE. For example, the remote UE can be configured with more than one direct path and/or more than one indirect path. Different direct paths are associated with different gNBs or cells while different indirect paths are associated with different relay UEs and/or different gNBs/cells serving a relay UE for the remote UE. In this case, each of direct paths and indirect paths are identified by path ID which can replace path type field in FIG. 22.
   If one bit identify is configured, this field indicates either the direct path or indirect path of the remote UE.
   Alternatively, the Path Type field can be replaced by cell ID for UL/DL or UL/SL BWP ID or cell group ID for a specific path or a specific path type.
RLCi: This field indicates the activation/deactivation status of PDCP duplication for the secondary RLC entity i where i is ascending order of logical channel ID of secondary RLC entities (in the order of direct path and indirect path, for the RB or vice versa).
   Alternatively, this field indicates the activation/deactivation status of PDCP duplication for the primary and secondary RLC entity i where i is ascending order of logical channel ID of the primary RLC entity and secondary RLC entities in the order of the primary RLC entity and secondary RLC entities, for the RB (or vice versa).
   Alternatively, this field indicates the activation/deactivation status of PDCP duplication for the UL RLC entity and SL RLC entity i where i is ascending order of UL logical channel ID of the UL RLC entities and SL logical channel ID of SL RLC entities in the order of the UL RLC entities and SL RLC entities, for the RB (or vice versa).
   Note that different secondary RLC entities can be configured on both direct path and indirect path or on both primary path and secondary path of the MP operation.
   The RLCi field is set to 1 to indicate that the PDCP duplication for the RLC entity i shall be activated. The RLCi field is set to 0 to indicate that the PDCP duplication for the RLC entity i shall be deactivated.

### DL MP Dynamic Path Switching MAC CE

FIG. 23 illustrates DL MP Dynamic Path Switching MAC CE to be carried in a MAC PDU on DL-SCH

The MP Dynamic Path Switching MAC CE is identified by a MAC subheader with a specific LCID value of a MAC PDU on DL SCH. It has a fixed size and consists of a single octet defined as follows in FIG. 23.
RB ID: This field indicates the identity of RB among the MP split bearers for which the MAC CE applies. The length of the field is 5 bits;
Path Type (or Path ID): This field indicates the 5-bit identity of a path among direct path and indirect path or the 1-bit indication to one of the direct path and indirect path for which the MAC CE applies. The length of the field is 1 or 5 bits;
   If more than one bit identify (e.g. 5 bits) is configured, this field indicates one of multiple paths configured for the remote UE. For example, the remote UE can be configured with more than one direct path and/or more than one indirect path. Different direct paths are associated with different gNBs or cells while different indirect paths are associated with different relay UEs and/or different gNBs/cells serving a relay UE for the remote UE. In this case, each of direct paths and indirect paths are identified by path ID which can replace path type field in FIG. 23.
   If one bit identify is configured, this field indicates either the direct path or indirect path of the remote UE.
   Alternatively, the Path Type field can indicates cell ID for UL/DL or UL/SL BWP ID or cell group ID for a specific path or a specific path type (e.g. primary path or secondary path or direct path or indirect path).
RLCi: This field indicates the activation/deactivation status of the RLC entity i where i is ascending order of logical channel ID of RLC entities (in the order of direct path and indirect path, for the RB or vice versa).
   Alternatively, this field indicates the activation/deactivation status of the primary and/or secondary RLC entity i where i is ascending order of logical channel ID of the primary RLC entity and secondary RLC entities in the order of the primary RLC entity and secondary RLC entities, for the RB (or vice versa).
   Alternatively, this field indicates the activation/deactivation status of the UL RLC entity and/or SL RLC entity i where i is ascending order of UL logical channel ID of the UL RLC entities and SL logical channel ID of SL RLC entities in the order of the UL RLC entities and SL RLC entities, for the RB (or vice versa).
   Note that different secondary RLC entities can be configured on both direct path and indirect path or on both primary path and secondary path of the MP operation.
   The RLCi field is set to 1 to indicate that the RLC entity i shall be activated. The RLCi field is set to 0 to indicate that the RLC entity i shall be deactivated.
   Alternatively, If only RLC entity is configured for the primary path or the direct path, RLC 0 (i.e. i=0) is used to indicate activation or deactivation of the RLC entity for primary path or the direct path. RLC i field (i>0) is used to indicate activation or deactivation of the RLC entity for secondary path or the indirect path.

### SL MP Dynamic Path Switching MAC CE

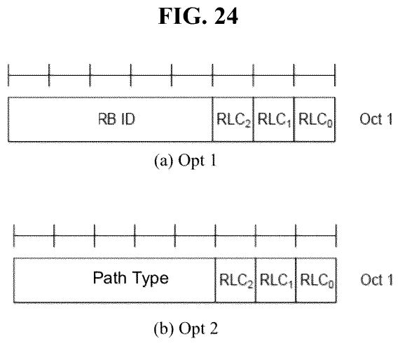

FIG. 24 illustrates SL MP Dynamic Path Switching MAC CE to be carried in a MAC PDU on SL-SCH

The MP Dynamic Path Switching MAC CE is identified by a MAC subheader with a specific LCID value of a MAC PDU on SL SCH. It has a fixed size and consists of a single octet defined as follows in FIG. 24.
RB ID: This field indicates the identity of RB among the MP split bearers for which the MAC CE applies. The length of the field is 5 bits;
Path Type (or Path ID): This field indicates the 5-bit identity of a path among direct path and indirect path or the 1-bit indication to one of the direct path and indirect path for which the MAC CE applies. The length of the field is 1 or 5 bits;
   If more than one bit identify (e.g. 5 bits) is configured, this field indicates one of multiple paths configured for the remote UE. For example, the remote UE can be configured with more than one direct path and/or more than one indirect path. Different direct paths are associated with different gNBs or cells while different indirect paths are associated with different relay UEs and/or different gNBs/cells serving a relay UE for the remote UE. In this case, each of direct paths and indirect paths are identified by path ID which can replace path type field in FIG. 24.
   If one bit identify is configured, this field indicates either the direct path or indirect path of the remote UE.
   Alternatively, the Path Type field can indicates cell ID for UL/DL or UL/SL BWP ID or cell group ID for a specific path or a specific path type (e.g. primary path or secondary path or direct path or indirect path).
RLCi: This field indicates the activation/deactivation status of the RLC entity i where i is ascending order of logical channel ID of RLC entities (in the order of direct path and indirect path, for the RB or vice versa).
   Alternatively, this field indicates the activation/deactivation status of the primary and/or secondary RLC entity i where i is ascending order of logical channel ID of the primary RLC entity and secondary RLC entities in the order of the primary RLC entity and secondary RLC entities, for the RB (or vice versa).
   Alternatively, this field indicates the activation/deactivation status of the UL RLC entity and/or SL RLC entity i where i is ascending order of UL logical channel ID of the UL RLC entities and SL logical channel ID of SL RLC entities in the order of the UL RLC entities and SL RLC entities, for the RB (or vice versa).
   Note that different secondary RLC entities can be configured on both direct path and indirect path or on both primary path and secondary path of the MP operation.
   The RLCi field is set to 1 to indicate that the RLC entity i shall be activated. The RLCi field is set to 0 to indicate that the RLC entity i shall be deactivated.
   Alternatively, If only RLC entity is configured for the primary path or the direct path, RLC 0 (i.e. i=0) is used to indicate activation or deactivation of the RLC entity for primary path or the direct path. RLC i field (i>0) is used to indicate activation or deactivation of the RLC entity for secondary path or the indirect path.

Activation/Deactivation of PDCP duplication and Dynamic Path Switching MAC CE in the remote UE and the relay UE

If the direct path is configured as the primary path of MP operation and/or if the direct path is not deactivated and/or if the indirect path is deactivated or experiences link failure,
the gNB may send MP Duplication Activation/Deactivation MAC CE and/or MP Duplication RLC Activation/Deactivation MAC CE by using the direct path only, i.e. the remote UE receives the MP Duplication Activation/Deactivation MAC CE and/or MP Duplication RLC Activation/Deactivation MAC CE in DL.

Else, if the indirect path is configured as the primary path of MP operation and/or if the indirect path is not deactivated and/or if the direct path is deactivated or experiences link failure,
the gNB may send MP Duplication Activation/Deactivation MAC CE and/or MP Duplication RLC Activation/Deactivation MAC CE by using the indirect path only via the relay UE, i.e. the remote UE receives the MP Duplication Activation/Deactivation MAC CE and/or MP Duplication RLC Activation/Deactivation MAC CE in SL from the relay UE.

If the remote UE receives DL MP Duplication Activation/Deactivation MAC CE on DL-SCH, the remote UE activates or deactivates the PDCP duplication of the corresponding PDCP entity associated with RB i of the MP split bearer type.

If the remote UE receives DL MP Duplication RLC Activation/Deactivation MAC CE on DL-SCH, the remote UE activates or deactivates the PDCP duplication of the corresponding PDCP entity for the RLC entity associated with RLC i of the MP split bearer type.

If the relay UE receives DL MP Duplication Activation/Deactivation MAC CE and/or DL MP Duplication RLC Activation/Deactivation MAC CE on DL-SCH possibly with or without a UE ID which can be a same as the local identity of U2N Remote UE configured for the SRAP entity of the MP split bearer, the relay UE forwards the received MAC CE(s) to the remote UE corresponding to the UE ID by using SL MP Duplication Activation/Deactivation MAC CE and/or SL MP Duplication RLC Activation/Deactivation MAC CE which is/are a copy of the received DL MP Duplication Activation/Deactivation MAC CE and/or a copy of the received DL MP Duplication RLC Activation/Deactivation MAC CE respectively. The UE ID field can be optionally included in the MAC CE(s) depending on whether more than one remote UE is configured for the relay UE or not. If more than one remote UE is configured for the relay UE, the gNB configures the UE ID field for the relay UE. If only one remote UE is configured for the relay UE, the gNB does not configure the UE ID field for the relay UE. For this MAC CE, the MAC entity of the relay UE relays the MAC CE(s) received in DL from the gNB to the remote UE in the level of the MAC.

Meanwhile, gNB can activate one or more RLC entities associated with the PDCP entity for the MP split bearer by sending MP Dynamic Path Switching MAC CE to the remote UE indirectly via the relay UE or directly.

Alternatively, the MP Dynamic Path Switching MAC CE can be only used to activate one RLC entity. In this case, if more than one RLC entity is activated, gNB sends MP Duplication Activation/Deactivation MAC CE and/or MP Duplication RLC Activation/Deactivation MAC CE to the remote UE.

If the remote UE receives DL MP Dynamic Path Switching MAC CE on DL-SCH, the remote UE activates the RLC entity associated with RLC i of the MP split bearer type. If only one RLC entity is activated based on the MAC CE, the PDCP duplication of the corresponding PDCP entity associated with the RLC entity is not activated. If more than one RLC entity is activated based on the MAC CE, the PDCP duplication of the corresponding PDCP entity associated with the RLC entity is activated.

If the relay UE receives DL MP Dynamic Path Switching MAC CE on DL-SCH possibly with or without a UE ID which can be a same as the local identity of U2N Remote UE configured for the SRAP entity of the MP split bearer, the relay UE forwards the received MAC CE to the remote UE corresponding to the UE ID by using SL MP Dynamic Path Switching MAC CE which is a copy of the received DL MP Dynamic Path Switching MAC CE. The UE ID field can be optionally included in the MAC CE(s) depending on whether more than one remote UE is configured for the relay UE or not. If more than one remote UE is configured for the relay UE, the gNB configures the UE ID field for the relay UE. If only one remote UE is configured for the relay UE, the gNB does not configure the UE ID field for the relay UE. For this MAC CE, the MAC entity of the relay UE relays the MAC CE received in DL from the gNB to the remote UE in the level of the MAC.

The MAC entity of the remote UE triggers activation of the RLC entity or activation of the PDCP duplication for a subset of or all associated RLC entities for the configured RB(s) of the MP split bearer type by:
receiving a specific uplink grant e.g. addressed to CS-RNTI with NDI=1 or C-RNTI with a specific value of a specific DCI field for a logical channel associated with the DRB (or SRB) configured with a specific parameter by the gNB; or
receiving a specific sidelink grant e.g. addressed to SLCS-RNTI with NDI=1 or C-RNTI with a specific value of a specific DCI field for a logical channel associated with the SLRB or U2N RLC channel configured with a specific parameter by the gNB; or
receiving a MAC PDU carrying data from a logical channel associated with a RB configured with a specific parameter, wherein the MAC PDU is stored in the HARQ buffer for the corresponding HARQ process:

Whether to activate only one RLC entity, the subset of associated RLC entities or all associated RLC entities for the configured RB of the MP split bearer type can be configured for the remote UE by the received RRC message.

The MAC entity shall for each MP split RB configured with or without PDCP duplication:
1> if a MP Dynamic Path Switching MAC CE is received activating the RLC entity of the RB:
   2> indicate the activation of RLC entity of the RB to PDCP/RLC entities for the configured RB of the MP split bearer type
1> if a MP Dynamic Path Switching MAC CE is received deactivating the RLC entity of the RB:
   2> indicate the deactivation of RLC entity of the RB to PDCP/RLC entities for the configured RB of the MP split bearer type
1> if a PDCP duplication is activated or deactivated for the PDCP entity associated with the above RLC entity as the result of activation or deactivation of the above RLC entity:
   2> indicate the activation or deactivation of PDCP duplication of the PDCP entity to PDCP/RLC entities for the configured RB of the MP split bearer type.

Note that the remote UE determines activation of the PDCP duplication when more than one RLC entity is being activated in the above step while the remote UE determines deactivation of the PDCP duplication when only one RLC entity or none is being activated in the above step.

The MAC entity shall for each MP split RB configured with PDCP duplication:
1> if a Duplication Activation/Deactivation MAC CE is received activating the PDCP duplication of the RB:
   2> indicate the activation of PDCP duplication of the RB to PDCP/RLC entities for a subset of or all associated RLC entities for the configured RB(s) of the MP split bearer type
1> if a Duplication Activation/Deactivation MAC CE is received deactivating the PDCP duplication of the RB:
   2> indicate the deactivation of PDCP duplication of the RB to PDCP/RLC entities for a subset of or all associated RLC entities for the configured RB(s) of the MP split bearer type
1> if a Duplication RLC Activation/Deactivation MAC CE is received activating PDCP duplication for associated RLC entities of a RB configured with PDCP duplication:
   2> indicate the activation of PDCP duplication for the indicated secondary RLC entity(ies) of the RB to PDCP/RLC entities.
1> if a Duplication RLC Activation/Deactivation MAC CE is received deactivating PDCP duplication for associated RLC entities of a RB configured with PDCP duplication:
   2> indicate the deactivation of PDCP duplication for the indicated secondary RLC entity(ies) of the RB to PDCP/RLC entities.
1> if activation of a PDCP duplication for all configured RLC entities is triggered for the RB:
   2> indicate the activation of PDCP duplication for all configured RLC entities of the RB to PDCP/RLC entities.

RRC message used to configure PDCP duplication and/or Dynamic Path Switching

The RRC message can configure MP split bearer and PDCP duplication by using the following parameters in table 6:

```
TABLE 6
  PDCP-config
  MP-moreThanOneRLC SEQUENCE {
  primaryPath SEQUENCE {
```

| | |
|---|---|
| (Alt1) pathType | CHOICE { |
| | directPath |
| | indirectPath |

} OPTIONAL, -- Need R

| | |
|---|---|
| (Alt2) cellType | CHOICE { |
| | directCell or directCellGroup |
| | indirectCell or indirectCellGroup |

} OPTIONAL, -- Need R

| | |
|---|---|
| (Alt3) cellType | CHOICE { |
| | UL-Cell or UL-CellGroup |
| | SL-Cell or SL-CellGroup |

} OPTIONAL, -- Need R

| | |
|---|---|
| (Alt4) cellType | CHOICE { |
| | UL-Cell or UL-CellGroup |
| | SL-carrier (e.g. ASFCN) |

} OPTIONAL, -- Need R

| | |
|---|---|
| (Alt5) cellType | CHOICE { |
| | UL-BWP-ID |
| | SL-BWP-ID |

```
  } OPTIONAL, -- Need R
  logicalChannel CHOICE {
```

ul-LogicalChannelIdentity
sl-LogicalChannelIdentity

```
  } OPTIONAL, -- Need R
  },
  mp-DataSplitThreshold UL-DataSplitThreshold OPTIONAL, -- Cond MP-SplitBearer
  mp-pdcp-Duplication BOOLEAN OPTIONAL -- Need R
  } OPTIONAL, -- Cond MP-MoreThanOneRLC
  Some of the above parameters can be described as follows:
  - MP-moreThanOneRLC: This field configures upstream data transmission when more
than one RLC entity is associated with the PDCP entity for both direct path and indirect path
(via relay UE).
  - MP-pdcp-Duplication: Indicates whether or not upstream duplication status for a
PDCP entity of the MP split bearer at the time of receiving this IE is configured and activated.
The presence of this field indicates that MP PDCP duplication is configured. The value of this
field, when the field is present, indicates the state of the duplication at the time of receiving this
IE. If set to true, duplication is activated. The value of this field is always true, when configured
for a SRB.
  - primaryPath: Indicates path type or a cell ID or a cell group ID or SL carrier or UL/SL
BWP ID for the primary RLC entity and LCID of the primary RLC entity for UL data
transmission when more than one RLC entity is associated with the PDCP entity. The NW
indicates path type or cell Group for split bearers using logical channels in different path types
or cell groups. The NW indicates UL logical Channel ID if path type or the cell group
corresponds to a cell of direct path while indicating SL logical Channel ID if path type or the
cell group corresponds to a cell of indirect path.
```

The gNB can configure PDCP duplication or dynamic path switching for each PDCP entity, all SRBs, all DRBs for the primary path, the secondary path, the direct path, the indirect path, each relay UE, or each remote UE.

### PUCCH SR and Prioritization for MAC CE

When the above MAC CE(s) is transmitted in SL, the relay UE can request a SL grant by sending PUCCH based scheduling request or SL BSR MAC CE. For this purpose, a specific PUCCH resource configured in a PUCCH resource configuration can be allocated by the gNB for each or a subset or all of the above SL MAC CEs. In this case, if the relay UE creates one or more of the above MAC CEs and has no SL grant to accommodate the MAC CE(s), the relay UE triggers PUCCH SR. if the relay UE creates one or more of the above MAC CEs and has a SL grant to accommodate the MAC CE(s), the relay UE sends SL BSR MAC CE requesting SL grant for the MAC CE(s).

Alternatively, if the relay UE creates one or more of the above MAC CEs, the relay UE triggers PUCCH SR to directly inform the gNB about availability of the MAC CE(s), regardless of whether SL grant is available. In this case the PUCCH SR does not trigger SL BSR.

PUCCH SR is prioritized over SL-SCH or UL-SCH in collision, if the priority of the MAC CE is higher than the highest priority of MAC PDU on SL-SCH or UL-SCH in collision. Otherwise, PUCCH SR is de-prioritized over SL-SCH or UL-SCH in collision.

PUCCH SR is prioritized over other PUCCH in collision, if the priority of the MAC CE is higher than the highest priority of the other PUCCH on SL-SCH or UL-SCH in collision. Otherwise, PUCCH SR is de-prioritized over the other PUCCH in collision.

The priority of the above MAC CE is configured by the gNB or pre-configuration or fixed by specification.

When the relay UE includes the above MAC CE in a MAC PDU on SL-SCH i.e. during logical channel prioritization, the relay UE prioritizes the above MAC CE during a creation of a MAC PDU in accordance with the following order (highest priority listed first) in one of the alternatives:
1) Alt 1:
   one, more or all of the above MAC CE(s);
   data from SCCH;
   Sidelink CSI Reporting MAC CE;
   Sidelink Inter-UE Coordination Request MAC CE and Sidelink Inter-UE Coordination InformationReporting MAC CE;
   Sidelink DRX Command MAC CE;
   data from any STCH.
2) Alt 2:
   data from SCCH;
   one, more or all of the above MAC CE(s);
   Sidelink CSI Reporting MAC CE;
   Sidelink Inter-UE Coordination Request MAC CE and Sidelink Inter-UE Coordination InformationReporting MAC CE;
   Sidelink DRX Command MAC CE;
   data from any STCH.
3) Alt 3:
   data from SCCH;
   Sidelink CSI Reporting MAC CE;
   one, more or all of the above MAC CE(s);
   Sidelink Inter-UE Coordination Request MAC CE and Sidelink Inter-UE Coordination InformationReporting MAC CE;
   Sidelink DRX Command MAC CE;
   data from any STCH.
4) Alt 4:
   data from SCCH;
   Sidelink CSI Reporting MAC CE;
   Sidelink Inter-UE Coordination Request MAC CE and Sidelink Inter-UE Coordination InformationReporting MAC CE;
   one, more or all of the above MAC CE(s);
   Sidelink DRX Command MAC CE;
   data from any STCH.
5) Alt 5:
   data from SCCH;
   Sidelink CSI Reporting MAC CE;
   Sidelink Inter-UE Coordination Request MAC CE and Sidelink Inter-UE Coordination InformationReporting MAC CE;
   Sidelink DRX Command MAC CE;
   one, more or all of the above MAC CE(s);
   data from any STCH.
6) Alt 6:
   data from SCCH;
   Sidelink CSI Reporting MAC CE;
   Sidelink Inter-UE Coordination Request MAC CE and Sidelink Inter-UE Coordination InformationReporting MAC CE;
   Sidelink DRX Command MAC CE;
   data from any STCH.
   one, more or all of the above MAC CE(s);

### Primary/Secondary Path Determination

If the remote UE supports multi-path (MP) operation, the remote UE in RRC_IDLE or RRC_INACTIVE sends a RRC request message or a RRC resume request message to gNB either directly or indirectly via a relay UE. The remote UE receives a RRC setup message in response to the RRC request message or a RRC resume message in response to the RRC resume request message either directly or indirectly via the relay UE from the gNB.

In this case, the remote UE selects the direct path or the indirect path as the primary path of the MP operation according to one of the following options:
Opt 1: the remote UE considers the path where the RRC setup request message or the RRC resume request message is transmitted as the primary path of MP operation.
Opt 2: the remote UE considers the path where the RRC setup message or the RRC resume message is received as the primary path of MP operation.
Opt 3: the remote UE considers the path indicated by the gNB as the primary path of MP operation
   Opt 3-1: The indication is included in the configuration of the primary path contained in the RRC setup message or the RRC resume message.
   Opt 3-2: The indication is included in a MAC CE or DCI directly received from the gNB in DL.
   Opt 3-3: The indication is included in a MAC CE or DCI indirectly received via the relay UE from the gNB.
   Opt 3-4: The indication is included in a MAC CE or DCI received from the relay UE in SL.

If the remote UE configured with multi-path (MP) operation receives a RRC reconfiguration message for reconfiguration of the direct path or the indirect path or both paths (e.g. for mobility or handover), upon reception and/or execution of a RRC reconfiguration, the remote UE sends a RRC reconfiguration complete message to gNB either directly or indirectly via a relay UE.
Opt 1: the remote UE considers the path not reconfigured by the RRC reconfiguration message as the primary path of MP operation.
Opt 2: the remote UE considers the path reconfigured by the RRC reconfiguration message as the primary path of MP operation.
Opt 3: the remote UE considers the path indicated by a cell of the gNB as the primary path of MP operation
   Opt 3-1: The indication is included in the configuration of the primary path contained in the RRC reconfiguration message.
   Opt 3-2: The indication is included in a MAC CE or DCI directly received from the gNB in DL.
   Opt 3-3: The indication is included in a MAC CE or DCI indirectly received via the relay UE from the gNB.
   Opt 3-4: The indication is included in a MAC CE or DCI received from the relay UE in SL.
In the above options,
   the gNB can be a source gNB or a target gNB for mobility or handover.
   the cell can be a source cell or a target cell for mobility or handover.
   the cell can be a cell of the indirect path or a cell of the direct path for mobility or handover.
   the remote UE may change from the serving cell of the direct path to a new cell of the direct path by reconfiguration of the direct path.
   the remote UE may change from the serving relay UE of the indirect path to a new relay UE of the indirect path by reconfiguration of the indirect path.
   the remote UE may change from the cell serving the serving relay UE of the indirect path to a new cell serving the same relay UE of the indirect path by reconfiguration of the indirect path.

If the remote UE has been configured with multi-path (MP) operation, upon initiation of the RRC re-establishment procedure, the remote UE sends a RRC reestablishment request message to gNB either directly or indirectly via a relay UE. The remote UE receives a RRC reestablishment message in response to the RRC reestablishment request message either directly or indirectly via the relay UE from the gNB.

In this case, after completion of RRC re-establishment procedure or upon receiving the RRC re-establishment message, the the remote UE selects the direct path or the indirect path as the primary path of the MP operation according to one of the following options:
Opt 1: the remote UE considers the path where the RRC reestablishment request message is transmitted as the primary path of MP operation.
Opt 2: the remote UE considers the path where the RRC reestablishment message is received as the primary path of MP operation.
Opt 3: the remote UE considers the path indicated by the gNB as the primary path of MP operation
   Opt 3-1: The indication is included in the configuration of the primary path contained in the RRC reestablishment message.
   Opt 3-2: The indication is included in a MAC CE or DCI directly received from the gNB in DL.
   Opt 3-3: The indication is included in a MAC CE or DCI indirectly received via the relay UE from the gNB.
   Opt 3-4: The indication is included in a MAC CE or DCI received from the relay UE in SL.

The remote UE configured with multi-path (MP) operation can configure a security key for each of the direct bearer, the indirect bearer and the MP split bearer. The security key is used for encryption and decryption of data units in each PDCP entity.

In this application, the primary path can correspond to one or more of the followings:
A. The primary path is the path where the remote UE has initially established an RRC connection.
B. The primary path is the path where the remote UE has re-established an RRC connection.
C. The primary path is the path that gNB indicated for the remote UE during mobility.
D. The primary path is the path configured on PCell of the remote UE.
   If the primary path is the indirect path, the PCell of the remote UE is same as the PCell of the relay UE.
   Note: The direct path and indirect path can be served by the same cell (i.e. PCell) or by different cells as agreed in RAN2 #119-e.
E. The primary path is the path that gNB indicates as the primary path.
F. The primary path is the path used as the AS security anchor.
G. The primary path is the path where the remote UE acquires system information.
H. The primary path is the path where the remote UE exchanges NAS messages.

The remote UE is configured with a first security key for the direct bearer and a second security key for the indirect bearer. The MP split bearer can be always configured with the first security key i.e. the same key as for the direct bearer. Or the MP split bearer can be always configured with the second security key i.e. the same key as for the indirect bearer. Or, the MP split bearer can be configured with either the first security key or the second security key based on the configuration. The second security key is derived from the first security key.

Each PDCP entity of the remote UE encrypts or decrypts data units based on the first security key or the second security key based on the type of the bearer (i.e. The direct bearer, the indirect bearer or the MP split bearer). The direct bearer, the indirect bearer or the MP split bearer can be used for a signalling radio bearer (SRB) and a data radio bearer (DRB).

For the MP split RB, if the transmitting PDCP entity of the remote UE is associated with at least two RLC entities:
if the PDCP duplication is activated for the RB:
if the PDCP PDU is a PDCP Data PDU:
   the remote UE duplicate the PDCP Data PDU and submit the PDCP Data PDU to the associated RLC entities activated for PDCP duplication;
else:
   submit the PDCP Control PDU to the primary RLC entity;
else (i.e. the PDCP duplication is deactivated for the RB or the RB is a DAPS bearer):
   the remote UE performs one of the following options:
1) Option 1: Separate thresholds mp-DataSplitThreshold and ul-DataSplitThreshold are configured for MP split bearer and legacy DC/CA split bearer.
   if the split secondary RLC entity is configured; and
   if the total amount of PDCP data volume and RLC data volume pending for initial transmission (as specified in TS 38.322 [5]) in the primary RLC entity and the split secondary RLC entity is equal to or larger than mp-DataSplitThreshold or ul-DataSplitThreshold, as configured for this RB: the transmitting PDCP entity submits the PDCP PDU to either the primary RLC entity or the split secondary RLC entity;
   else: the transmitting PDCP entity submits the PDCP PDU to the primary RLC entity.
2) Option 2: Separate thresholds primary-DataSplitThreshold and secondary-DataSplitThreshold are configured for primary path and secondary path of MP split bearer.
   if the split secondary RLC entity is configured for MP operation; and
   if the total amount of PDCP data volume and RLC data volume pending for initial transmission (as specified in TS 38.322 [5]) in the primary RLC entity for the MP split RB is equal to or larger than primary-DataSplitThreshold: the transmitting PDCP entity submits the PDCP PDU to either the primary RLC entity or the split secondary RLC entity;
   else if the total amount of PDCP data volume and RLC data volume pending for initial transmission (as specified in TS 38.322 [5]) in the split secondary RLC entity for the MP split RB is equal to or larger than secondary-DataSplitThreshold: the transmitting PDCP entity submits the PDCP PDU to either the primary RLC entity or the split secondary RLC entity;
   else: the transmitting PDCP entity submits the PDCP PDU to the primary RLC entity.
3) Option 3: Only PDCP data volume (i.e. not RLC data volume) is compared with a threshold.
   if the split secondary RLC entity is configured for MP operation; and
   if the total amount of PDCP data volume pending for initial transmission in the PDCP entity for the MP split RB is equal to or larger than mp-DataSplitThreshold or ul-DataSplitThreshold, as configured for this RB: the transmitting PDCP entity submits the PDCP PDU to either the primary RLC entity or the split secondary RLC entity;
   else: the transmitting PDCP entity submits the PDCP PDU to the primary RLC entity.
4) Option 4: Separate thresholds direct-DataSplitThreshold and indirect-DataSplitThreshold are configured for direct path and indirect path of MP split bearer.
   if the split secondary RLC entity is configured for MP operation; and
   if the total amount of PDCP data volume and RLC data volume pending for initial transmission (as specified in TS 38.322 [5]) in the RLC entity associated to the direct path of the MP split RB is equal to or larger than direct-DataSplitThreshold: the transmitting PDCP entity submits the PDCP PDU to either the primary RLC entity or the split secondary RLC entity;
   else if the total amount of PDCP data volume and RLC data volume pending for initial transmission (as specified in TS 38.322 [5]) in the RLC entity associated to the indirect path of the MP split RB is equal to or larger than indirect-DataSplitThreshold: the transmitting PDCP entity submits the PDCP PDU to either the primary RLC entity or the split secondary RLC entity;
   else: the transmitting PDCP entity submits the PDCP PDU to the primary RLC entity.
5) Option 5: The data volume on only direct path is compared with a threshold.
   if the split secondary RLC entity is configured; and
   if the total amount of PDCP data volume and RLC data volume pending for initial transmission (as specified in TS 38.322 [5]) in the RLC entity (or all RLC entities) associated to the direct path of the MP split RB is equal to or larger than mp-DataSplitThreshold or ul-DataSplitThreshold, as configured for this RB: the transmitting PDCP entity submits the PDCP PDU to either the primary RLC entity or the split secondary RLC entity;
   else: the transmitting PDCP entity submits the PDCP PDU to the primary RLC entity.
6) Option 6: The data volume on only indirect path is compared with a threshold.
   if the split secondary RLC entity is configured; and
   if the total amount of PDCP data volume and RLC data volume pending for initial transmission (as specified in TS 38.322 [5]) in the RLC entity (or all RLC entities) associated to the indirect path of the MP split RB is equal to or larger than mp-DataSplitThreshold or ul-DataSplitThreshold, as configured for this RB: the transmitting PDCP entity submits the PDCP PDU to either the primary RLC entity or the split secondary RLC entity;
   else: the transmitting PDCP entity submits the PDCP PDU to the primary RLC entity.
7) Option 7: The data volume on only primary path is compared with a threshold.
   if the split secondary RLC entity is configured; and
   if the total amount of PDCP data volume and RLC data volume pending for initial transmission (as specified in TS 38.322 [5]) in the primary RLC entity of the MP split RB is equal to or larger than mp-DataSplitThreshold or ul-DataSplitThreshold, as configured for this RB: the transmitting PDCP entity submits the PDCP PDU to either the primary RLC entity or the split secondary RLC entity;
   else: the transmitting PDCP entity submits the PDCP PDU to the primary RLC entity.
8) Option 8: The data volume on only secondary path is compared with a threshold.
   if the split secondary RLC entity is configured; and
   if the total amount of PDCP data volume and RLC data volume pending for initial transmission (as specified in TS 38.322 [5]) in the split secondary RLC entity (or all split secondary RLC entities) of the MP split RB is equal to or larger than mp-DataSplitThreshold or ul-DataSplitThreshold, as configured for this RB: the transmitting PDCP entity submits the PDCP PDU to either the primary RLC entity or the split secondary RLC entity;
   else: the transmitting PDCP entity submits the PDCP PDU to the primary RLC entity.

### Issue 1: Path Addition/Modification/Release

Issue 1 is related to which cases can be supported or not supported for scenario 1 and 2 as shown in Item 1-1 and 1-2.
(1) Item 1-1: Whether to support all of the following MP cases in Scenario 1? If not, which case should be excluded in Scenario 1?
A. The remote UE configured only on the direct path adds the indirect path under the same gNB;
B. The remote UE configured only on the indirect path adds the direct path under the same gNB;
C. The remote UE configured with multi-path releases the indirect path;
D. The remote UE configured with multi-path releases the direct path;
E. The remote UE configured with multi-path changes the serving cell of the remote UE for the direct path while keeping the serving relay UE for the indirect path under the same gNB;
F The remote UE configured with multi-path keeps the serving relay UE for the indirect path and the serving cell of the remote UE for the direct path while the serving relay UE changes the serving cell of the relay UE under the same gNB;
G. The remote UE configured with multi-path changes to a new relay UE for the indirect path while keeping the direct path under the same gNB.

According to an an embodiment, all the cases may be supported.
(2) Item 1-2: Whether to support all of the MP cases of Item 1-1 in Scenario 2? If not, which case should be excluded in Scenario 2?

According to an an embodiment, supported cases may include A to F, and Excluded cases may include G. It is assumed that the remote UE does not reselect the pre-configured relay UE in Scenario 2.

### Issue 2: Primary Path for Control Plane

The issue 2 is related to whether to introduce the concept of a primary path and which aspects can be considered as the characteristics of the primary path for scenario 1 and 2 as shown in Item 1-1 and 1-2. The considered characteristics of the primary path can be used to define the primary path and specify the primary path, if needed.

In an embodiment, the concept of the primary path is proposed mainly for control plane while others address the primary RLC entity with the concept of the primary path i.e. mainly for layer 2. Accordingly, the issue 2 focuses on control plane aspects of the primary path while the issue 3 will address the primary RLC entity for layer 2.
(3) Item 2-1: Whether to introduce the concept of a primary path in Scenario 1 from CP perspective? If yes, which part(s) of the following CP aspects can be considered as the characteristics of the primary path?
A. The primary path is the path where the remote UE has initially established an RRC connection.
B. The primary path is the path where the remote UE has re-established an RRC connection.
C. The primary path is the path that gNB indicated for the remote UE during mobility.
D. The primary path is the path configured on PCell of the remote UE.
If the primary path is the indirect path, the PCell of the remote UE is same as the PCell of the relay UE.
Note: The direct path and indirect path can be served by the same cell (i.e. PCell) or by different cells as agreed in RAN2 #119-e.
E. The primary path is the path that gNB indicates as the primary path.
F. The primary path is the path used as the AS security anchor.
G. The primary path is the path where the remote UE acquires system information.
H. The primary path is the path where the remote UE exchanges NAS messages.

In an embodiment, the concept of a primary path can be supported, and considered characteristics may include A to F.
(4) Item 2-2: Whether to introduce the concept of a primary path in Scenario 2? If yes, which part(s) of the above aspects can be considered as the characteristics of the primary path?

In an embodiment, the concept of a primary path can be supported, and considered characteristics may include A to F.

In an embodiment, the direct path is configured as the primary path and the indirect path is configured as the secondary path, The other case where the primary path is the indirect path and the secondary path is the direct path is down-prioritized in Rel-18.
(5) Item 3-1: Options related to Scenario 1 when both paths are configured
Option 3A: The primary path is always configured on the direct path.
Option 3B: The primary path is always configured on the indirect path.
Option 3C: The primary path can be configured on either the direct or the indirect path.
Option 3D: Option 3B is excluded. Option 3A and 3C can be further studied.
(6) Item 3-2: Options related to Scenario 2 when both paths are configured
Option 3A: The primary path is always configured on the direct path.
Option 3B: The primary path is always configured on the indirect path.
Option 3C: The primary path can be configured on either the direct or the indirect path.
Option 3D: Option 3B is excluded. Option 3A and 3C can be further studied.
(7) Item 4-1: Options related to Scenario 1, if yes in Item 2 (note: SRB0 is not subject to this Item)
Option 4A: SRB1, SRB2, SRB3 and SRB4 can be configured on the primary path only.
Option 4B: SRB1, SRB2, SRB3 and SRB4 can be configured on both the primary path and the secondary path.
Option 4C: Some SRB(s) can be configured on the primary path only while other SRB(s) can be configured on both the primary path and the secondary path. Which SRB can be configured only on the primary path can be further discussed.
(8) Item 4-2: Options related to Scenario 2, if yes in Item 2 (note: SRB0 is not subject to this Item)
Option 4A: SRB1, SRB2, SRB3 and SRB4 can be configured on the primary path only.
Option 4B: SRB1, SRB2, SRB3 and SRB4 can be configured on both the primary path and the secondary path.
Option 4C: Some SRB(s) can be configured on the primary path only while other SRB(s) can be configured on both the primary path and the secondary path. Which SRB can be configured only on the primary path can be further discussed.

It was agreed to support the MP split bearer which is a bearer mapped to both paths, based on the existing split bearer framework. It can be further discussed whether the MP split bearer can support SRB as well as DRB. In 38.331, it is specified that split SRB is supported for all the MR-DC options in both SRB1 and SRB2 (split SRB is not supported for SRB0 and SRB3).
(9) Item 5-1: Whether MP split bearer can be supported for SRB in Scenario 1? If yes, which SRB can be configured as the MP split bearer?

For example, SRB1 and SRB2 can be configured as the MP split bearer, same as for MR-DC.
(10) Item 5-2: Whether MP split bearer can be supported for SRB in Scenario 2? If yes, which SRB can be configured as the MP split bearer?

For example, SRB1 and SRB2 can be configured as the MP split bearer, same as for MR-DC.

In addition, considering the existing split bearer framework, one primary RLC entity and one split secondary RLC entity may be supported for each MP split bearer. If the MP split bearer can be supported for SRB, it can be further discussed whether the primary RLC entity of the MP split bearer is always configured on the primary path of the control plane or can be configured on any path.
(11) Item 6-1: Options related to Scenario 1 (if yes in Item 5)
Option 6A: The primary RLC entity of the MP split bearer for SRB is always configured on the primary path of the control plane
Option 6B: The primary RLC entity of the MP split bearer for SRB can be configured on either the primary path or the secondary path. For example, At least upon detection of RLF on the primary path, the primary RLC entity of the MP split bearer for SRB can be reconfigured on the secondary path.
(12) Item 6-2: Options related to Scenario 2 (if yes in Item 5)
Option 6A: The primary RLC entity of the MP split bearer for SRB is always configured on the primary path of the control plane
Option 6B: The primary RLC entity of the MP split bearer for SRB can be configured on either the primary path or the secondary path. For example, at least upon detection of RLF on the primary path, the primary RLC entity of the MP split bearer for SRB can be reconfigured on the secondary path.

### Issue 3: Layer 2

In clause 5.2.1 of TS 38.323, if the transmitting PDCP entity is associated with at least two RLC entities, the UE can submit the PDCP PDU to either the primary RLC entity or the split secondary RLC entity as follows:
else, if the transmitting PDCP entity is associated with at least two RLC entities:
if the PDCP duplication is activated for the RB:
if the PDCP PDU is a PDCP Data PDU:
duplicate the PDCP Data PDU and submit the PDCP Data PDU to the associated RLC entities activated for PDCP duplication;
else:
submit the PDCP Control PDU to the primary RLC entity;
else (i.e. the PDCP duplication is deactivated for the RB or the RB is a DAPS bearer):
if the split secondary RLC entity is configured; and
if the total amount of PDCP data volume and RLC data volume pending for initial

transmission (as specified in TS 38.322 [5]) in the primary RLC entity and the split secondary RLC entity is equal to or larger than ul-DataSplitThreshold:
submit the PDCP PDU to either the primary RLC entity or the split secondary RLC entity;

Considering the existing split bearer framework, one primary RLC entity and one split secondary RLC entity are supported for each MP split bearer. Assuming that the MP split bearer can be supported for DRB, it can be discussed whether the primary RLC entity of the MP split bearer for DRB is always configured on the primary path of the control plane or can be configured on any path.
(13) Item 7-1: Options related to Scenario 1 (if yes in Item 2)
Option 7A: The primary RLC entity of the MP split bearer for DRB is always configured on the primary path of the control plane
Option 7B: The primary RLC entity of the MP split bearer for DRB can be configured on either the primary path or the secondary path.
(14) Item 7-2: Options related to Scenario 2 (if yes in Item 2)
Option 7A: The primary RLC entity of the MP split bearer for DRB is always configured on the primary path of the control plane
Option 7B: The primary RLC entity of the MP split bearer for DRB can be configured on either the primary path or the secondary path.
(15) Item 9A: Whether an adaptation layer is needed for Scenario 2? Provide the reason(s) why the adaptation layer is needed for Scenario 2.

For example, an adaptation layer is needed to support data routing. For example, the relay UE and the remote UE configure multiple PDCP/RLC entities for multiple indirect/split bearers. So, when a PDCP entity of the remote UE submits a PDCP PDU to lower non-standard layers of the remote UE, the lower non-standard layers of the relay UE cannot identify which RLC entity of the relay UE needs to process the PDCP PDU received from the remote UE.
(16) Item 9B: Whether the adaptation layer of Scenario 2 can be based on Rel-17 SRAP? What kind of change do you expect compared to Rel-17 SRAP?

For example, the adaptation layer of Scenario 2 can be designed based on the SRAP specification. However, the adaptation layer of Scenario 2 does not need to understand/process SL data units. If the same SRAP is used for both scenario 1 and 2, the SRAP entity in Scenario 1 and 2 needs to additionally understand the type of the lower layers e.g. based on the header of a SRAP PDU (e.g. 3GPP SL or non-standard). Since the adaptation layer of Scenario 2 does not need to differentiate the type of the lower layers, the adaptation layer of Scenario 2 can be something new.

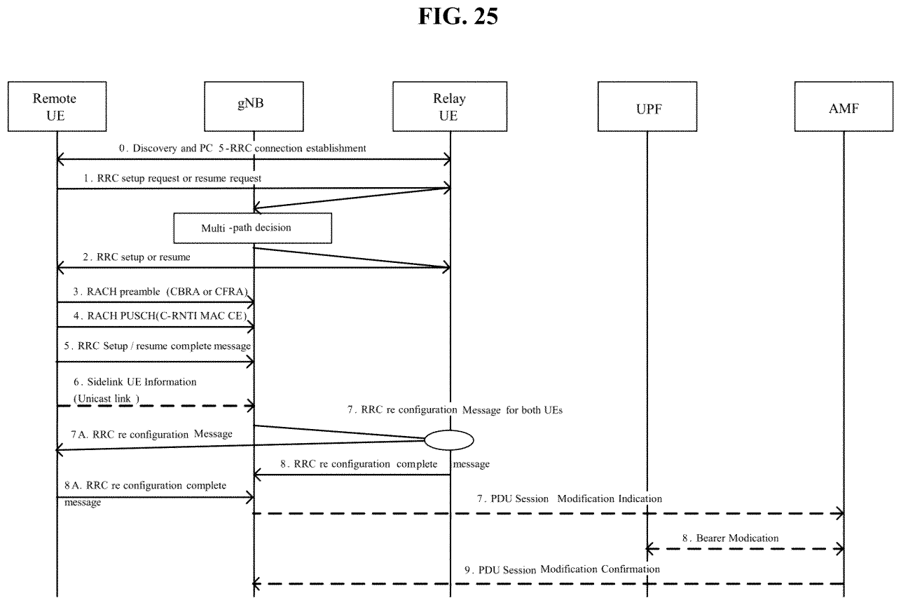

FIG. 25 illustrates Simultaneous establishment of direct/indirect path in U2N based RRC connection establishment.

The method for performing data transmission and reception by a UE includes the following steps:
1. The U2N Remote and U2N Relay UE perform discovery procedure, and establish PC5-RRC connection using NR V2X procedure.
2. After PC5-RRC connection establishment with PC5 unicast link setup, the remote UE and the relay UE can exchange their own UE capability by triggering the Sidelink UE capability transfer procedure in which the remote UE sends the UECapabilityEnquirySidelink message requesting MP capability of the relay UE to the relay UE and then the relay UE sends the UECapabilityInformationSidelink message including its MP capability to the remote UE. Afterwards, the relay UE can sends the UECapabilityEnquirySidelink message requesting MP capability of the remote UE to the remote UE and then the remote UE sends the UECapabilityInformationSidelink message including its MP capability to the relay UE.

The MP capability of a UE can include one or more of the followings:
whether the UE supports multi-path operation as a remote UE and/or as a relay UE
a SL/UL/DL frequency carrier/band where the UE can support the MP operation for transmission and/or reception
a combination of SL carriers/bands and UL carriers/bands where the UE can support the MP operation for transmission from the UE
a combination of SL carriers/bands and DL carriers/bands where the UE can support the MP operation for reception at the UE
3. If the remote UE and the relay UE can support the MP operation on the DL/UL carrier of the serving cell and the SL carrier where sidelink transmission and/or sidelink reception between the remote UE and the relay UE has been performed or the serving cell supports sidelink resources for sidelink transmission/reception and/or the MP operation (e.g. based on resource pool configuration in system information or dedicated signaling), the relay UE can determine request of multi-path operation and initiate a RRC Connection Establishment, and/or the relay UE can inform the remote UE about request of multi-path operation, a RRC state of the relay UE, or whether the relay UE is in RRC_CONNECTED or not by sending a first sidelink message to the remote UE. If the relay UE (and the remote UE) determines request of multi-path operation, the first RRC message (i.e., RRCSetupRequest or RRCResumeRequest) in the RRC Connection Establishment from the relay UE can indicate request of multi-path operation e.g. in EstablishmentCause or ResumeCause in the first RRC message to the gNB. If the above conditions are met (and if the relay UE requests multi-path operation), the remote UE can also inform the remote UE about request of multi-path operation, a RRC state of the remote UE, or whether the remote UE is in RRC_CONNECTED or not by sending a second sidelink message to the relay UE including the request of multi-path operation.
A. The first sidelink message can include one or more of the followings:
The cell identity of PCell for the relay UE.
The PLMN identity of the registered PLMN for the relay UE.
Tracking Area Code of the tracking area that the relay UE has been registered for

PCell.
Request of multi-path operation
B. Upon receiving the first sidelink message, the remote UE can perform one or more of the following steps e.g. cell reselection before or during the RRC Connection Establishment from the remote UE, or cell reselection during or after the RRC Connection Establishment from the relay UE:
if the cell indicated by the relay UE is different than the serving cell where the remote UE is camping on, the remote UE may reselect to the indicated cell based on the cell reselection process or the remote UE aborts configuration of multi-path operation with the relay UE. If the remote UE cannot reselect to the indicated cell based on the cell reselection process, the remote UE aborts configuration of multi-path operation with the relay UE.
if the tracking area indicated by the relay UE is different than the tracking area where the remote UE has been registered, the remote UE may trigger a tracking area update procedure to register to the tracking area indicated by the relay UE or the remote UE aborts configuration of multi-path operation with the relay UE. If the remote UE cannot register to the indicated tracking area e.g. due to failure of the track area update procedure or other related NAS procedure, the remote UE aborts configuration of multi-path operation with the relay UE.
if the PLMN indicated by the relay UE is different than the PLMN where the remote UE has been registered, the remote UE may reselect to the PLMN indicated by the relay UE to register to the indicated PLMN or the remote UE aborts configuration of multi-path operation with the relay UE. If the remote UE cannot register to the indicated PLNN e.g. due to failure of the PLMN registration procedure or other related NAS procedure, the remote UE aborts configuration of multi-path operation with the relay UE.
C. The first sidelink message can be the RemoteUEInformationSidelink message or the UEAssistanceInformationSidelink message or the RRCReconfigurationSidelink message or the RRCReconfigurationCompleteSidelink message.
4. If the relay UE identifies that both the relay UE and the remote UE support MP capability based on the above exchange of sidelink UE capability, and the remote UE is not in RRC_CONNECTED, the remote UE can determine request of multi-path operation and initiate a RRC connection establishment procedure via the relay UE as follows:

If the U2N Remote UE has no direct Uu RRC connection, the U2N Remote UE sends the first RRC message (i.e., RRCSetupRequest or RRCResumeRequest) for its connection establishment with gNB via the Relay UE, using a specified PC5 Relay RLC channel configuration. If the remote UE (and the relay UE) determines request of multi-path operation, the first RRC message from the remote UE can indicate request of multi-path operation e.g. in EstablishmentCause or ResumeCause in the first RRC message to the gNB. The remote UE can also indicate request of multi-path operation to the relay UE e.g. via the SCI scheduling PSSCH including the first RRC message in SL, via the SL MAC CE in either a separate SL MAC PDU or the SL MAC PDU including the first RRC message in SL, via the MAC (sub-) header of the SL MAC PDU including the first RRC message in SL, or via a separate PC5-RRC message sent to the relay UE.
5. If the U2N Relay UE is not in RRC_CONNECTED, it needs to do its own connection establishment upon reception of a message on the specified PC5 Relay RLC channel. If the relay UE (and the remote UE) determines request of multi-path operation, the first RRC message (i.e., RRCSetupRequest or RRCResumeRequest) in the RRC Connection Establishment from the relay UE can indicate request of multi-path operation e.g. in EstablishmentCause or ResumeCause in the first RRC message to the gNB. During Relay UE's RRC connection establishment procedure, gNB may configure SRB0 relaying Uu Relay RLC channel to the U2N Relay UE by sending e second RRC message (e.g. an RRCSetup message or an RRCResume message) to the U2N Relay UE.
A. If the relay UE and the remote UE are not configured with a same cell, or not registered in a same tracking area and/or a same PLMN, the gNB may send handover command to the relay UE via the second RRC mesasage to have both the relay UE and the remote UE in the same cell, the same tracking area and/or the same PLMN.
6. The gNB responds with the second RRC message (e.g. an RRCSetup message or an RRCResume message) to U2N Remote UE via the U2N Relay UE. The second RRC message is sent to the U2N Remote UE using SRB0 relaying channel over Uu and a specified PC5 Relay RLC channel over PC5.
A. If the relay UE and the remote UE are not configured with a same cell, or not registered in a same tracking area and/or a same PLMN, the gNB may send handover command to the remote UE via the second RRC message to have both the relay UE and the remote UE in the same cell, the same tracking area and/or the same PLMN.
7. If both the relay UE and the remote UE are in RRC_CONNECTED and if gNB determined whether to add direct path as well as indirect path for the remote UE according to the request of multi-path operation from the relay UE and/or the remote UE, the gNB configures a direct path for the remote UE e.g. via the second RRC message sent to the relay UE and the remote UE respectively.

For adding direct path as well as indirect path for the remote UE, as an alternative message adding the direct path or as an additional message following the second message adding the direct path, the gNB can send the (first) RRCReconfiguration message to the relay UE and/or the remote UE after completion of the RRC connection (re-) establishment (and AS security activation) for the relay UE or the remote UE. If the gNB sends the RRCReconfiguration message to the remote UE, the message can be sent to the remote UE indirectly via the relay UE or directly on the Uu interface only.
If the second RRC message to the relay UE includes the sl-L2RelayUEConfig, the relay UE performs the L2 U2N Relay UE configuration procedure to (re-)configure zero, one or more direct bearers, zero, one or more indirect bearers and zero, one or more split bearers for upstream data from the remote UE and/or downstream data to the remote UE.
if the second RRC message to the remote UE includes the sl-L2RemoteUEConfig, the remote UE performs the L2 U2N Remote UE configuration procedure to (re-)configure zero, one or more direct bearers, zero, one or more indirect bearers and zero, one or more split bearers for the remote UE for upstream data from the remote UE and/or downstream data to the remote UE.
if the second RRC message to the relay UE includes configuration of direct bearer(s) and/or direct path of split bearer(s), the remote UE (re-)configure zero, one or more direct bearers and direct path of zero, one or more split bearers for upstream data from the remote UE and/or downstream data to the remote UE.
if the second RRC message to the remote UE includes configuration of direct bearer(s) and/or direct path of split bearer(s), the remote UE (re-)configure zero, one or more direct bearers and direct path of zero, one or more split bearers for upstream data from the remote UE and/or downstream data to the remote UE.
The indirect bearer or the split bearer involves establishment of Uu Relay RLC channels.
The indirect bearer is configured with the indirect link consisting of Uu link and sidelink.
The direct bearer is configured over direct link only over Uu.
The split bearer is configured with both the indirect path and the direct path of the split bearer. gNB may select one or both of the indirect path and the direct path for downstream data transfer towards the remote UE, while the remote UE may select one or both of the indirect path and the direct path for upstream data transfer towards the gNB.
8. The gNB and U2N Relay UE perform relaying channel setup procedure over Uu. According to the configuration from gNB, the U2N Relay/Remote UE establishes an PC5 Relay RLC channel for relaying of SRB1 towards the U2N Remote/Relay UE over PC5.
9. The second message (e.g. an RRCSetup message or an RRCResume message) sent to the remote UE can trigger RACH from the morete UE and possibly include RACH configuration. In this case, the remote UE triggers RACH procedure to send the RRCSetupComplete message.
The RRC configuration may also include a UE-dedicated preamble. In this case, the remote UE can perform the RACH preamble transmission with the UE-dedicated preamble.
The MAC PDU in MSG3 PUSCH or MSGA PUSCH can include C-RNTI MAC CE indicating the C-RNTI allocated by the second message. If no C-RNTI is allocated by the second message, the remote UE can include C-RNTI MAC CE indicating Temporary C-RNTI determined by this RACH procedure. Alternatively, if no C-RNTI is allocated by the second message, the MAC PDU can include a MAC CE or a RRC message including other UE identity of the remote UE e.g. s-TMSI or resumeID.
The MAC PDU in MSG3 PUSCH or MSGA PUSCH can (also) include Buffer Status Report to report UL buffer size at least for transmission of the RRCSetupComplete message from the remote UE.
If SL resource allocation mode 1 is configured for the remote UE, the remote UE can (also) include Sidelink Buffer Status Report to report SL buffer size and request SL resource in order to send SL data over indirect bearer or indirect path of the split bearer from the remote UE

If the RACH procedure from the remote UE successfully completes, the remote UE directly transmits the third message (i.e. the RRCSetupComplete message or the RRCResumeComplete message) to the gNB. Then, the remote UE is in RRC_CONNECTED with both indirect path via the relay UE and the direct path with the gNB.

If the RACH procedure from the remote UE unsuccessfully completes (i.e. the RACH fails), the remote UE indirectly transmits the third message (e.g. the RRCSetupFailure message or the RRCReumeFailure message) to the gNB via the U2N Relay UE using SRB1 relaying channel over PC5 and SRB1 relaying channel configured to the U2N Relay UE over Uu. Then, the remote UE is in RRC_CONNECTED only with the indirect path via the relay UE with the gNB. In case of RACH failure, the third message can inform the gNB about RACH failure and/or failure of the direct path setup or multi-path operation.

Alternatively, if the RACH procedure from the remote UE unsuccessfully completes (i.e. the RACH fails), the remote UE initiates the RRC Re-establishment procedure by sending the RRCReestablishmentRequest message indirectly via the relay UE or directly to the gNB. If the RRCReestablishmentRequest message is directly sent to the gNB, the remote UE triggers the RACH procedure again to send the RRCReestablishmentRequest message indicating recovery or failure of multi-path operation. In this procedure, the remote UE may perform cell reselection to the same cell with the relay UE.

Alternatively, if the RACH procedure from the remote UE unsuccessfully completes (i.e. the RACH fails), the remote UE initiates the RRC Resume procedure by sending the RRCResumeRequest message indirectly via the relay UE or directly to the gNB. If the RRCResumeRequest message is directly sent to the gNB, the remote UE triggers the RACH procedure again to send the RRCResumeRequest message indicating recovery or failure of multi-path operation. In this procedure, the remote UE may perform cell reselection to the same cell with the relay UE.
10. If the RACH procedure from the remote UE successfully completes, the U2N Remote UE and gNB establish AS security following Uu procedure e.g. via the direct path.

But, if the RACH procedure from the remote UE unsuccessfully completes (i.e. the RACH fails), the U2N Remote UE and gNB establish AS security via the indirect path and the AS security messages are forwarded through the U2N Relay UE.
11. The third message from the remote UE can include initial NAS message from the remote UE. The third message from the relay UE can include initial NAS message from the relay UE. Upon receiving the third message, the gNB forwards the initial NAS message (e.g. Service Request message) to the Core Network (CN) node (such as AMF or SMF). Upon receiving the initial NAS message, the CN node can provide multi-path configuration to the gNB and the UEs as follows:

### 1) Alternative 1:

When the remote UE establishes a RRC connection with the gNB e.g. via the relay UE, the remote UE sends an initial NAS message to the CN node. The initial NAS message can indicate preference of the remote UE for multi-path operation. Upon receiving the initial NAS message from the remote UE, the CN node provides UE capability related to multi-path operation and multi-path related NAS configuration to the gNB. If the UE capability and/or the NAS configuration is received, the gNB determines whether to configure multi-path operation as described above.

In addition, when the relay UE establishes a RRC connection with the gNB, the relay UE sends an initial NAS message to the CN node. The initial NAS message can indicate preference of the relay UE for multi-path operation. Upon receiving the initial NAS message from the relay UE as well as the initial NAS message from the remote UE, the CN node provides UE capability related to multi-path operation and multi-path related NAS configuration to the gNB. If the UE capability and/or the NAS configuration is received, the gNB determines whether to configure multi-path operation as described above.

### 2) Alternative 2:

After the remote UE establishes a RRC connection with the gNB e.g. via the relay UE, the gNB determines whether to configure multi-path operation as described above. If the gNB determines multi-path operation, the gNB indicates the multi-path operation to the CN node.

Upon receiving the indication from the gNB, the CN node provides UE capability related to multi-path operation and multi-path related NAS configuration to the gNB. If the UE capability and/or the NAS configuration is received, the gNB configures multi-path operation as described above based on the received UE capability and/or NAS configuration.

Upon receiving the indication from the gNB, the CN node provides multi-path related NAS configuration to the remote UE and/or the relay UE. The remote UE and/or the relay UE configures multi-path operation based on the multi-path related NAS configuration on top of the above RRC configurations provided by the gNB as described above.

### 3) Alternative 3:

When the relay UE establishes a RRC connection with the gNB, the relay UE sends an initial NAS message to the CN node. The initial NAS message can indicate preference of the relay UE for multi-path operation. Upon receiving the initial NAS message from the relay UE, the CN node provides UE capability related to multi-path operation and multi-path related NAS configuration to the gNB. If the UE capability and/or the NAS configuration is received, the gNB determines whether to configure multi-path operation as described above.

In addition, when the relay UE establishes a RRC connection with the gNB e.g. via the relay UE, the remote UE can also send an initial NAS message to the CN node. The initial NAS message can indicate preference of the remote UE for multi-path operation. Upon receiving the initial NAS message from the remote UE as well as the initial NAS message from the relay UE, the CN node provides UE capability related to multi-path operation and multi-path related NAS configuration to the gNB. If the UE capability and/or the NAS configuration is received, the gNB determines whether to configure multi-path operation as described above.

The CN node (e.g. AMF or SMF) can inform the gNB about UE capability and multi-path configuration e.g. in QoS profile for the remote UE and/or the relay UE, or addition of the multi-path configuration. The QoS profile is sent from the CN node to the gNB.
The multi-path related information in the QoS profile can indicate whether multi-path can be configured for one of the followings:
   each PDU session
   each QoS flow
   each remote UE
   each relay UE
   each frequency
   each cell
   each RAT
   each PLMN
   each Tracking Area
   each gNB
12. If the CN node does not provide UE capability of the remote UE, upon request from the gNB, the U2N Remote UE informs gNB about UE capability of the remote UE e.g. including whether the remote UE supports U2N bearers/channels and/or MP operation.

If the CN node does not provide UE capability of the relay UE, upon request from the gNB, The U2N Relay UE informs gNB about UE capability of the relay UE e.g. including whether the relay UE supports U2N bearers/channels and/or MP operation.
13. For adding direct path as well as indirect path for the remote UE, as an alternative message adding the direct path or as an additional message following the second message adding the direct path, the gNB can send the RRCReconfiguration message to the relay UE and/or the remote UE, e.g. based on UE capability and multi-path configuration from the CN node, after completion of the RRC connection (re-) establishment (and AS security activation) for the relay UE or the remote UE. The gNB sends the RRCReconfiguration message to the U2N Remote UE indirectly via the U2N Relay UE or directly to the remote UE, in order to setup the SRB2/DRBs for both direct path and indirect path. In addition, the gNB sends the RRCReconfiguration message to the U2N Relay UE
   If the RRCReconfiguration message to the relay UE includes the sl-L2RelayUEConfig, the relay UE performs the L2 U2N Relay UE configuration procedure to (re-)configure zero, one or more direct bearers, zero, one or more indirect bearers and zero, one or more split bearers for upstream data from the remote UE and/or downstream data to the remote UE.
   if the RRCReconfiguration message to the remote UE includes the sl-L2RemoteUEConfig, the remote UE performs the L2 U2N Remote UE configuration procedure to (re-)configure zero, one or more direct bearers, zero, one or more indirect bearers and zero, one or more split bearers for the remote UE for upstream data from the remote UE and/or downstream data to the remote UE.
   if the second RRC message and/or the RRCReconfiguration message to the relay UE includes configuration of direct bearer(s) and/or direct path of split bearer(s), the remote UE (re-)configure zero, one or more direct bearers and direct path of zero, one or more split bearers for upstream data from the remote UE and/or downstream data to the remote UE.
   if the second RRC message and/or the RRCReconfiguration message to the remote UE includes configuration of direct bearer(s) and/or direct path of split bearer(s), the remote UE (re-)configure zero, one or more direct bearers and direct path of zero, one or more split bearers for upstream data from the remote UE and/or downstream data to the remote UE.

### A. Option 1: Joint RRC Reconfiguration

gNB sends the RRCReconfiguration message to the relay UE. The RRCReconfiguration message includes at least the first part and the second part. The first part includes configuration on addition of indirect/split bearer which is applied to the relay UE while the second part includes configuration on addition of indirect/split bearer and addition of direct bearer or direct path of the split bearer which is applied to the remote UE.
(i) Option 1A: The relay UE forwards the second part to the remote UE by sending a Uu RRC message (e.g. the RRCReconfiguration message) to the remote UE.

For example, the second part is included in a RRC container of the RRCReconfiguration message. gNB encrypts the first part by a first security key configured between the gNB and the relay UE while encrypting the second part by a second security key configured between the gNB and the remote UE. Upon receiving the RRCReconfiguration message, if the relay UE successfully applies the configuration of the first part, a layer of the relay UE removes the first part from the RRCReconfiguration message and forwards the second part in the RRC container to the remote UE by sending the RRCReconfiguration message excluding the first part to the remote UE. The layer of the relay UE can be one of a PDCP layer, a SRAP layer and a RRC layer of the relay UE. Meanwhile, if the relay UE unsuccessfully applies the configuration of the first part, the relay UE may not forward the second part in the RRC container to the remote UE.

Upon receiving the second part, the remote UE decrypts the second part by using the second security key. If the remote UE successfully applies the configuration of the second part, the remote UE encrypts the RRCReconfigurationComplete message by using the second security key and then directly sends it to gNB or indirectly sends it to gNB via the relay UE. If the remote UE unsuccessfully applies the configuration of the second part, the remote UE encrypts the RRCReconfigurationFailure or RRCReconfigurationComplete message indicating failure of U2N configuration or multi-path configuration by using the second security key and then directly sends it to gNB or indirectly sends it to gNB via the relay UE. Alternatively, if the remote UE unsuccessfully applies the configuration of the second part, the remote UE initiates the RRC Re-establishment procedure for which the remote UE suspends direct bearer(s) and suspends or releases indirect/split bearers. The remote UE may also release the PC5-RRC connection with the relay UE.

In case of the RRC Re-establishment procedure on Uu interface, the remote UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE.

In case of the RRC Re-establishment procedure via the relay UE, the remote UE sends the RRCReestablishmentComplete message to the relay UE by using SL-RLC1 for SRB1 and then the relay UE forwards the RRCReestablishmentComplete message to the gNB. The RRCReestablishmentComplete message indicates failure of U2N configuration or multi-path configuration and the source or destination identity of the relay UE and/or the remote UE.

If the remote UE unsuccessfully applies the configuration of the second part, the remote UE can release the PC5-RRC connection with the relay UE or inform the relay UE about sidelink relay reconfiguration failure or multi-path configuration failure.

Upon release of the PC5-RRC connection or upon receiving the sidelink relay reconfiguration failure or multi-path configuration failure, the relay UE sends the RRCReconfigurationFailure or RRCReconfigurationComplete message failure of U2N configuration or multi-path configuration to the gNB. A RRC container of the RRCReconfigurationComplete message sent from the relay UE to the gNB can include the RRCReconfigurationComplete message received from the remote UE. Alternatively, upon release of the PC5-RRC connection, upon receiving or detecting the sidelink relay reconfiguration failure or multi-path configuration failure, or if the relay UE unsuccessfully applies the configuration of the first part, the relay UE initiates the RRC Re-establishment procedure for which the relay UE suspends direct bearer(s) and suspends or releases indirect/split bearers. The relay UE may also release the PC5-RRC connection with the remote UE or inform the remote UE about the sidelink relay reconfiguration failure or multi-path configuration failure. In the RRC Re-establishment procedure, the relay UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE.
(ii) Option 1B: The relay UE forwards the second part to the remote UE by sending a PC5 RRC message (e.g. the RRCReconfigurationSidelink message or the UuMessageTransferSidelink message) to the remote UE.

For example, the second part is included in a RRC container of the RRCReconfiguration message or the UuMessageTransferSidelink message. gNB encrypts the first part by a first security key configured between the gNB and the relay UE while encrypting the second part by the first security key (or a second security key configured between the gNB and the remote UE). Upon receiving the RRCReconfiguration message, the relay UE decrypts the second part by using the first security key (or the second security key). Then, the relay UE encrypts the second part by using a third security key configured on the PC5 interface between the relay UE and the remote UE. The relay UE forwards the second part to the remote UE by including the second part in the RRCReconfigurationSidelink message sent to the remote UE. The second part can be included in a RRC container of the RRCReconfigurationSidelink message, or the second part is reconstructed to be included in the RRCReconfigurationSidelink message.

Upon receiving the second part, the remote UE decrypts the second part by using the third security key. If the remote UE successfully applies the configuration of the second part, the remote UE encrypts the RRCReconfigurationCompleteSidelink message by using the third security key and then sends it to the relay UE. If the remote UE unsuccessfully applies the configuration of the second part, the remote UE encrypts the RRCReconfigurationFailureSidelink message indicating failure of U2N configuration or multi-path configuration by using the third security key and then sends it to the relay UE. Alternatively, if the remote UE unsuccessfully applies the configuration of the second part, the remote UE initiates the RRC Re-establishment procedure for which the remote UE suspends direct bearer(s) and suspends or releases indirect/split bearers. The remote UE may also release the PC5-RRC connection with the relay UE.

In case of the RRC Re-establishment procedure on Uu interface, the remote UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE.

In case of the RRC Re-establishment procedure via the relay UE, the remote UE sends the RRCReestablishmentComplete message to the relay UE by using SL-RLC1 for SRB1 and then the relay UE forwards the RRCReestablishmentComplete message to the gNB. The RRCReestablishmentComplete message indicates failure of U2N configuration or multi-path configuration and the source or destination identity of the relay UE and/or the remote UE.

Upon receiving the RRCReconfigurationFailureSidelink message, upon receiving the sidelink relay reconfiguration failure or multi-path configuration failure, upon detecting sidelink failure (e.g. due to expiry of timer T400), or if the relay UE unsuccessfully applies the configuration of the first part, the relay UE sends the RRCReconfigurationFailure or RRCReconfigurationComplete message failure of U2N configuration or multi-path configuration to the gNB. Alternatively, upon receiving the RRCReconfigurationFailureSidelink message, upon receiving the sidelink relay reconfiguration failure or multi-path configuration failure, upon detecting sidelink failure (e.g. due to expiry of timer T400), or if the relay UE unsuccessfully applies the configuration of the first part, the relay UE initiates the RRC Re-establishment procedure for which the relay UE suspends direct bearer(s) and suspends or releases indirect/split bearers. The relay UE may also release the PC5-RRC connection with the remote UE or inform the remote UE about the sidelink relay reconfiguration failure or multi-path configuration failure. In the RRC Re-establishment procedure, the relay UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE.

In Option 1, when the remote UE or the relay UE performs the RRC Re-establishment procedure, it can also inform the gNB which UE failed to apply U2N configuration or multi-path configuration, i.e. the remote UE or the relay UE.

### B. Option 2: Separate Delivery of RRC Reconfiguration

gNB sends the first RRCReconfiguration message to the relay UE. The first RRCReconfiguration message includes configuration on addition of at least indirect/split bearer which is applied to the relay UE.

Upon receiving the first RRCReconfiguration message, if the relay UE successfully applies the configuration of the first message, the relay UE sends the RRCReconfigurationComplete message to the gNB. But, after receiving the first message, if the relay UE unsuccessfully applies the configuration of the first message, upon release of the PC5-RRC connection, or upon receiving or detecting the sidelink relay reconfiguration failure or multi-path configuration failure, the relay UE initiates the RRC Re-establishment procedure for which the relay UE suspends direct bearer(s) and suspends or releases indirect/split bearers. The relay UE may also release the PC5-RRC connection with the remote UE or inform the remote UE about the sidelink relay reconfiguration failure or multi-path configuration failure. In the RRC Re-establishment procedure, the relay UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE.
gNB sends the second RRCReconfiguration message to the remote UE. The second RRCReconfiguration message includes configuration on addition of indirect/split bearer and addition of direct bearer and direct path of split bearer which is applied to the remote UE.

gNB can directly send the second RRCReconfiguration message to the remote UE on Uu interface e.g. by using SRB1.

Upon receiving the second message, if the remote UE successfully applies the configuration of the second message, the remote UE sends the RRCReconfigurationComplete message to gNB. If the remote UE unsuccessfully applies the configuration of the second message, the remote UE directly or indirectly sends the RRCReconfigurationFailure or RRCReconfigurationComplete message indicating failure of U2N configuration or multi-path configuration to gNB.

The RRCReconfigurationComplete or the RRCReconfigurationFailure message is directly sent to gNB by using SRB1 or indirectly sent to gNB via the relay UE by using SL-RLC1 for SRB1.

If the remote UE unsuccessfully applies the configuration of the second message, the remote UE can release the PC5-RRC connection with the relay UE or inform the relay UE about sidelink relay reconfiguration failure or multi-path configuration failure.

Alternatively, if the remote UE unsuccessfully applies the configuration of the second message, the remote UE initiates the RRC Re-establishment procedure for which the remote UE suspends direct bearer(s) and suspends or releases indirect/split bearers. The remote UE may also release the PC5-RRC connection with the relay UE and/or informs the relay UE about sidelink relay reconfiguration failure or multi-path configuration failure.

In case of the RRC Re-establishment procedure on Uu interface, the remote UE performs random access to the gNB and configures only direct bearer(s) as the result of the procedure. In the RRC Re-establishment it procedure, the relay UE sends the RRCReestablishmentComplete message indicating failure of U2N configuration or multi-path configuration and the source or destination identity of the relay UE and/or the remote UE.

In case of the RRC Re-establishment procedure via the relay UE, the remote UE sends the RRCReestablishmentComplete message to the relay UE by using SL-RLC1 for SRB1 and then the relay UE forwards the RRCReestablishmentComplete message to the gNB. The RRCReestablishmentComplete message indicates failure of U2N configuration or multi-path configuration and the source or destination identity of the relay UE and/or the remote UE.

Upon release of the PC5-RRC connection or upon receiving the sidelink relay reconfiguration failure or multi-path configuration failure, the relay UE sends the RRCReconfigurationFailure or RRCReconfigurationComplete message failure of U2N configuration or multi-path configuration to the gNB. If the RRCReestablishmentRequest message is received from the remote UE, a RRC container of the RRCReconfigurationComplete message sent from the relay UE to the gNB can include the RRCReestablishmentRequest message received from the remote UE.

Alternatively, upon release of the PC5-RRC connection, upon receiving or detecting the sidelink relay reconfiguration failure or multi-path configuration failure, or if the relay UE unsuccessfully applies the configuration of the first message, the relay UE initiates the RRC Re-establishment procedure for which the relay UE suspends direct bearer(s) and suspends or releases indirect/split bearers. The relay UE may also release the PC5-RRC connection with the remote UE or inform the remote UE about the sidelink relay reconfiguration failure or multi-path configuration failure. In the RRC Re-establishment procedure, the relay UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE. If the RRCReestablishmentRequest message is received from the remote UE, a RRC container of the RRCReestablishmentComplete message sent from the relay UE to the gNB can include the RRCReestablishmentRequest message received from the remote UE.

Alternatively, gNB can indirectly send the second RRCReconfiguration message via the relay UE by using the PC5 Relay RLC channel for SRB1, i.e. SL-RLC1.

Upon receiving the first RRCReconfiguration message, if the relay UE successfully applies the configuration of the first message, the relay UE forwards the second RRCReconfiguration message received from the gNB to the remote UE. The relay UE also sends the RRCReconfigurationComplete message to the gNB. But, after receiving the first message, if the relay UE unsuccessfully applies the configuration of the first message, upon release of the PC5-RRC connection, or upon receiving or detecting the sidelink relay reconfiguration failure or multi-path configuration failure, the relay UE does not forwards the second RRCReconfiguration message received from the gNB to the remote UE, and the relay UE initiates the RRC Re-establishment procedure for which the relay UE suspends direct bearer(s) and suspends or releases indirect/split bearers. The relay UE may also release the PC5-RRC connection with the remote UE or inform the remote UE about the sidelink relay reconfiguration failure or multi-path configuration failure. In the RRC Re-establishment procedure, the relay UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE.

If the relay UE informs the remote UE about the sidelink relay reconfiguration failure or multi-path configuration failure, the remote UE initiates the RRC Re-establishment procedure for which the remote UE suspends direct bearer(s) and suspends or releases indirect/split bearers. The remote UE may also release the PC5-RRC connection with the relay UE.

In case of the RRC Re-establishment procedure on Uu interface, the remote UE performs random access to the gNB and configures only direct bearer(s) as the result of the procedure. In the RRC Re-establishment procedure, the relay UE sends the RRCReestablishmentComplete message indicating failure of U2N configuration or multi-path configuration and the source or destination identity of the relay UE and/or the remote UE.

In case of the RRC Re-establishment procedure via the relay UE, the remote UE sends the RRCReestablishmentComplete message to the relay UE by using SL-RLC1 for SRB1 and then the relay UE forwards the RRCReestablishmentComplete message to the gNB. The RRCReestablishmentComplete message indicates failure of U2N configuration or multi-path configuration and the source or destination identity of the relay UE and/or the remote UE.
14. The U2N Remote UE sends an RRCReconfigurationComplete message indirectly to the gNB via the U2N Relay UE or directly to the gNB as a response. In addition, the gNB configures additional Uu Relay RLC channels between the gNB and U2N Relay UE, and PC5 Relay RLC channels between U2N Relay UE and U2N Remote UE for the relay traffic.
15. The remote UE sends upstream data to the gNB via the relay UE by using the Uu Relay RLC channels and PC5 Relay RLC channels. The gNB sends downstream data to the remote UE via the relay UE by using the Uu Relay RLC channels and PC5 Relay RLC channels.
16. The remote UE and/or the relay UE can perform flow control as follow to control the amount of data over the indirect path.

For example, the remote UE may report the Downlink Data Delivery Status to the relay UE, the relay UE may report the Downlink Data Delivery Status to the base station, or the remote UE may report the Downlink Data Delivery Status to the base station through the relay UE. The Downlink Data Delivery Status report may be reported through an RLC control PDU, reported through a MAC CE, reported through an RRC message, reported through a PDCP control PDU, or reported through another Layer 2 control PDU.

For example, when DL DATA DELIVERY STATUS is reported through PDCP control PDU, it can be reported as follows. For example, the remote UE may report DL DATA DELIVERY STATUS to the base station as follows.

The Remote UE may report the Downlink Data Delivery Status to the base station through a direct path or an indirect path.

In the case of data transmission without SL HARQ feedback or SL RLC feedback (e.g., RLC UM or HARQ feedback disabled channel), the remote UE can be set to report to the base station through a direct path.

In the case of data transmission with SL HARQ feedback or SL RLC feedback (e.g, RLC AM or HARQ feedback enabled channel), the remote UE can be set to report to the base station through a direct path.

The Downlink Data Delivery Status procedure is to provide feedback from the remote UE or the relay UE to the gNB hosting the NR PDCP entity to allow the gNB hosting the NR PDCP entity to control the downlink user data flow via the relay UE for the respective data radio bearer. The relay UE may also transfer uplink user data for the concerned data radio bearer to the gNB hosting the NR PDCP entity together with a DL DATA DELIVERY STATUS in the same Layer 2 PDU carrying the uplink user data.

TABLE 7
When the corresponding node (e.g. the remote UE or the relay UE) decides to trigger the
feedback for Downlink Data Delivery procedure it shall report e.g. to the relay UE or the
gNB:
- a) in case of RLC AM, the highest NR PDCP PDU sequence number successfully delivered
in sequence to the remote UE among those NR PDCP PDUs received from the gNB hosting
the NR PDCP entity i.e. excludes those retransmission NR PDCP PDUs;
- For all other cases, if the NR user plane protocol instance is associated with an RB
configured with at least one RLC AM entity and RLC-UM, the highest successfully
delivered NR PDCP sequence number indicates the combined feedback of the highest NR
PDCP sequence number successfully delivered in sequence to all the involved UEs for which
the RLC AM entites have been configured, no retransmissions are performed, and the highest
NR PDCP sequence number transmitted to the lower layers.
- b) the desired buffer size in bytes for the concerned data radio bearer or for the remote UE;
- c) optionally, the desired data rate in bytes associated with a specific data radio bearer
configured for the UE or for the remote UE;
- d) the NR-U packets that were declared as being “lost” by the corresponding node and have
not yet been reported to the node hosting the NR PDCP entity within the DL DATA
DELIVERY STATUS;
- e) if retransmission NR PDCP PDUs have been delivered, the NR PDCP PDU sequence
number associated with the highest NR-U sequence number among the retransmission NR
PDCP PDUs successfully delivered to the UE in sequence of NR-U sequence number;
- f) if retransmission NR PDCP PDUs have been transmitted to the lower layers, the NR
PDCP PDU sequence number associated with the highest NR-U sequence number among
the retransmission NR PDCP PDUs transmitted to the lower layers in sequence of NR-U
sequence number;
- g) the highest NR PDCP PDU sequence number transmitted to the lower layers among
those NR PDCP PDUs received from the node hosting the NR PDCP entity i.e. excludes
those retransmission NR PDCP PDUs;
- NOTE 2: If the NR user plane protocol instance is associated with an RB configured with
RLC-UM entities only, the highest NR PDCP PDU sequence number transmitted
successfully to all lower layer instances is reported.
- h) in case of RLC AM, the NR PDCP PDU sequence number successfully delivered out of
sequence to the UE among those NR PDCP PDUs received from the node hosting the NR
PDCP entity i.e. excludes those retransmission NR PDCP PDUs.
The gNB hosting the NR PDCP entity, when receiving the DL DATA DELIVERY
STATUS:
- regards the desired buffer size under b) and the data rate under c) above as the amount of
data to be sent from the hosting node (i.e. gNB):
- If the value of the desired buffer size is 0, the hosting node shall stop sending any data per
bearer.
- If the value of the desired buffer size in b) above is greater than 0, the hosting node may
send up to this amount of data per bearer starting from the last “Highest successfully
delivered NR PDCP Sequence Number” for RLC AM if received, or the hosting node may
send up to this amount of data per bearer starting from the last “Highest transmitted NR
PDCP Sequence Number” for RLC UM if received.
- The value of the desired data rate in c) above is the amount of data desired to be received
in a specific amount of time. The amount of time is 1 sec.
- The information of the buffer size in b) above and of the data rate in c) above is valid until
the next DL DATA DELIVERY STATUS frame is received.
- is allowed to remove the buffered NR PDCP PDUs of a RLC AM bearer, according to the
feedback of successfully delivered NR PDCP PDUs;
- decides upon the actions necessary to take for NR PDCP PDUs reported other than
transmitted and/or successfully delivered.

For example, when DL DATA DELIVERY STATUS is reported through RLC control PDU, it can be reported as follows. For example, the relay UE may report DL DATA DELIVERY STATUS to the base station as follows.

For this purpose, the remote UE may provide a SL RLC status report to the relay UE. For example, before performing the Downlink Data Delivery Status process, the relay UE can trigger the SL RLC status report of the remote UE through SL RLC polling.

The Downlink Data Delivery Status procedure is to provide feedback from the remote UE or the relay UE to the gNB hosting the NR PDCP entity to allow the gNB hosting the NR PDCP entity to control the downlink user data flow via the relay UE for the respective data radio bearer. The relay UE may also transfer uplink user data for the concerned data radio bearer to the gNB hosting the NR PDCP entity together with a DL DATA DELIVERY STATUS in the same Layer 2 PDU carrying the uplink user data.

TABLE 8
When the corresponding node (e.g. the remote UE or the relay UE) decides to trigger the
feedback for Downlink Data Delivery procedure it shall report e.g. to the relay UE or the
gNB:
- a) in case of RLC AM, the highest NR RLC PDU sequence number successfully delivered
in sequence to the remote UE among those NR RLC PDUs received from the gNB hosting
the NR RLC entity i.e. excludes those retransmission NR RLC PDUs;
- For all other cases, if the NR user plane protocol instance is associated with an RB
configured with at least one RLC AM entity and RLC-UM, the highest successfully
delivered NR RLC sequence number indicates the combined feedback of the highest NR
RLC sequence number successfully delivered in sequence to all the involved UEs for which
the RLC AM entites have been configured, no retransmissions are performed, and the highest
NR RLC sequence number transmitted to the lower layers.
- b) the desired buffer size in bytes for the concerned data radio bearer or for the remote UE;
- c) optionally, the desired data rate in bytes associated with a specific data radio bearer
configured for the UE or for the remote UE;
- d) the NR-U packets that were declared as being “lost” by the corresponding node and have
not yet been reported to the node hosting the NR RLC entity within the DL DATA
DELIVERY STATUS;
- e) if retransmission NR RLC PDUs have been delivered, the NR RLC PDU sequence
number associated with the highest NR-U sequence number among the retransmission NR
RLC PDUs successfully delivered to the UE in sequence of NR-U sequence number;
- f) if retransmission NR RLC PDUs have been transmitted to the lower layers, the NR RLC
PDU sequence number associated with the highest NR-U sequence number among the
retransmission NR RLC PDUs transmitted to the lower layers in sequence of NR-U sequence
number;
- g) the highest NR RLC PDU sequence number transmitted to the lower layers among those
NR RLC PDUs received from the node hosting the NR RLC entity i.e. excludes those
retransmission NR RLC PDUs;
- NOTE 2: If the NR user plane protocol instance is associated with an RB configured with
RLC-UM entities only, the highest NR RLC PDU sequence number transmitted successfully
to all lower layer instances is reported.
- h) in case of RLC AM, the NR RLC PDU sequence number successfully delivered out of
sequence to the UE among those NR RLC PDUs received from the node hosting the NR
RLC entity i.e. excludes those retransmission NR RLC PDUs.
The gNB hosting the NR RLC entity, when receiving the DL DATA DELIVERY STATUS:
- regards the desired buffer size under b) and the data rate under c) above as the amount of
data to be sent from the hosting node (i.e. gNB):
- If the value of the desired buffer size is 0, the hosting node shall stop sending any data per
bearer.
- If the value of the desired buffer size in b) above is greater than 0, the hosting node may
send up to this amount of data per bearer starting from the last “Highest successfully
delivered NR RLC Sequence Number” for RLC AM if received, or the hosting node may
send up to this amount of data per bearer starting from the last “Highest transmitted NR RLC
Sequence Number” for RLC UM if received.
- The value of the desired data rate in c) above is the amount of data desired to be received
in a specific amount of time. The amount of time is 1 sec.
- The information of the buffer size in b) above and of the data rate in c) above is valid until
the next DL DATA DELIVERY STATUS frame is received.
- is allowed to remove the buffered NR RLC PDUs of a RLC AM bearer, according to the
feedback of successfully delivered NR RLC PDUs;
- decides upon the actions necessary to take for NR RLC PDUs reported other than
transmitted and/or successfully delivered.

For example, DL DATA DELIVERY STATUS reported to the gNB or the relay UE can be constructed as follows, noting that PDCP SN in DL DATA DELIVERY STATUS can be replaced by RLC SN for DL DATA DELIVERY STATUS from the relay UE:

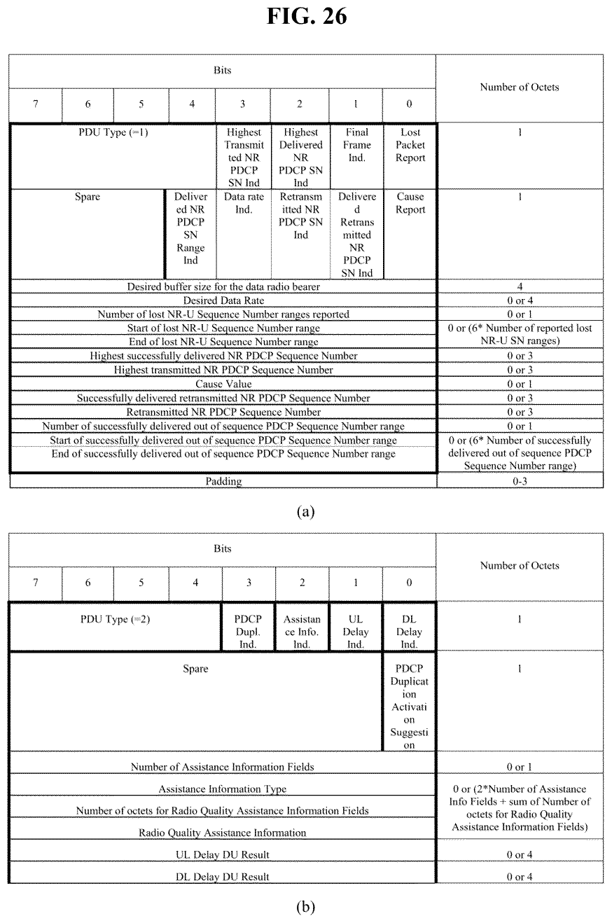

FIG. 26 illustrates examples of DL DATA DELIVERY STATUS.
Through the RRC reconfiguration message, the base station may set SL resource allocation mode 1 to allocate SL resources of the Remote UE. That is, the base station may allocate an SL grant to be transmitted by the remote UE through DCI. In this case, the remote UE may perform the following operations.
(1) The remote UE may directly report Uu BSR (Buffer Status Report MAC CE) and SL-BSR (Sidelink Buffer Status Report MAC CE) to the base station in one of the following ways. For example, when PDCP duplication is configured, the BSR may be reported according to method 1, and otherwise, the BSR may be reported according to method 2 or method 3. Alternatively, the BSR may be reported in one of the following ways according to the setting of the base station.
1) Method 1: Uu BSR for Remote and SL-BSR can be configured to report 100% buffer status in duplicate for the same bearer. For example, when an SL RLC entity and a UL RLC entity are connected together to the same PDCP entity, when the PDCP buffer size of the corresponding bearer is 100 bytes:
In the SL BSR, for the buffer size of a corresponding bearer, the PDCP buffer size 100 bytes and the SL RLC buffer size can be combined and reported.

Here, in the SL-BSR, the buffer status for a specific destination can be set for SL relay. When configuring SL BSR MAC CE for multiple destinations, the buffer size for a specific destination for SL relay can be included in the SL BSR MAC CE with priority over the buffer size for other destinations.
In Uu BSR, for the buffer size of the bearer, PDCP buffer size 100 bytes and UL RLC buffer size can be combined and reported.
After receiving the SL BSR and Uu BSR, the base station can allocate UL resources and SL resources by allocating UL BS (Buffer Size) and SL BS.
2) Method 2: When an SL RLC entity and a UL RLC entity are connected together to the same PDCP entity, the base station determines whether to include the PDCP buffer size in Uu BSR or in SL BSR for each specific bearer, for each specific logical channel group, or for each specific destination. The remote UE can determine whether to report the PDCP buffer size by including it in the Uu BSR or in the SL BSR for each specific bearer, each specific logical channel group, or each specific destination according to the settings of the base station.
3) Method 3: When an SL RLC entity and a UL RLC entity are connected together to the same PDCP entity, the remote UE reports whether to include the PDCP buffer size in Uu BSR or in the SL BSR depending on whether the RLC entity determined as the primary path is UL or SL.
The buffer size of the PDCP entity of the bearer whose direct path is the primary path is reported in Uu BSR and not in SL BSR.
The buffer size of the PDCP entity of the bearer whose indirect path is the primary path is reported in the SL BSR and not in the Uu BSR.
4) Method 4: When the Remote UE operates in SL mode 2, SL resources can be reserved. At this time, the remote UE may determine Y % buffer status based on the reserved resource, and Uu BSR may be configured to report a buffer size of (100−Y) %. The SL-BSR may be configured to report the remaining Y % buffer size, or the SL-BSR report may not be configured/transmitted.
5) Method 5: X % buffer status may be determined based on UL resources allocated to the remote UE, and SL-BSR may be configured to report (100−X) % buffer size. The Uu BSR can be configured to report the buffer size of X % or not to report it. The Remote UE may be set to SL mode 1 or SL mode 2. When set to SL mode 2, the remote UE can reserve SL resources as much as (100−X) % buffer size without reporting (100−X) % buffer size by the SL-BSR.

In the Uu BSR of the above methods, the remote UE can report the BS (Buffer Size) of the split bearer, the BS of the indirect bearer, the BS of the direct bearer, and the BS of the bearer for which PDCP duplication is set.
For example, the BS (Buffer Size) of the split bearer, the BS of the indirect bearer, the BS of the direct bearer, and the BS of the bearer for which PDCP duplication is set can be be reported as BSs for different LCGs.
Alternatively, Uu BSR can be configured to include separate BS fields for the BS (Buffer Size) of the split bearer, the BS of the indirect bearer, the BS of the direct bearer, and the BS of the bearer for which PDCP duplication is set.
(2) Relay UE's BSR reporting method or resource allocation method

If the Remote UE reports SL-BSR or Uu BSR, the base station can set the Relay UE not to report the buffer status of the corresponding U2N bearer. Alternatively, the relay UE may set a specific logical channel group for the corresponding U2N bearer or a specific destination to be included in the Uu BSR with a low priority. Alternatively, the buffer status for the destination of a specific remote UE may not be reported or may be set to be included in the BSR with a low priority.

The base station may allocate the SL resource of the Remote UE according to the SL BSR of the Remote UE and the UL resource of the Relay UE according to the SL resource.
The base station can allocate UL resources for a specific remote UE or logical channel for U2N relay through DCI. The DCI may indicate the destination of the remote UE, or the CRC may be scrambled with a UE specific RNTI mapped to the remote UE or an RNTI for U2N relay.
Or when receiving SL data of a specific PC5 RLC channel from a remote UE, a specific UL resource within a specific time interval can be preferentially used for uplink transmission of the SL data. For example, when configuring a UL MAC PDU in the UL Logical Channel Prioritization process, data of a UL RLC channel mapped to a specific PC5 RLC channel can be preferentially mapped to a specific UL resource within the specific time interval.
(3) The base station may set SL resource allocation mode 2 to allocate SL resources of the Remote UE. That is, the remote UE can select and transmit SL resources within the resource pool allocated by the base station.

In this SL mode 2, the remote UE can be configured to report the SL BSR only for the logical channel for U2N relay. For example, Method 4 and Method 5 may be applied as follows.
4) Method 4: When the Remote UE operates in SL mode 2, SL resources can be reserved. The remote UE may determine the Y % buffer status based on the reserved SL resource, and the Uu BSR may be configured to report a buffer size of (100−Y) %. The SL-BSR may be configured to report the remaining Y % buffer size, or the SL-BSR report may not be configured/transmitted.

Or among the entire 100% upstream data rate, the remote UE can determine the Y % upstream data rate based on the reserved SL resource and transmit the remaining (100−Y) % data rate to UL. Accordingly, the UL buffer size for the data rate of the remaining (100−Y) % may be reported as Uu BSR. The SL-BSR may be configured to report as much as the remaining Y % data rate or may not be configured/transmitted.
5) Method 5: X % buffer status can be determined based on UL resources allocated to the remote UE, and SL-BSR can report (100−X) % buffer size. The Uu BSR can be configured to report the buffer size of X % or not to report it. When set to SL mode 2, the remote UE may reserve SL resources as much as (100−X) % buffer size. The Remote UE may not report the SL-BSR for the corresponding bearer.

Or among the entire 100% upstream data rate, the remote UE can determine the X % upstream data rate based on the allocated UL resource and transmit the remaining (100−X) % data rate to the SL. Accordingly, it is possible to reserve SL resources for a data rate of (100−X) %. UL buffer size can be reported in Uu BSR. The Uu BSR can be configured to report the buffer size of X % or not to report it. The Remote UE may not report the SL-BSR for the corresponding bearer.
(4) If SL BSR is not configured, Remote UE can report only Uu BSR.

Since the base station cannot control SL transmission, when the Uu BSR for remote always reports 100% buffer status, there is a problem in that UL or SL resources are allocated unnecessarily.

Uplink resource of Remote UE
The base station can allocate UL resources by distributing UL BS and SL BS
Except for the amount of data transmitted to UL resources, the rest of the data is transmitted to SL relay
The Remote UE can be configured to allocate only Y % of the PDCP buffer as SL resources.

The remote UE can configure Y % for all destinations or for each logical channel.

The remote UE can determine Y % with a value indicated by the base station or relay UE, or with a min, max, or average value among Y1 and Y2 indicated by the base station/relay UE.
The remote UE can designate the maximum, minimum, or average SL data rate for all destinations or for each logical channel. Accordingly, SL data transmission exceeding the SL data rate may be dropped, SL resources may be allocated not to exceeding the SL data rate, or SL resources exceeding the SL data rate may be canceled.

For example, SL resources reserved per time may be limited according to the SL data rate.

The remote UE can set the SL data rate for all destinations or for each logical channel.

The remote UE can determine the SL data rate with a value indicated by the base station or relay UE, or can determine the SL data rate with a min, max, or average value among SL data rate 1 and SL data rate 2 indicated by the base station/relay UE.
A base station or relay UE can set a CR limit to be applied by a remote UE. The Remote UE can limit the amount of data to be transmitted to the SL according to the CR limit. Accordingly, SL data transmission exceeding the CR limit may be dropped.

The CR limits can be set for all destinations or for each logical channel.

The remote UE can determine the CR limit with a value indicated by the base station or relay UE, or can determine the CR limit with a min, max, or average value among CR limit1 and CR limit2 indicated by the base station/relay UE.
The base station or relay UE sets the resource pool for all destinations or for each logical channel, and the remote UE can reserve and transmit SL resources within the configured resource pool.

The base station can set to limit the number of SL resources in the resource pool. In addition, the relay UE may again limit the number of SL resources in the resource pool set by the base station. Alternatively, the number of SL resources may be determined as min, max, or average value among the number of SL resources 1 and the number of SL resources 2 limited by the base station/relay UE.
(5) When U2N Relay is configured, the remote UE and relay UE can report Uu BSR or SL BSR as follows.

### 1) BSR Reporting Method of Remote UE

### Uu BSR

In the case of a specific bearer or split bearer, for the PDCP entity and UL RLC entity of the bearer:

The remote UE can include and report only the PDCP buffer size excluding the RLC buffer size in the BSR.

Alternatively, the remote UE may include both the RLC buffer size and the PDCP buffer size in the BSR and report it.

Alternatively, the remote UE may include and report only the RLC buffer size excluding the PDCP buffer size in the BSR.

In the case of a specific indirect bearer, the remote UE does not include the corresponding BS in the BSR.

### SL-BSR

In the case of a specific bearer or split bearer, for the PDCP entity and SL RLC entity of the bearer:

The remote UE can include and report only the PDCP buffer size excluding the RLC buffer size in the SL BSR.

Alternatively, the remote UE may include both the RLC buffer size and the PDCP buffer size in the SL BSR and report them.

Alternatively, the remote UE may include and report only the RLC buffer size excluding the PDCP buffer size in the SL BSR.

In the case of a specific direct bearer, the remote UE does not include the corresponding BS in the SL BSR.

### 2) Relay UE's BSR Reporting Method

### Uu BSR

In the case of a specific bearer, split bearer, or indirect bearer, only the RLC buffer size of the corresponding U2N bearer can be reported.

### SL-BSR

The base station can allocate the SL resources of the relay UE based on the DL U2N bearer data transmission amount, but the base station may not know SL RLC AM retransmission, SL RLC control PDU, or SL MAC CE. Therefore, the relay UE can be configured to include only the size of SL RLC AM retransmission, SL RLC control PDU, or SL MAC CE in the SL BSR.

To reduce unnecessary SL BSR transmission,

Relay UE can be configured not to report SL BS for a specific destination.

Relay UEs can be configured to report only specific data (e.g. retransmission/control PDU/MAC CE) for specific destinations.

The Remote UE can report the TX SL buffer size waiting for transmission of the Remote UE to the Relay UE. In this case, the relay UE may report the pre-emptive BSR to the base station. The pre-emptive BSR MAC CE may include the expected PDCP and/or RLC buffer size calculated based on the TX SL buffer size reported by the Remote UE.
(6) When a remote UE configures a split bearer, the following operations may be performed for the split bearer having a direct path and an indirect path.

When the primary path of a specific bearer is a direct path, Remote UE may preferentially use UL resources for data of the corresponding bearer, and only data remaining after consuming all UL resources may be transmitted in SL resources.

When the primary path of a specific bearer is an indirect path, Remote UE may preferentially use SL resources for the data of the bearer, and only data remaining after consuming all SL resources can be transmitted as UL resources.

The Remote UE may switch or maintain the primary path of a specific bearer to an indirect path if one or more of the following condition(s) are satisfied.
If the serving cell measurement result of the Remote UE is below a specific threshold, the primary path of a specific bearer can be switched to an indirect path.
If the CBR measurement result for the SL resource is below a specific threshold, the primary path of a specific bearer can be switched to an indirect path.
If the SL relay measurement result for SL resources (e.g. SL-RSRP or SD-RSRP measurement result of relay UE) exceeds a specific threshold, the primary path of a specific bearer can be switched to an indirect path.
When a Uu failure is detected in a specific bearer, the primary path of the specific bearer can be switched to an indirect path.

When integrity protection failure, RLC retransmission failure, RLF, bearer reconfiguration failure, beam failure, etc. are detected for a specific bearer, it can be switched to an indirect path.

The Remote UE may switch or maintain the primary path of a specific bearer to a direct path if one or more of the following condition(s) are satisfied.
If the serving cell measurement result of the Remote UE is equal to or greater than a specific threshold, the primary path of a specific bearer can be switched to a direct path.
If the CBR measurement result for the SL resource exceeds a specific threshold, the primary path of a specific bearer can be switched to a direct path.
If the SL relay measurement result for SL resources (e.g. SL-RSRP or SD-RSRP measurement result of relay UE) is below a specific threshold, the primary path of a specific bearer can be switched to a direct path.
When an SL failure is detected in a specific bearer, the primary path of the specific bearer can be switched to a direct path.

When integrity protection failure, RLC retransmission failure, HARQ feedback based SL failure, bearer reconfiguration failure, etc. are detected for a specific bearer, it can be switched to the direct path.
17. The remote UE may be configured by the network to derive NR sidelink measurement results of serving L2 Relay UE or candidate L2 U2N Relay UEs associated to the measurement objects configured in the measObjectRelay.

The remote UE may receive measurement configuration in the RRCReconfiguration message. If the UE receives a measConfig in the RRCReconfiguration message, the UE perform the measurements and initiate the measurement reporting procedure for each measId included in the measIdList within VarMeasConfig as follows:
A. if the measObject is associated to L2 U2N Relay UE, the remote UE performs the corresponding measurements associated to candidate Relay UEs on the frequencies indicated in the concerned measObject. When performing the measurements, the UE filters the measured result based on layer 3 filtering, before using for evaluation of reporting criteria or for measurement reporting for each candidate L2 U2N Relay UE measurement quantity:
B. For each L2 U2N Relay UE measurement quantity to be derived, the remote UE shall:
   derive the corresponding measurement quantity based on DMRS as described in TS 38.215 of the L2 U2N Relay UE associated to the NR sidelink frequency indicated in the concerned measObjectRelay; and
   apply layer 3 filtering.
C. If the corresponding measObject concerns L2 U2N Relay UE:
   if eventY1-Relay is configured in the corresponding reportConfig; or
   if corresponding reportConfig includes reportType set to periodical:
the remote UE shall consider any L2 U2N Relay UE detected on the associated frequency to be applicable for this measId;
Table 9 describes events for measurement report triggering.

TABLE 9
Event X1 (Serving L2 U2N Relay UE becomes worse than threshold1 and NR Cell
becomes better than threshold2)
The UE shall:
1> consider the entering condition for this event to be satisfied when both condition X1-
1 and condition X1-2, as specified below, are fulfilled;
1> consider the leaving condition for this event to be satisfied when condition X1-3 or
condition X1-4, i.e. at least one of the two, as specified below, is fulfilled;
Inequality X1-1 (Entering condition 1)
Mr + Hys < Thresh1
Inequality X1-2 (Entering condition 2)
Mn + Ofn + Ocn − Hys > Thresh2
Inequality X1-3 (Leaving condition 1)
Mr − Hys > Thresh1
Inequality X1-4 (Leaving condition 2)
Mn + Ofn + Ocn + Hys < Thresh2
The variables in the formula are defined as follows:
Mr is the measurement result of the serving L2 U2N Relay UE, not taking into account
any offsets.
Mn is the measurement result of the NR cell, not taking into account any offsets.
Ofn is the measurement object specific offset of the frequency of the NR cell.
Ocn is the cell specific offset of the NR cell, and set to zero if not configured for the cell.
Hys is the hysteresis parameter for this event.
Thresh1 is the threshold parameter for this event (i.e. x1-Threshold1-Relay as defined
within reportConfigNR for this event).
Thresh2 is the threshold parameter for this event (i.e. x1-Threshold2 as defined within
reportConfigNR for this event).
Mr is expressed in dBm.
Mn is expressed in dBm in case of RSRP, or in dB in case of RSRQ and RS-SINR.
Ofn, Ocn, Hys are expressed in dB.
Thresh1 is expressed in the same unit as Mr.
Thresh2 is expressed in the same unit as Mn.
Event X2 (Serving L2 U2N Relay UE becomes worse than threshold)
The UE shall:
1> consider the entering condition for this event to be satisfied when condition X2-1, as
specified below, is fulfilled;
1> consider the leaving condition for this event to be satisfied when condition X2-2, as
specified below, is fulfilled;
Inequality X2-1 (Entering condition)
Mr + Hys < Thresh
Inequality X2-2 (Leaving condition)
Mr − Hys > Thresh
The variables in the formula are defined as follows:
Mr is the measurement result of the serving L2 U2N Relay UE, not taking into account
any offsets.
Hys is the hysteresis parameter for this event.
Thresh is the threshold parameter for this event (i.e. x2-Threshold-Relay as defined
within reportConfigNR for this event).
Mr is expressed in dBm.
Hys are expressed in dB.
Thresh is expressed in the same unit as Mr.
Event X3 (Serving L2 U2N Relay UE becomes worse than threshold1 and PCell (or
PSCell or SCell) becomes better than threshold2)
The UE shall:
1> consider the entering condition for this event to be satisfied when both condition X3-
1 and condition X3-2, as specified below, are fulfilled;
1> consider the leaving condition for this event to be satisfied when condition X3-3 or
condition X3-4, i.e. at least one of the two, as specified below, is fulfilled;
Inequality X3-1 (Entering condition 1)
Mr + Hys < Thresh1
Inequality X3-2 (Entering condition 2)
Mn + Ofn + Ocn − Hys > Thresh2
Inequality X3-3 (Leaving condition 1)
Mr − Hys > Thresh1
Inequality X3-4 (Leaving condition 2)
Mn + Ofn + Ocn + Hys < Thresh2
The variables in the formula are defined as follows:
Mr is the measurement result of the serving L2 U2N Relay UE, not taking into account
any offsets.
Mn is the measurement result of the PCell (or PSCell or SCell), not taking into account
any offsets.
Ofn is the measurement object specific offset of the frequency of the NR cell.
Ocn is the cell specific offset of the PCell (or PSCell or SCell), and set to zero if not
configured for the cell.
Hys is the hysteresis parameter for this event.
Thresh1 is the threshold parameter for this event (i.e. x3-Threshold1-Relay as defined
within reportConfigNR for this event).
Thresh2 is the threshold parameter for this event (i.e. x3-Threshold2 as defined within
reportConfigNR for this event).
Mr is expressed in dBm.
Mn is expressed in dBm in case of RSRP, or in dB in case of RSRQ and RS-SINR.
Ofn, Ocn, Hys are expressed in dB.
Thresh1 is expressed in the same unit as Mr.
Thresh2 is expressed in the same unit as Mn.
Note that the remote UE can be configured with different X3 events for PCell, PSCell
and each SCell, respectively.
Event Y1 (PCell becomes worse than threshold1 and candidate L2 U2N Relay UE
becomes better than threshold2)
The UE shall:
1> consider the entering condition for this event to be satisfied when both condition Y1-
1 and condition Y1-2, as specified below, are fulfilled;
1> consider the leaving condition for this event to be satisfied when condition Y1-3 or
condition Y1-4, i.e. at least one of the two, as specified below, is fulfilled;
Inequality Y1-1 (Entering condition 1)
Mp + Hys < Thresh1
Inequality Y1-2 (Entering condition 2)
Mr− Hys > Thresh2
Inequality Y1-3 (Leaving condition 1)
Mp − Hys > Thresh1
Inequality Y1-4 (Leaving condition 2)
Mr + Hys < Thresh2
The variables in the formula are defined as follows:
Mp is the measurement result of the PCell, not taking into account any offsets.
Mr is the measurement result of the candidate L2 U2N Relay UE, not taking into account
any offsets.
Hys is the hysteresis parameter for this event (i.e. hysteresis as defined within
reportConfigInterRAT for this event).
Thresh1 is the threshold parameter for this event (i.e. y1-Threshold1 as defined within
reportConfigInterRAT for this event).
Thresh2 is the threshold parameter for this event (i.e. y1-Threshold2-Relay as defined
within reportConfigInterRAT for this even).
Mp is expressed in dBm in case of RSRP, or in dB in case of RSRQ and SINR.
Mr is expressed in dBm or dB, depending on the measurement quantity of candidate L2
U2N Relay UE.
Hys are expressed in dB.
Thresh1 is expressed in the same unit as Mp.
Thresh2 is expressed in the same unit as Mr.
Event Y2 (Candidate L2 U2N Relay UE becomes better than threshold)
The UE shall:
1> consider the entering condition for this event to be satisfied when condition Y2-1, as
specified below, is fulfilled;
1> consider the leaving condition for this event to be satisfied when condition Y2-2, as
specified below, is fulfilled;
Inequality Y2-1 (Entering condition)
Mr− Hys > Thresh2
Inequality Y2-2 (Leaving condition)
Mr + Hys < Thresh2
The variables in the formula are defined as follows:
Mr is the measurement result of the candidate L2 U2N Relay UE, not taking into account
any offsets.
Hys is the hysteresis parameter for this event (i.e. hysteresis as defined within
reportConfigInterRAT for this event).
Thresh is the threshold parameter for this event (i.e. y2-Threshold-Relay as defined
within reportConfigInterRAT for this event).
Mr is expressed in dBm or dB, depending on the measurement quantity of candidate L2
U2N Relay UE.
Hys are expressed in dB.
Thresh is expressed in the same unit as Mr.
Event Y3 (PCell (or PSCell or SCell) becomes worse than threshold1 and Serving
L2 U2N Relay UE becomes better than threshold2)
The UE shall:
1> consider the entering condition for this event to be satisfied when both condition Y3-
1 and condition Y1-2, as specified below, are fulfilled;
1> consider the leaving condition for this event to be satisfied when condition Y3-3 or
condition Y3-4, i.e. at least one of the two, as specified below, is fulfilled;
Inequality Y3-1 (Entering condition 1)
Mp + Hys < Thresh1
Inequality Y3-2 (Entering condition 2)
Mr− Hys > Thresh2
Inequality Y3-3 (Leaving condition 1)
Mp − Hys > Thresh1
Inequality Y3-4 (Leaving condition 2)
Mr + Hys < Thresh2
The variables in the formula are defined as follows:
Mp is the measurement result of the PCell (or PSCell or SCell), not taking into account
any offsets.
Mr is the measurement result of the candidate L2 U2N Relay UE, not taking into account
any offsets.
Hys is the hysteresis parameter for this event (i.e. hysteresis as defined within
reportConfigInterRAT for this event).
Thresh1 is the threshold parameter for this event (i.e. y3-Threshold1 as defined within
reportConfigInterRAT for this event).
Thresh2 is the threshold parameter for this event (i.e. y3-Threshold2-Relay as defined
within reportConfigInterRAT for this even).
Mp is expressed in dBm in case of RSRP, or in dB in case of RSRQ and SINR.
Mr is expressed in dBm or dB, depending on the measurement quantity of candidate L2
U2N Relay UE.
Hys are expressed in dB.
Thresh1 is expressed in the same unit as Mp.
Thresh2 is expressed in the same unit as Mr.
Note that the remote UE can be configured with different Y3 events for PCell, PSCell
and each SCell, respectively.
eventX3-r17 SEQUENCE {
x3-Threshold1-Relay-r17 SL-MeasTriggerQuantity-r16,
x3-Threshold2-r17 MeasTriggerQuantity,
reportOnLeave-r17 BOOLEAN,
hysteresis-r17 Hysteresis,
timeToTrigger-r17 TimeToTrigger
},
eventY3-Relay-r17 SEQUENCE {
y3-Threshold1-r17 MeasTriggerQuantity,
y3-Threshold2-Relay-r17 SL-MeasTriggerQuantity-r16,
reportOnLeave-r17 BOOLEAN,
hysteresis-r17 Hysteresis,
timeToTrigger-r17 TimeToTrigger,
},
SL-MeasReportQuantity-r16 ::= CHOICE {
sl-RSRP-r16 BOOLEAN,
}
SL-MeasTriggerQuantity-r16 ::= CHOICE {
sl-RSRP-r16 RSRP-Range,
}

D. if the reportType is set to eventTriggered and if the entry condition applicable for this event, i.e. the event corresponding with the eventId of the corresponding reportConfig within VarMeasConfig, is fulfilled for one or more applicable L2 U2N Relay UEs for all measurements after layer 3 filtering taken during timeToTrigger defined for this event within the VarMeasConfig, while the VarMeasReportList does not include a measurement reporting entry for this measId (a first L2 U2N Relay UE triggers the event), the remote UE shall:
   include a measurement reporting entry within the VarMeasReportList for this measId;
   set the numberOfReportsSent defined within the VarMeasReportList for this measId to 0;
   include the concerned L2 U2N Relay UE(s) in the relaysTriggeredList defined within the VarMeasReportList for this measId;
   initiate the measurement reporting procedure, as in the next step(s).
else if the reportType is set to eventTriggered and if the entry condition applicable for this event, i.e. the event corresponding with the eventId of the corresponding reportConfig within VarMeasConfig, is fulfilled for one or more applicable L2 U2N Relay UEs not included in the relaysTriggeredList for all measurements after layer 3 filtering taken during timeToTrigger defined for this event within the VarMeasConfig (a subsequent L2 U2N Relay UE triggers the event), the remote UE shall:
   set the numberOfReportsSent defined within the VarMeasReportList for this measId to 0;
   include the concerned L2 U2N Relay UE(s) in the relaysTriggeredList defined within the VarMeasReportList for this measId;
   initiate the measurement reporting procedure, as in the next step(s).
E. else if the reportType is set to eventTriggered and if the leaving condition applicable for this event is fulfilled for one or more of the L2 U2N Relay UEs included in the relays TriggeredList defined within the VarMeasReportList for this measId for all measurements after layer 3 filtering taken during timeToTrigger defined within the VarMeasConfig for this event, the remote UE shall,
   remove the concerned L2 U2N Relay UE(s) in the relaysTriggeredList defined within the VarMeasReportList for this measId;
   if reportOnLeave is set to true for the corresponding reporting configuration, initiate the measurement reporting procedure, as in the next step(s).
   if the relaysTriggeredList defined within the VarMeasReportList for this measId is empty: remove the measurement reporting entry within the VarMeasReportList for this measId; stop the periodical reporting timer for this measId, if running;
F. if reportType is set to periodical and if a (first) measurement result is available:
   if the reportAmount exceeds 1: the UE shall initiate the measurement reporting procedure, as specified in 5.5.5, immediately after the quantity to be reported becomes available for the NR SpCell or for the serving L2 U2N Relay UE (if the UE is a L2 U2N Remote UE);
   else (i.e. the reportAmount is equal to 1): initiate the measurement reporting procedure, as specified in 5.5.5, immediately after the quantity to be reported becomes available for the NR SpCell and for the strongest cell among the applicable cells, or for the NR SpCell and for the strongest L2 U2N Relay UEs among the applicable L2 U2N Relay UEs; or initiate the measurement reporting procedure, as in the next step(s), immediately after the quantity to be reported becomes available for the serving L2 U2N Relay UE and for the strongest cell among the applicable cells (if the UE is a L2 U2N Remote UE);
18. Upon initiation of the measurement reporting procedure in the previous step, for the measId for which the measurement reporting procedure was triggered, the UE shall set the measResults within the MeasurementReport message as follows, and then the remote UE sends the MeasurementReport message via SRB to the network.
A. if the UE is connected with a L2 U2N Relay UE via PC5-RRC connection (i.e. the UE is a L2 U2N Remote UE), the UE shall set the sl-MeasResultServingRelay to include the SL-RSRP of the serving L2 U2N Relay UE;
   In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
B. if there is at least one applicable neighbouring cell to report:
   if the reportType is set to eventTriggered or periodical and if the measurement report concerns the candidate L2 U2N Relay UE, the UE shall set the sl-MeasResultCandRelay to include the best candidate L2 U2N Relay UEs up to maxReportCells in accordance with the following:
      if the reportType is set to eventTriggered: the UE shall include the L2 U2N Relay UEs included in the relaysTriggeredList as defined within the VarMeasReportList for this measId;
      else: the UE shall include the applicable L2 U2N Relay UEs for which the new measurement results became available since the last periodical reporting or since the measurement was initiated or reset;
   For each L2 U2N Relay UE that is included in the sl-MeasResultsCandRelay, the UE shall include the sl-RelayUEIdentity. For each included L2 U2N Relay UE, the UE shall include the layer 3 filtered measured results in accordance with the reportConfig for this measId, ordered
      if the measObject associated with this measId concerns L2 U2N Relay UE, the UE shall set the measResult to include the quantity(ies) indicated in the reportQuantityRelay within the concerned reportConfigRelay in decreasing order of the sorting quantity, the best L2 U2N Relay UE is included first;
         for a candidate L2 U2N Relay UE, the UE shall consider the yN-Threshold2-Relay as the sorting quantity;
         for a candidate L2 U2N Relay UE, the UE shall consider the reportQuantityRelay as the sorting quantity.

Table 10 describes SL-MeasResultsSLRelay Information Element.

```
TABLE 10
  - SL-MeasResultsRelay
  The IE SL-MeasResultsSLRelay covers measured results of L2 U2N Relay UEs.
  SL-MeasResultsRelay information element
  SL-MeasResultsRelay-r17 ::= SEQUENCE {
  sl-MeasResultsListRelay-r17 SEQUENCE {
  sl-MeasResultNR-Relay-r17 SL-MeasResultNR-Relay-r17,
  },
  }
  SL-MeasResultNR-Relay-r17 ::= SEQUENCE {
  sl-FrequencyInfo-r17 ARFCN-ValueNR,
  sl-MeasResultListRelay-r17 SEQUENCE (SIZE (1.. maxNrofRelayToMeasure-r17))
OF SL-MeasResultRelay-r17,
  }
  SL-MeasResultRelay-r17 ::= SEQUENCE {
  cellIdentity-r17 CellAccessRelatedInfo,
  sl-RelayUEIdentity-r17 SL-SourceIdentity-r17,
  sl-MeasResult-r17-r17 SL-MeasResult-r16,
  }
  SL-MeasResult-r16 ::= SEQUENCE {
  sl-ResultDMRS-r16 SL-MeasQuantityResult-r16 OPTIONAL,
  }
  SL-MeasQuantityResult-r16 ::= SEQUENCE {
  sl-RSRP-r16 RSRP-Range OPTIONAL,
  }
  sl-RelayUEIdentity
  The identity of the measured L2 U2N Relay UE's source L2 ID.
```

C. In the second message or the RRCReconfiguration message, the gNB can configure the reportConfig associated with the measId that triggered the measurement reporting is set to eventTriggered and eventID is set to one or more events for event-triggered measurement reporting as follows:
   For the serving cell where the remote UE camps on, for the serving cell where the relay UE camps on, or for the best ranked suitable cell of the remote UE, the remote UE can be configured with one or more of the following events:
Event A1 (Serving/best cell quality becomes better than threshold)
Event A2 (Serving/best cell quality becomes worse than threshold)
Event A3 (Neighbour cell becomes offset better than the serving/best cell in terms of cell quality)
Event N1 (Neighbour cell quality becomes better than threshold)

The remote UE can trigger this event only for a cell indicated by the gNB in the RRCReconfiguration message.
Event N2 (Neighbour cell quality becomes worse than threshold)

The remote UE can trigger this event only for a cell indicated by the gNB in the RRCReconfiguration message.

Note that the best ranked suitable cell of the remote UE or the serving cell where the remote UE is camping on can be same as or different than the serving cell of the relay UE.

Note that the remote UE can be configured to trigger event A3, N1 and/or N2 only for a cell indicated by the gNB in the RRCReconfiguration message.
For the serving frequency of the serving cell where the remote UE camps on or of the best ranked suitable cell of the remote UE, for the frequency with the highest cell reselection priority or a cell reselection priority higher than a priority threshold (e.g. higher priority than the threshold), or for a non-serving frequency of the remote UE, the remote UE can be configured with one or more of the following events:
Event S1 (Suitable/best cell quality on the frequency becomes better than threshold)
Event S2 (Suitable/best cell quality on the frequency becomes worse than threshold)
Event S3 (Neighbour suitable cell becomes offset better than the best cell in terms of cell quality)

Note that if the above event is triggered for the suitable/best cell or a neighbouring cell, the remote UE reports the following information to the gNB.
measurement results on the suitable/best cell and/or the neighbour suitable cell
whether the neighbour cell is suitable or not as a result of suitability check based on reading SIB1 of the neighbouring cell.
the global cell identity of the suitable/best cell
the global cell identity of the neighbour cell
D. In the second message or the RRCReconfiguration message, the gNB can configure the reportConfig associated with the measId that triggered the measurement reporting is set to periodical as the reportType and so the remote UE performs as follows:
The UE performs the corresponding measurements associated to the serving cell of the remote UE, the serving cell of the relay UE (if the serving cell has been indicated by the relay UE), and/or the best ranked (suitable) cell of the remote UE for the frequency indicated by the gNB.
If the received measObject includes the cellsToAddModList in the RRCReconfiguration message, the UE performs the corresponding measurements associated to each cell corresponding to a physCellId value included in the cellsToAddModList or each detected cell on the frequency indicated by the gNB.
Then, the UE periodically report the measurement result on each cell (as measured by the remote UE in the above steps) to the gNB via the relay UE.

In the measurement report to the gNB, the UE first includes measured result(s) on the serving cell of the remote UE and/or the serving cell of the relay UE in order (or the serving cell of the relay UE and/or the serving cell of the remote UE) and then measured results on each other cell in the cellsToAddModList in decreasing order of the sorting quantity (e.g. in decreasing order of measured RSRP or RSRQ results).
19. After RRC connection establishment and PC5-RRC connection establishment or after the RRC reconfiguration, the relay UE and/or the remote UE can perform the Sidelink UE information for NR sidelink communication procedure in which the UE sends the SidelinkUEInformationNR message to gNB.

The UE shall set the contents of the SidelinkUEInformationNR message as follows:
A. If a specific SIB (e.g. SIB12) includes sl-NonRelayDiscovery and if configured by upper layers to receive NR sidelink non-relay discovery announcements, or if a specific SIB (e.g. SIB12) includes sl-L2U2N-Relay and if configured by upper layers to receive NR sidelink L2 U2N relay discovery announcements, or if a specific SIB (e.g. SIB12) includes sl-L3U2N-RelayDiscovery and if configured by upper layers to receive NR sidelink L3 U2N relay discovery announcements, or if a specific SIB (e.g. SIB12) include an indication to multi-path support and if configured by upper layers to receive NR sidelink U2N relay discovery announcements:
   the UE shall include sl-RxInterestedFreqListDisc and set it to the frequency for NR sidelink discovery announcements reception;
   if the UE is capable of L2 U2N remote UE or the UE is capable of multi-path operation as a remote UE, the UE shall include sl-SourceIdentity-RemoteUE and set it to the source identity configured by upper layer for NR sidelink L2 U2N relay communication transmission.
B. if a specific SIB (e.g. SIB12) includes sl-NonRelayDiscovery and if configured by upper layers to transmit NR sidelink non-relay discovery announcements, or if a specific SIB (e.g. SIB12) includes sl-L2U2N-Relay and if configured by upper layers to transmit NR sidelink L2 U2N relay discovery announcements, or if a specific SIB (e.g. SIB12) includes sl-L3U2N-RelayDiscovery and if configured by upper layers to transmit NR sidelink L3 U2N relay discovery announcements, or if a specific SIB (e.g. SIB12) include an indication to multi-path support and if configured by upper layers to transmit NR sidelink U2N relay discovery announcements: the UE shall include sl-TxResourceReqListDis and set its fields (if needed) as follows for each destination for which it requests the network to assign NR sidelink discovery announcements resource:
   set sl-DestinationIdentityDisc to the destination identity configured by upper layer for NR sidelink discovery announcements transmission;
   if the UE is acting as L2 U2N Relay UE, the UE shall set sl-SourceIdentity-RelayUE to the source identity configured by upper layer for NR sidelink L2 U2N relay discovery announcements transmission;
   set sl-CastTypeDisc to the cast type of the associated destination identity configured by the upper layer for the NR sidelink discovery announcements transmission;
   set sl-InterestedFreqListDisc to indicate the frequency of the associated destination for NR sidelink discovery announcements transmission;
   set sl-TypeTxSyncListDisc to the current synchronization reference type used on the associated sl-InterestedFreqList for NR sidelink discovery announcements transmission;
   set sl-DiscoveryType to the current discovery type of the associated destination identity configured by the upper layer for NR sidelink discovery announcements transmission;
C. if configured by upper layers to transmit NR sidelink L2 U2N relay communication and the UE is acting as L2 U2N Relay UE for multi-path, the relay UE shall:
   include sl-TxResourceReqL2U2N-Relay in sl-TxResourceReqListCommRelay and set its fields (if needed) as follows for each destination for which it requests network to assign NR sidelink L2 U2N relay communication resource:
   set sl-DestinationIdentityL2U2N to the destination identity configured by upper layer for NR sidelink L2 U2N relay communication transmission;
   set sl-TxInterestedFreqListL2U2N to indicate the frequency of the associated destination for NR sidelink L2 U2N relay communication transmission;
   set sl-TypeTxSyncListL2U2N to the current synchronization reference type used on the associated sl-InterestedFreqListL2U2N for NR sidelink L2 U2N relay communication
   set sl-LocalID-Request to request local ID for L2 U2N Remote UE;
   set sl-PagingIdentity-RemoteUE to the paging UE ID received from peer L2 U2N Remote UE;
   set sl-CapabilityInformationSidelink to include UECapability InformationSidelink message, if any, received from peer UE.
   include ue-Type and set it to relayUE;
   include an indication to multi-path support/request
   include an indication to a RRC state of the remote UE or whether the remote UE is in RRC_CONNECTED or not.
   include the cell identity of PCell for the remote UE.
   include the PLMN identity of the registered PLMN for the remote UE.
   include Tracking Area Code of the tracking area that the remote UE is registered for PCell.
D. if configured by upper layers to transmit NR sidelink L2 U2N relay communication and the UE has a selected L2 U2N Relay UE for multi-path, the remote UE shall:
   include sl-TxResourceReqL2U2N-Relay in sl-TxResourceReqListCommRelay and set its fields (if needed) as follows to request network to assign NR sidelink L2 U2N relay communication resource:
   set sl-TxInterestedFreqListL2U2N to indicate the frequency of the associated destination for NR sidelink L2 U2N relay communication transmission;
   set sl-TypeTxSyncListL2U2N to the current synchronization reference type used on the associated sl-InterestedFreqListL2U2N for NR sidelink L2 U2N relay communication
   set sl-CapabilityInformationSidelink to include UECapability InformationSidelink message, if any, received from peer UE.
   include ue-Type and set it to remoteUE;
   include an indication to multi-path support/request
   include an indication to a RRC state of the relay UE or whether the relay UE is in RRC_CONNECTED or not.
   include the cell identity of PCell for the relay UE.
   include the PLMN identity of the registered PLMN for the relay UE.
   include Tracking Area Code of the tracking area that the relay UE is registered for PCell.
E. if configured by upper layers to transmit NR sidelink L3 U2N relay communication, the relay UE or the remote UE shall:
   include sl-TxResourceReqL3U2N-Relay in sl-TxResourceReqListCommRelay and set its fields (if needed) as follows for each destination for which it requests network to assign NR sidelink L3 U2N relay communication resource:
   set sl-DestinationIdentity to the destination identity configured by upper layer for NR sidelink L3 U2N relay communication transmission;
   set sl-CastType to the cast type of the associated destination identity configured by the upper layer for the NR sidelink L3 U2N relay communication transmission;
   set sl-RLC-ModeIndication to include the RLC mode(s) and optionally QoS profile(s) of the sidelink QoS flow(s) of the associated RLC mode(s), if the associated bi-directional sidelink DRB has been established due to the configuration by RRCReconfigurationSidelink;
   set sl-QoS-InfoList to include QoS profile(s) of the sidelink QoS flow(s) of the associated destination configured by the upper layer for the NR sidelink L3 U2N relay communication transmission;
   set sl-TxInterestedFreqList to indicate the frequency of the associated destination for NR sidelink L3 U2N relay communication transmission;
   set sl-TypeTxSyncList to the current synchronization reference type used on the associated sl-InterestedFreqList for NR sidelink L3 U2N relay communication transmission.
   set sl-CapabilityInformationSidelink to include UECapability InformationSidelink message, if any, received from peer UE.
   include ue-Type and set it to relayUE if the UE is acting as NR sidelink L3 U2N Relay UE and to remoteUE otherwise;
   include an indication to multi-path support/request
   include an indication to a RRC state of the relay UE or whether the relay UE is in RRC_CONNECTED or not.
   include an indication to a RRC state of the remote UE or whether the remote UE is in RRC_CONNECTED or not.
   if the UE is acting as NR sidelink U2N Remote UE:
      include the cell identity of PCell for the relay UE.
      include the PLMN identity of the registered PLMN for the relay UE.
      include Tracking Area Code of the tracking area that the relay UE is registered for PCell.
   if the UE is acting as NR sidelink U2N Relay UE:
      include the cell identity of PCell for the remote UE.
      include the PLMN identity of the registered PLMN for the remote UE.
      include Tracking Area Code of the tracking area that the remote UE is registered for PCell.
20. Upon receiving the report(s) from the remote UE and/or the relay UE (e.g. the MeasurementReport message and/or the SidelinkUEInformationNR message from the remote UE and/or the SidelinkUEInformationNR message from the relay UE and/or the multi-path configuration from gNB, gNB determines whether to modify or release a direct path with the gNB for the remote UE.
21. When gNB sends another RRCReconfiguration message, the relay UE and the remote UE may release one or more or all of the indirect bearers and/or the split bearers that can be reconfigured as the direct bearers according to the RRCReconfiguration message from the gNB. Note that with the RRCReconfiguration message from the gNB, the remote UE still keeps both direct link and the indirect link via the relay UE.

For release of an indirect bearer or an indirect path of split bearer for indirect path of multi-path to be reconfigured as a direct bearer via the RRCReconfiguration message from the gNB, the remote UE or the relay UE perform one or more of the followings:

A. The receiving PDCP entity of the bearer in the remote UE may trigger a PDCP status report sent to gNB as described below:
   The PDCP status report is directly sent from the remote UE to the gNB or indirectly sent to the gNB via the relay UE.
   Upon receiving the PDCP status report, the transmitting PDCP entity of the bearer in the gNB triggers ‘multi-path data switching’ to perform retransmission or transmission of PDCP SDUs on the direct path towards the remote UE, as described below.
   Upon/before receiving the RRCReconfiguration message for the release of the bearer, the SL RLC entity in the remote UE or the relay UE may perform one or more of the followings:
      Opt 1: The remote UE releases the Uu RLC entity and/or PC5 RLC entity for downstream indirect path of the bearer. As a result, SL data buffered in the TX RLC entity is discared and/or DL data buffered in the RX RLC entity is discarded.
      Opt 2: For the SL RLC entity of the PC5 RLC channel for downstream indirect path of the bearer, the AM RLC entity in the relay UE polls the peer AM RLC entity to trigger RLC STATUS reporting at the peer AM RLC entity in the remote UE. Based on the polling, the AM RLC entity in the remote UE triggers a RLC STATUS report sent to the peer AM RLC entity in the relay UE.
      Opt 3: For the SL RLC entity of the PC5 RLC channel for downstream indirect path of the bearer, the AM RLC entity in the remote UE triggers a RLC STATUS report sent to the peer AM RLC entity in the relay UE.
   Upon receiving the RLC STATUS reporting from the receiving RLC entity, the SL transmitting RLC entity in the relay UE performs retransmission of the RLC SDU or the RLC SDU segment for which a negative acknowledgement was received via the RLC STATUS reporting, as described below.
B. The receiving PDCP entity of the bearer in the gNB may trigger a PDCP status report sent to the remote UE as described below:
   The PDCP status report is directly sent from the gNB to the remote UE or indirectly sent to the remote UE via the relay UE.
   Upon receiving the PDCP status report, the transmitting PDCP entity of the bearer in the remote UE triggers ‘multi-path data switching’ to perform retransmission or transmission of PDCP SDUs on the direct path towards the gNB, as described below.
   Upon/before receiving the RRCReconfiguration message for the release of the bearer, the SL RLC entity in the relay UE or the remote UE may perform one or more of the followings:
      Opt 1: The relay UE releases the Uu RLC entity and/or PC5 RLC entity for upstream indirect path of the bearer. As a result, SL data buffered in the RX RLC entity is discared and/or UL data buffered in the TX RLC entity is discarded.
      Opt 2: For the SL RLC entity of the PC5 RLC channel for upstream indirect path of the bearer, the AM RLC entity in the remote UE polls the peer AM RLC entity to trigger RLC STATUS reporting at the peer AM RLC entity in the relay UE. Based on the polling, the AM RLC entity in the relay UE triggers a RLC STATUS report sent to the peer AM RLC entity in the remote UE.
      Opt 3: For the SL RLC entity of the PC5 RLC channel for upstream indirect path of the bearer, the AM RLC entity in the relay UE triggers a RLC STATUS report sent to the peer AM RLC entity in the remote UE.
   Upon receiving the RLC STATUS reporting from the receiving RLC entity, the SL transmitting RLC entity in the remote UE performs retransmission of the SL RLC SDU or the SL RLC SDU segment for which a negative acknowledgement was received via the RLC STATUS reporting, as described below, until release of the bearer on Uu/PC5.

Upon receiving the SL RLC SDU(s) and/or the SL RLC SDU segment(s) from the remote UE, the relay UE performs uplink retransmission of UL RLC SDU(s) or UL RLC SDU segment(s) corresponding to the SL RLC SDU(s) and/or the SL RLC SDU segment(s), until release of the bearer(s).
Afterwards, the relay UE and/or the remote UE informs the gNB about the release of the bearer e.g. by sending a UE information message to the gNB.

The gNB releases the PDCP/RLC entity (or entities) corresponding to the bearer(s) and/or the PC5-RRC connection, before/after reception of the UE information message.

The relay UE and/or the remote UE releases the Uu/PC5 PDCP/RLC entity (or entities) corresponding to the bearer(s) and/or the PC5-RRC connection, either before/after transmission of the UE information message or upon transmission of the RRCReconfiguration message releasing the bearer(s) to the remote UE and/or the relay UE.
C. Upon/before receiving the RRCReconfiguration message releasing the bearer, for downstream indirect path of the bearer, the relay UE stops any RLC Status Reporting procedure in the DL receiving RLC entity and/or the SL transmitting RLC entity, and the relay UE releases the DL receiving RLC entity and/or the SL transmitting RLC entity. The relay UE can also send the RRCReconfigurationSidelink message to the remote UE to release the peer SL receiving RLC entity in the remote UE.

If a PDCP status report is triggered, the receiving PDCP entity shall:
compile a PDCP status report as indicated below by:
   setting the FMC field to RX_DELIV;
   if RX_DELIV<RX_NEXT:
      allocating a Bitmap field of length in bits equal to the number of COUNTs from and not including the first missing PDCP SDU up to and including the last out-of-sequence PDCP SDUs, rounded up to the next multiple of 8, or up to and including a PDCP SDU for which the resulting PDCP Control PDU size is equal to 9000 bytes, whichever comes first;
      setting in the bitmap field as ‘0’ for all PDCP SDUs that have not been received, and optionally PDCP SDUs for which decompression have failed;
      setting in the bitmap field as ‘1’ for all PDCP SDUs that have been received;
   submit the PDCP status report to lower layers as the first PDCP PDU for transmission via the transmitting PDCP entity as specified in clause 5.2.1 of 3GPP TS 38.323 for Uu interface and in clause 5.2.3 of 3GPP TS 38.323 for PC5 interface.

For AM DRBs, when a PDCP status report is received in the downlink or in the sidelink, the transmitting PDCP entity shall:
consider for each PDCP SDU, if any, with the bit in the bitmap set to ‘1’, or with the associated COUNT value less than the value of FMC field as successfully delivered, and discard the PDCP SDU as specified in clause 5.3 of 3GPP TS 38.323.

When multi-path data switching (e.g. from the indirect bearer to the direct bearer) is triggered for the bearer, the transmitting PDCP entity in DL, UL or SL shall for the bearer:
for AM DRBs, from the first PDCP SDU for which the successful delivery of the corresponding PDCP Data PDU has not been confirmed by the RLC entity associated with the indirect path, perform retransmission or transmission of all the PDCP SDUs already associated with PDCP SNs in ascending order of the COUNT values associated to the PDCP SDU prior to multi-path data switching to the RLC entity associated with the direct path in DL, UL or SL as specified below:
perform header compression of the PDCP SDU using ROHC.
perform integrity protection and ciphering of the PDCP SDU using the COUNT value associated with this PDCP SDU;
submit the resulting PDCP Data PDU to the corresponding RLC entity of the direct path.
for UM DRBs, for all PDCP SDUs which have been processed by PDCP but which have not yet been submitted to lower layers, perform transmission of the PDCP SDUs in ascending order of the COUNT values to the RLC entity associated with the direct path in DL, UL or SL as specified below:
perform header compression of the PDCP SDU using ROHC
perform integrity protection and ciphering of the PDCP SDU using the COUNT value associated with this PDCP SDU
submit the resulting PDCP Data PDU to the corresponding RLC entity of the direct path in DL, UL or SL.

```
TABLE 11
  An AM RLC entity sends STATUS PDUs to its peer AM RLC entity in order to provide
positive and/or negative acknowledgements of RLC SDUs (or portions of them).
  Triggers to initiate STATUS reporting include:
  - Polling from its peer AM RLC entity:
  - When an AMD PDU with SN = x and the P field set to “1” is received from lower
layer, the receiving side of an AM RLC entity shall:
  - if the AMD PDU is to be discarded as specified in clause 5.2.3.2.2; or
  - if x < RX_Highest_Status or x >= RX_Next + AM_Window_Size:
  - trigger a STATUS report.
  - else:
  - delay triggering the STATUS report until x < RX_Highest_Status or x >= RX_Next
+ AM_Window_Size.
  NOTE 1: This ensures that the RLC Status report is transmitted after HARQ reordering.
  - Detection of reception failure of an AMD PDU
  - The receiving side of an AM RLC entity shall trigger a STATUS report when t-
Reassembly expires.
  - Upon reception of release of indirect path for multi-path configuration
  - The receiving side of an AM RLC entity in DL, UL or SL for indirect path shall trigger
a STATUS report
  NOTE 2: The expiry of t-Reassembly triggers both RX_Highest_Status to be updated
and a STATUS report to be triggered, but the STATUS report shall be triggered after
RX_Highest_Status is updated.
  When STATUS reporting has been triggered, the receiving side of an AM RLC entity
shall:
  - if t-StatusProhibit is not running:
  - at the first transmission opportunity indicated by lower layer, construct a STATUS
PDU and submit it to lower layer.
  - else:
  - at the first transmission opportunity indicated by lower layer after t-StatusProhibit
expires, construct a single STATUS PDU even if status reporting was triggered several times
while t-StatusProhibit was running and submit it to lower layer.
  When a STATUS PDU has been submitted to lower layer, the receiving side of an AM
RLC entity shall:
  - start t-StatusProhibit.
  When constructing a STATUS PDU, the AM RLC entity shall:
  - for the RLC SDUs with SN such that RX_Next <= SN < RX_Highest_Status that has
not been completely received yet, in increasing SN order of RLC SDUs and increasing byte
segment order within RLC SDUs, starting with SN = RX_Next up to the point where the
resulting STATUS PDU still fits to the total size of RLC PDU(s) indicated by lower layer:
  - for an RLC SDU for which no byte segments have been received yet:
  - include in the STATUS PDU a NACK_SN which is set to the SN of the RLC SDU.
  - for a continuous sequence of byte segments of a partly received RLC SDU that have
not been received yet:
  - include in the STATUS PDU a set of NACK_SN, SOstart and SOend.
  - for a continuous sequence of RLC SDUs that have not been received yet:
  - include in the STATUS PDU a set of NACK_SN and NACK range;
  - include in the STATUS PDU, if required, a pair of SOstart and SOend.
  - set the ACK_SN to the SN of the next not received RLC SDU which is not indicated
as missing in the resulting STATUS PDU.
```

Upon reception of a STATUS report from the receiving RLC AM entity, the transmitting side of an AM RLC entity shall:
if the STATUS report comprises a positive or negative acknowledgement for the RLC SDU with sequence number equal to POLL_SN:
   if t-PollRetransmit is running:
      stop and reset Timer t-PollRetransmit which is used by the transmitting side of an AM RLC entity in order to retransmit a poll.
consider the RLC SDU or the RLC SDU segment for which a negative acknowledgement was received for retransmission.

Meanwhile, upon receiving the RRCReconfiguration message from the gNB, for the above bearer (e.g. split bearer), the remote UE can reconfigure the direct path of the split bearer as the primary path as follows:
If the RRCReconfiguration message does not configure the primary path of the bearer, the remote UE reconfigure the direct path of the split bearer as the primary path.

Alternatively, if the RRCReconfiguration message does not configure the primary path of the bearer, the remote UE keeps (or configures) the indirect path of the split bearer as the primary path.

Alternatively, if the RRCReconfiguration message does not configure the primary path of the bearer, the remote UE configures the direct path or indirect path of the split bearer as the primary path according to the specified configuration or the default configuration.
If the RRCReconfiguration message configures the primary path of the bearer, the remote UE configures the direct path or indirect path of the split bearer as the primary path according to the configuration in the RRCReconfiguration message.
The specific type of Signalling RB can be always configured with the direct path of the split bearer as the primary path (e.g. according to specified configuration or default configuration).
22. The relay UE can request modification or release of an indirect bearer and/or indirect path of a split bearer to the gNB and/or inform the gNB about the condition that may trigger the modification or release (i.e. one or more of the following conditions) by using a first UE information message, if one or more of the following conditions is met:
   If the relay UE detects buffer overflow for relayed bearer(s)/channel(s) (e.g. TX or RX buffer overflows for SL transmission/reception between the relay UE and the remote UE, or buffer overflows for UL transmission or DL reception for U2N relay)
   If the relay UE cannot meet QoS requirements of relayed bearer(s)/channel(s) e.g. delay requirement or data rate requirement of relay bearer(s)/channel(s) cannot be met
   If the relay UE establishes a PC5 unicast link with one or more remote UE
   If the relay UE releases a PC5 unicast link with the remote UE
   If the relay UE detects sidelink failure (e.g. sidelink radio link failure or sidelink reconfiguration failure or sidelink integrity protection failure) of the PC5 unicast link with the remote UE
   If a SL bearer which may be newly configured by the remote UE and/or the relay UE cannot be mapped to any existing established Uu/PC5 RLC channel for relaying the SL bearer
   If a SL bearer mapped to any established Uu/PC5 RLC channel is released by the remote UE and/or the relay UE
   If NAS layer of the relay UE requests addition, modification or release of an indirect bearer and/or indirect path of a split bearer which can be configured with multi-path operation.

The first UE information message includes one or more of the followings:
Identifier(s) of relayed bearer(s)/channel(s) subject to the above modification or the above condition(s) for modification, e.g. bearer identity, logical channel identity, source identity or destination identity of the relayed bearer(s)/channel(s)
   Identifier(s) of relayed bearer(s)/channel(s) subject to the above release or the above condition(s) for release, e.g. bearer identity, logical channel identity, source identity or destination identity of the relayed bearer(s)/channel(s)
   Cause(s) related to the above condition(s) for modification
23. The remote UE can request modification or release of an indirect bearer and/or indirect path of a split bearer to the gNB and/or inform the gNB about the condition that may trigger the modification or release (i.e. one or more of the following conditions) by using a second UE information message, if one or more of the following conditions is met:
   If the remote UE detects buffer overflow for relayed bearer(s)/channel(s) (e.g. TX or RX buffer overflows for SL transmission/reception between the relay UE and the remote UE)
   If the remote UE cannot meet QoS requirements of relayed bearer(s)/channel(s) e.g. delay requirement or data rate requirement of relay bearer(s)/channel(s) cannot be met
   If the remote UE establishes a PC5 unicast link with one or more relay UE
   If the remote UE releases a PC5 unicast link with the relay UE
   If the remote UE detects sidelink failure (e.g. sidelink radio link failure or sidelink reconfiguration failure or sidelink integrity protection failure) of the PC5 unicast link with the relay UE
   If a SL bearer which may be newly configured by the remote UE and/or the relay UE cannot be mapped to any existing established Uu/PC5 RLC channel for relaying the SL bearer
   If a SL bearer mapped to any established Uu/PC5 RLC channel is released by the remote UE and/or the relay UE
   If NAS layer of the remote UE requests addition, modification or release of an indirect bearer and/or indirect path of a split bearer which can be configured with multi-path operation.

The second UE information message includes one or more of the followings:
Identifier(s) of relayed bearer(s)/channel(s) subject to the above modification or the above condition(s) for modification, e.g. bearer identity, logical channel identity, source identity or destination identity of the relayed bearer(s)/channel(s)
Identifier(s) of relayed bearer(s)/channel(s) subject to the above release or the above condition(s) for release, e.g. bearer identity, logical channel identity, source identity or destination identity of the relayed bearer(s)/channel(s)
Cause(s) related to the above condition(s) for release
24. If the remote UE considers the entering condition for one of the following events to be satisfied based on the above measurement configuration, the remote UE initiates a first measurement reporting procedure
Event X1 (Serving L2 U2N Relay UE becomes worse than threshold1 and NR Cell becomes better than threshold2)
Event X3 (Serving L2 U2N Relay UE becomes worse than threshold1 and PCell (or PSCell or SCell) becomes better than threshold2)
Event X2 (Serving L2 U2N Relay UE becomes worse than threshold)
Event Y2 (Candidate L2 U2N Relay UE becomes better than threshold)
Event C1 (The NR sidelink channel busy ratio is above a threshold)

If the remote UE considers the leaving condition for one of the following events to be satisfied based on the above measurement configuration, the remote UE initiates a first measurement reporting procedure
Event C2 (The NR sidelink channel busy ratio is below a threshold)
Event Y1 (PCell becomes worse than threshold1 and candidate L2 U2N Relay UE becomes better than threshold2)

If the relay UE considers the entering condition for one of the following events to be satisfied based on the above measurement configuration, the relay UE initiates a second measurement reporting procedure
Event A2 (Serving becomes worse than threshold)
Event A3 (Neighbour becomes offset better than SpCell)
Event B1 (Inter RAT neighbour becomes better than threshold)
Event B2 (PCell becomes worse than threshold1 and inter RAT neighbour becomes better than threshold2)
Event C1 (The NR sidelink channel busy ratio is above a threshold)

If the relay UE considers the leaving condition for one of the following events to be satisfied based on the above measurement configuration, the relay UE initiates a second measurement reporting procedure
Event C2 (The NR sidelink channel busy ratio is below a threshold)
Event A1 (Serving becomes better than threshold)

If the first measurement reporting procedure is initiated, the remote UE informs the gNB about the measured result on the relay UE and the identifier of the relay UE by using a first measurement report.

If the second measurement reporting procedure is initiated, the relay UE informs the gNB about the measured result on the remote UE and the identifier of the remote UE by using a second measurement report.
25. The CN node (e.g. AMF or SMF) can inform the gNB about addition, modification or release of multi-path configuration e.g. in QoS profile for the remote UE and/or the relay UE. The QoS profile is sent from the CN node to the gNB.
   The multi-path related information in the QoS profile can indicate whether multi-path can be configured for one of the followings:
      each PDU session
      each QoS flow
      each remote UE
      each relay UE
      each frequency
      each cell
      each RAT
      each PLMN
      each Tracking Area
      each gNB
26. Based on the first/second UE information message and/or the first/second measurement report and/or the above multi-path configuration, the gNB determines addition, modification or release of an indirect bearer and/or indirect path of a split bearer for relayed bearer(s)/channel(s).

If the gNB determines addition, modification or release of an indirect bearer and/or indirect path of a split bearer for relayed bearer(s)/channel(s) based on the below option 1 or option 2 e.g. by sending the RRCReconfiguration message to the relay UE and the remote UE respectively. The gNB may send the RRCReconfiguration message based on the option 1 as described below for modification of the relayed bearer(s)/channel(s), while sending the RRCReconfiguration message based on the option 2 as described below for release of the relayed bearer(s)/channel(s).
if the RRCReconfiguration message includes SL-DestinationIdentity corresponding the remote UE in the sl-L2RelayUEConfig, the relay UE performs the L2 U2N Remote UE release to release all indirect bearers and one or more split bearers for the remote UE.
if the RRCReconfiguration message includes SL-DestinationIdentity corresponding the remote UE and BearerIdentity or SL-DestinationIdentity corresponding to an indirect bearer or an split bearer for the remote UE in the sl-L2RelayUEConfig, the relay UE releases one or more L2 entities (e.g. RLC entity) and a logical channel corresponding to the indirect bearer or the split bearer for the remote UE.
if the RRCReconfiguration message includes (SL-DestinationIdentity corresponding the relay UE and) BearerIdentity or SL-DestinationIdentity corresponding to an indirect bearer or an split bearer for the remote UE in sl-L2RemoteUEConfig, the remote UE releases or modify one or more L2 entities (e.g. RLC entity) and a logical channel corresponding to the indirect bearer or the split bearer for the relay UE according to the message. The remote UE may also add or modify direct bearers to change the indirect/split bearers to the direct bearers.
if the RRCReconfiguration message includes SL-DestinationIdentity corresponding the relay UE in sl-L2RemoteUEConfig, the remote UE release all indirect bearers and release or modify one or more split bearers for the relay UE according to the message. The remote UE may also add or modify direct bearers to change the indirect/split bearers to the direct bearers.

The following options of RRC Reconfiguration as described above can be considered for this step.
A. Option 1: Joint RRC Reconfiguration is used for the remote UE and the relay UE to modify or release the indirect bearer(s) and/or the split bearer(s) possibly with release of the U2N based connection.
B. Option 2: Separate delivery of RRC reconfiguration is used for the remote UE and the relay UE to modify or release the indirect bearer(s) and/or the split bearer(s) possibly with release of the U2N based connection.
27. In the above steps, the relay UE and the remote UE may release one or more or all of the indirect bearers and/or the split bearers that can be reconfigured as the direct bearers. As a result of this step, the remote UE may keep both direct link and the indirect link via the relay UE, or the remote UE may maintain only the direct link while releasing the indirect link via the relay UE and possibly the PC5-RRC connection with the relay UE.

For release of an indirect bearer or an indirect path of split bearer for indirect path of multi-path, the remote UE or the relay UE perform one or more of the followings:
A. The receiving PDCP entity of the bearer in the remote UE may trigger a PDCP status report sent to gNB as described below:
   The PDCP status report is directly sent from the remote UE to the gNB or indirectly sent to the gNB via the relay UE.
   Upon receiving the PDCP status report, the transmitting PDCP entity of the bearer in the gNB triggers ‘multi-path data switching’ to perform retransmission or transmission of PDCP SDUs on the direct path towards the remote UE, as described below.
   Upon/before receiving the RRCReconfiguration message for the release of the bearer or upon/before release of the PC5-RRC connection, the SL RLC entity in the remote UE or the relay UE may perform one or more of the followings:
      Opt 1: The remote UE releases the Uu RLC entity and/or PC5 RLC entity for downstream indirect path of the bearer. As a result, SL data buffered in the TX RLC entity is discarded and/or DL data buffered in the RX RLC entity is discarded.
      Opt 2: For the SL RLC entity of the PC5 RLC channel for downstream indirect path of the bearer, the AM RLC entity in the relay UE polls the peer AM RLC entity to trigger RLC STATUS reporting at the peer AM RLC entity in the remote UE. Based on the polling, the AM RLC entity in the remote UE triggers a RLC STATUS report sent to the peer AM RLC entity in the relay UE.
      Opt 3: For the SL RLC entity of the PC5 RLC channel for downstream indirect path of the bearer, the AM RLC entity in the remote UE triggers a RLC STATUS report sent to the peer AM RLC entity in the relay UE.
   Upon receiving the RLC STATUS reporting from the receiving RLC entity, the SL transmitting RLC entity in the relay UE performs retransmission of the RLC SDU or the RLC SDU segment for which a negative acknowledgement was received via the RLC STATUS reporting, as described below.
B. The receiving PDCP entity of the bearer in the gNB may trigger a PDCP status report sent to the remote UE as described below:
   The PDCP status report is directly sent from the gNB to the remote UE or indirectly sent to the remote UE via the relay UE.
   Upon receiving the PDCP status report, the transmitting PDCP entity of the bearer in the remote UE triggers ‘multi-path data switching’ to perform retransmission or transmission of PDCP SDUs on the direct path towards the gNB, as described below.
   Upon/before receiving the RRCReconfiguration message for the release of the bearer or upon/before release of the PC5-RRC connection, the SL RLC entity in the relay UE or the remote UE may perform one or more of the followings:
      Opt 1: The relay UE releases the Uu RLC entity and/or PC5 RLC entity for upstream indirect path of the bearer. As a result, SL data buffered in the RX RLC entity is discarded and/or UL data buffered in the TX RLC entity is discarded.
      Opt 2: For the SL RLC entity of the PC5 RLC channel for upstream indirect path of the bearer, the AM RLC entity in the remote UE polls the peer AM RLC entity to trigger RLC STATUS reporting at the peer AM RLC entity in the relay UE. Based on the polling, the AM RLC entity in the relay UE triggers a RLC STATUS report sent to the peer AM RLC entity in the remote UE.
      Opt 3: For the SL RLC entity of the PC5 RLC channel for upstream indirect path of the bearer, the AM RLC entity in the relay UE triggers a RLC STATUS report sent to the peer AM RLC entity in the remote UE.
   Upon receiving the RLC STATUS reporting from the receiving RLC entity, the SL transmitting RLC entity in the remote UE performs retransmission of the SL RLC SDU or the SL RLC SDU segment for which a negative acknowledgement was received via the RLC STATUS reporting, as described below, until release of the PC5-RRC release and/or release of the bearer on Uu/PC5.

Upon receiving the SL RLC SDU(s) and/or the SL RLC SDU segment(s) from the remote UE, the relay UE performs uplink retransmission of UL RLC SDU(s) or UL RLC SDU segment(s) corresponding to the SL RLC SDU(s) and/or the SL RLC SDU segment(s), until release of the PC5-RRC connection or the bearer(s).
Afterwards, the relay UE and/or the remote UE informs the gNB about the release of the PC5-RRC connection and/or the release of the bearer e.g. by sending a UE information message to the gNB.

The gNB releases the PDCP/RLC entity (or entities) corresponding to the bearer(s) and/or the PC5-RRC connection, before/after reception of the UE information message.

The relay UE and/or the remote UE releases the Uu/PC5 PDCP/RLC entity (or entities) corresponding to the bearer(s) and/or the PC5-RRC connection, either before/after transmission of the UE information message or upon transmission of the RRCReconfiguration message releasing the bearer(s) to the remote UE and/or the relay UE.
C. Upon/before receiving the RRCReconfiguration message releasing the bearer or upon/before release of the PC5-RRC connection, for downstream indirect path of the bearer, the relay UE stops any RLC Status Reporting procedure in the DL receiving RLC entity and/or the SL transmitting RLC entity, and the relay UE releases the DL receiving RLC entity and/or the SL transmitting RLC entity. The relay UE can also send the RRCReconfigurationSidelink message to the remote UE to release the peer SL receiving RLC entity in the remote UE.

Using the disclosed invention, the network can configure direct path and indirect path for multi-path operation and dynamically activate or deactivate a RLC entity and PDCP duplication according to the invention, in particular when the UEs can support U2N relay function via SL.

This invention is beneficial in that the system can dynamically provide multi-path operation including direct link and indirect link via U2N relay. In the prior art, there is no mechanism to provide multi-path operation with sidelink relay.

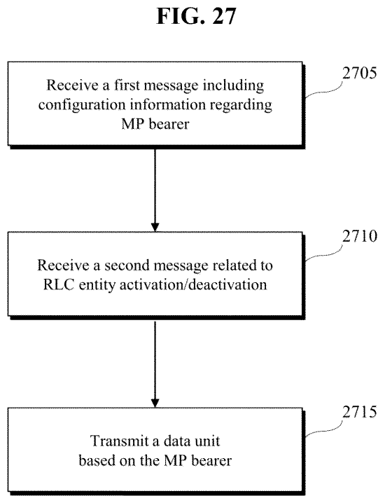

FIG. 27 illustrates a method of transmitting a signal by a user equipment (UE) in an embodiment of the present disclosure. The UE may be a remote UE.

Referring to FIG. 27, the UE may receive a first message including configuration information regarding a multi-path (MP) bearer configured with a plurality of radio link control (RLC) entities including at least one first RLC entity related to a direct path to a network and at least one second RLC entity related to an indirect path to the network (2705). The configuration information may include information regarding data duplication for the data unit transmission.

The UE may receive a second message including information regarding activation/deactivation of each RLC entity (2710). The information regarding activation/deactivation of each RLC entity may be configured based on RLC entity indexes for the plurality of RLC entities. The RLC entity indexes are determined based on an indexing order in which at least one first RLC entity index of the at least one first RLC entity related to the direct path may be followed by at least one second RLC entity index of the at least one second RLC entity related to the indirect path. The data unit transmission may be duplicated based on the data duplication on activated RLC entities among the plurality of RLC entities.

The UE may transmit a data unit based on the MP bearer configured through the configuration information (2715).

Preferably, the information regarding activation/deactivation of each RLC entity may be configured as a medium access control (MAC) control element (CE).

Preferably, the MAC CE may include an activation/deactivation indication per each RLC entity index.

Preferably, the second message including the information regarding activation/deactivation of each RLC entity may be received through the direct path.

Preferably, the second message including the information regarding activation/deactivation of each RLC entity may be received through a remote UE in the indirect path.

Preferably, the at least one first RLC entity index may be lower than the at least one second RLC entity index.

Preferably, the data unit may be a packet data convergence protocol (PDCP) data unit, and the data duplication is PDCP data unit duplication.

Preferably, the at least one second RLC entity may be at least one sidelink (SL) RLC entity related to a relay UE in the indirect path to the network.

Preferably, the first message may be received through a radio resource control (RRC) signaling.

Preferably, the plurality of RLC entity indexes may be logical channel identifiers of the plurality of RLC entities.

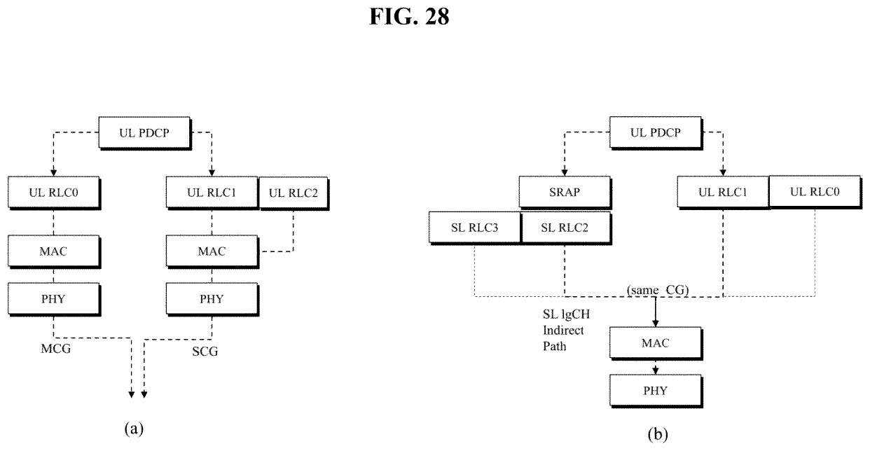

FIG. 28 illustrates split bearers. The FIG. 28 (a) is a split bearer for DC. The FIG. 28 (b) is a split bearer configured with the direct path and the indirect path. PDCP duplication can be performed through RLC entities. In DC case (a), PDCP duplication can be performed through two or more of RLC entities 0 to 2. In MP case (b), PDCP duplication can be performed through two or more of RLC entities 0 to 3. In the MP case (b), the UL RLC entities in direct path are allocated with the lower indexes than the SL RLC entities in the indirect path.

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

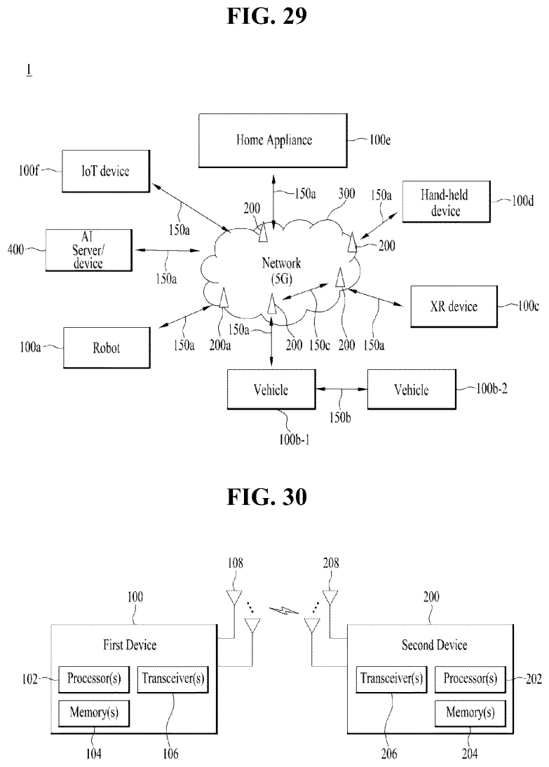

FIG. 29 illustrates a communication system applied to the present disclosure.

Referring to FIG. 29, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 30 illustrates a wireless device applicable to the present disclosure.

Referring to FIG. 30, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 29.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, a UE may include the processor(s) 102 connected to the RF transceiver and the memory(s) 104. The memory(s) 104 may include at least one program for performing operations related to the embodiments described above with reference to FIGS. 11 to 27.

Alternatively, a chipset including the processor(s) 102 and memory(s) 104 may be configured. The chipset may include: at least one processor; and at least one memory operably connected to the at least one processor and configured to, when executed, cause the at least one processor to perform operations.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

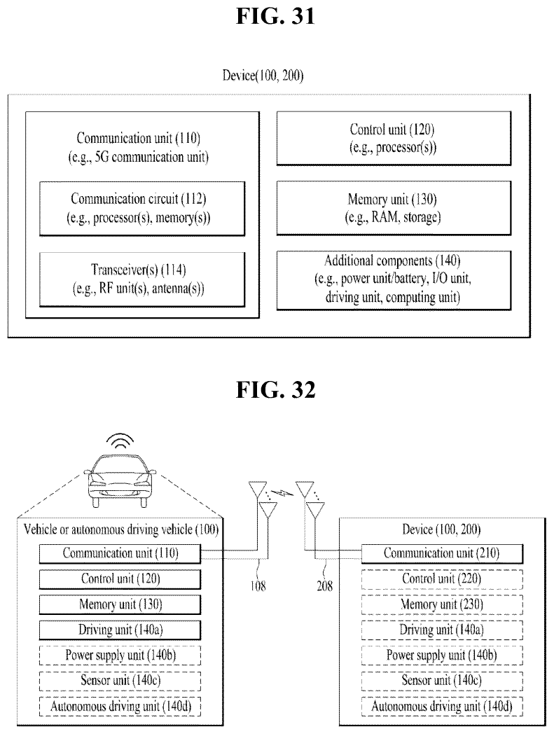

FIG. 31 illustrates another example of a wireless device applied to the present disclosure. The wireless device may be implemented in various forms according to a use-case/service (refer to FIG. 29)

Referring to FIG. 31, wireless devices 100 and 200 may correspond to the wireless devices 100 and 200 of FIG. 30 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 30. For example, the transceiver(s) 114 may include the one or more transceivers 106 and 206 and/or the one or more antennas 108 and 208 of FIG. 30. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 29), the vehicles (100b-1 and 100b-2 of FIG. 29), the XR device (100c of FIG. 29), the hand-held device (100d of FIG. 29), the home appliance (100e of FIG. 29), the IoT device (100f of FIG. 29), a digital broadcast terminal, a hologram device, a public safety device, an MTC device, a medicine device, a fintech device (or a finance device), a security device, a climate/environment device, the AI server/device (400 of FIG. 29), the BSs (200 of FIG. 29), a network node, etc. The wireless device may be used in a mobile or fixed place according to a use-example/service.

In FIG. 31, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 32 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 32, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 31, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure is applicable to UEs, BSs, or other apparatuses in a wireless mobile communication system.

1. A method performed by a user equipment (UE), the method comprising:
receiving a first message including configuration information regarding a multi-path (MP) bearer configured with a plurality of radio link control (RLC) entities including at least one first RLC entity related to a direct path to a network and at least one second RLC entity related to an indirect path to the network;
receiving a second message including information regarding activation/deactivation of each RLC entity; and
transmitting a data unit based on the MP bearer configured through the configuration information,
wherein the configuration information includes information regarding data duplication for the data unit transmission,
wherein the information regarding activation/deactivation of each RLC entity is configured based on RLC entity indexes for the plurality of RLC entities,
wherein the RLC entity indexes are determined based on an indexing order in which at least one first RLC entity index of the at least one first RLC entity related to the direct path is followed by at least one second RLC entity index of the at least one second RLC entity related to the indirect path, and
wherein the data unit transmission is duplicated based on the data duplication on activated RLC entities among the plurality of RLC entities.

2. The method of claim 1, wherein the information regarding activation/deactivation of each RLC entity is configured as a medium access control (MAC) control element (CE).

3. The method of claim 2, wherein the MAC CE includes an activation/deactivation indication per each RLC entity index.

4. The method of claim 1, wherein the second message including the information regarding activation/deactivation of each RLC entity is received through the direct path.

5. The method of claim 1, wherein the second message including the information regarding activation/deactivation of each RLC entity is received through a remote UE in the indirect path.

6. The method of claim 1, wherein the at least one first RLC entity index is lower than the at least one second RLC entity index.

7. The method of claim 1, wherein the data unit is a packet data convergence protocol (PDCP) data unit, and the data duplication is PDCP data unit duplication.

8. The method of claim 1, wherein the at least one second RLC entity is at least one sidelink (SL) RLC entity related to a relay UE in the indirect path to the network.

9. The method of claim 1, wherein the first message is received through a radio resource control (RRC) signaling.

10. The method of claim 1, wherein the plurality of RLC entity indexes are logical channel identifiers of the plurality of RLC entities.

11. A non-transitory computer-readable medium storing instructions, when executed by a processor, that cause the processor to perform the method of claim 1.

12. A device comprising:
a memory configured to store instructions; and
a processor configured to perform operations by executing the instructions,
wherein the operations performed by the processor comprise:
receiving a first message including configuration information regarding a multi-path (MP) bearer configured with a plurality of radio link control (RLC) entities including at least one first RLC entity related to a direct path to a network and at least one second RLC entity related to an indirect path to the network;
receiving a second message including information regarding activation/deactivation of each RLC entity; and
transmitting a data unit based on the MP bearer configured through the configuration information,
wherein the configuration information includes information regarding data duplication for the data unit transmission,
wherein the information regarding activation/deactivation of each RLC entity is configured based on RLC entity indexes for the plurality of RLC entities,
wherein the RLC entity indexes are determined based on an indexing order in which at least one first RLC entity index of the at least one first RLC entity related to the direct path is followed by at least one second RLC entity index of the at least one second RLC entity related to the indirect path, and
wherein the data unit transmission is duplicated based on the data duplication on activated RLC entities among the plurality of RLC entities.

13. The device of claim 12, wherein the device is a user equipment (UE) operating in a 3rd generation partnership project (3GPP) based wireless communication system.
